(19) United States
(12) Patent Application Publication
(10) Pub. No.: US 2015/0108836 A1
(43) Pub. Date: Apr. 23, 2015

(54) Power Boost Circuit

(71) Applicants: Yen-Wei Hsu, Taipei (TW); Whei-Chyou Wu, Fremont, CA (US)

(72) Inventors: Yen-Wei Hsu, Taipei (TW); Whei-Chyou Wu, Fremont, CA (US)

(21) Appl. No.: 14/056,980

(22) Filed: Oct. 18, 2013

(51) Int. Cl. G05F 1/62

(52) U.S. Cl. CPC G05F 1/62
USPC 307/24

(57) ABSTRACT

The invention relates to a voltage boost circuit, and more particularly, to a power boost circuit formed by a plurality of voltage boost circuits.

### BACKGROUND OF THE INVENTION

1. Field of the Invention

The invention relates to a voltage boost circuit, and more particularly, to a power boost circuit formed by a plurality of voltage boost circuits.

2. Description of Related Art

The invention relates to a power boost circuit, and more particularly, to provide a circuit and a modulator to more efficiently drive a LED resulting in improving matching between power source and LED, lowering LED junction temperature and emitting brighter, richer and more natural colors in a more capacitive way. The following is a brief discussion about this.

For any RLC circuit can be expressed by two first-order differential equations as followed:

$$\{ \begin{matrix}\frac{d x}{d t} = y - F ( x ) \\ \frac{d y}{d t} = - g ( x )\end{matrix} \qquad ( 1 )$$

of which x and y are state variables of which one is current and the other one is voltage and F(x) is the impedance function. The two first-order differential equations (1) can be expressed by a second-order differential equation as shown by:

$$\frac{{d}^{2} x}{d {t}^{2}} + \frac{d F ( x )}{d x} \frac{d x}{d t} + g ( x ) = 0$$

$$or$$

$$\frac{{d}^{2} x}{d {t}^{2}} + f ( x ) \frac{d x}{d t} + g ( x ) = 0$$

$$where$$

$$f ( x ) = \frac{d F ( x )}{d x}$$

It's note that the

$$\frac{d F ( x )}{d x}$$

in

$$\frac{d x}{d t}$$

term is the damping term. According to the Liénard stabilized system theory, for any stabilized periodical system,

$$\frac{d F ( x )}{d x} > 0 and \frac{d F ( x )}{d x} < 0$$

hold simultaneously and the two must pass

$$\frac{d F ( x )}{d x} = 0 , where \frac{d F ( x )}{d x} > 0$$

is defined as positive differential resistance or PDR in short,

$$\frac{d F ( x )}{d x} < 0$$

is defined as negative differential resistance or NDR in short, and

$$\frac{d F ( x )}{d x} = 0$$

is a constant resistance or defined as pure resistance. Any device having PDR is a PDR device, any device having NDR is a NDR device, and any device having constant resistance is defined as pure resistor. It's obvious that a PDR device and a NDR device electrically connected in series can satisfy

$$\frac{d F ( x )}{d x} > 0 and \frac{d F ( x )}{d x} < 0$$

simultaneously so that a PDR device and a NDR device electrically connected in series is a damper.

The PDR device and the NDR device are not limited to any particular PDR device and NDR device, for example, an embodiment, a PDR device and a NDR device can respectively be a positive temperature coefficient (or PTC in short) and negative temperature coefficient (or NTC in short). According to the chain-rule,

$$\frac{d F ( x )}{d x} = \frac{d F}{d T} \frac{d T}{d x}$$

where T is temperature and assuming the state x is current for the purpose of convience,

$$\frac{d T}{d x}$$

can be interpreted as a change in current leads to a change in temperature, and the change in temperature leads to a change in resistance as described by

$$\frac{d F}{d T} .$$

This explains why a PTC and a NTC can respectively be a PDR device and a NDR device.

More detailed about the damper formed by a PDR device and a NDR device electrically connected in series and an energy discharge capacitor formed with a PDR device and a NDR device can be referred to our previous invention “a capacitor” USA early publication no. US2010-0277392A1 for reference. The energy discharge capacitor is a capacitor also is a damper. The “energy discharge capacitor” in the present invention is the capacitor of our previous invention “a capacitor” USA early publication no. US2010-0277392A1.

Capacitor and inductor are basic electronic components and are widely used in electrical circuits, and if their dynamic properties are more understood and improved then a circuit or a system using them will be a lot benefited.

An inventive theory describing the dynamic property of a capacitor is revealed in the present invention and an inventive multilayer capacitor having variable capacitances based on the inventive theory is also revealed in the present invention. An inventive multilayer magnetic core and an inventive “multi-phase multilayer magnetic core assembly” to work with the inventive multilayer capacitor to form an oscillator are also revealed in the present invention.

The Miller effect and the synchronization of million transistors in array of the prior-art FET (field-effect transistor) and IGBT (insulated gate bipolar transistor) are known to seriously limit their speed and performance and the gate of FET and IGBT is known to have capacitive structure. Aiming at the drawbacks, the inventive theory describing the dynamic property of a capacitor and the inventive multilayer capacitor based on the inventive theory can be applied to the gate of FET and IGBT to solve those problems.

Prior-art voltage boost circuit is known to boost voltage but not electrical power. Aiming at the drawback, an inventive power boost circuit formed by multiple voltage boost circuits and using inventive magnetic core can boost both voltage and electrical power is also revealed in the present invention.

The inventive power boost circuit can be used to drive a positive dc bus, a positive dcbus and a negative dc bus, a plurality of positive dc buses, or a plurality of positive dc buses and a negative dc bus to form an inventive dc bus level control circuit, an inventive battery charging circuit, an inventive power factor correction circuit, or an inventive soft start circuit.

Based on the inventive multilayer capacitor, an inventive touch panel device is revealed.

Based on the inventive multilayer capacitor and the inventive multilayer magnetic core and an inventive multi-phase multilayer magnetic core assembly, a power boost circuit, an inventive oscillator, antenna, RFID, positive and negative differential impedance network, dc bus level control circuit, battery charging circuit, and electrical power generator are revealed in the present invention.

### BRIEF SUMMARY OF THE INVENTION

An inventive theory describing the dynamic property of capacitor is revealed in the present invention and an inventive multilayer capacitor based on the inventive theory is also revealed in the present invention. An inventive multilayer inductor and multi-phase multilayer magnetic core assembly is also revealed in the present invention.

Based on the inventive multilayer capacitor and the inventive theory, an inventive touch panel device is revealed in the present invention.

Based on the inventive multilayer capacitor and the inventive theory, an inventive FET (field-effect transistor) and an IGBT (insulated gate bipolar transistor) are respectively revealed in the present invention.

An inventive oscillator based on the inventive multilayer capacitor, the inventive theory and multilayer inductor or multi-phase multilayer magnetic core assembly is also revealed in the present invention.

Prior-art voltage boost circuit is known to boost voltage but not electrical power. Aiming at the drawback, an inventive power boost circuit formed by multiple voltage boost circuits can boost both voltage and electrical power is revealed in the present invention.

An inventive power boost assembly formed by a plurality of the inventive power boost circuits is revealed in the present invention.

The inventive power boost circuit or the inventive power assembly can be used to drive a positive dc bus, a positive dc bus and a negative dc bus, a plurality of positive dc buses, or a plurality of positive dc buses and a negative dc bus to form an inventive dc bus level control circuit, an inventive battery charging circuit, an inventive power factor correction circuit, an inventive soft start circuit, an inventive electric pedal control circuit, or an inventive battery charging station.

An inventive antenna based on the inventive multilayer capacitor and the inventive theory is revealed in the present invention.

An inventive oscillator based on the inventive multilayer capacitor, the inventive theory and the multilayer inductor or multi-phase multilayer magnetic core assembly is revealed in the present invention.

An inventive RFID based on the inventive multilayer and the inventive oscillator is revealed in the present invention.

An inventive positive and negative differential impedance network having variable resistances, capacitances and inductances is revealed in the present invention.

### BRIEF DESCRIPTION OF THE SEVERAL VIEWS OF THE DRAWINGS

FIG. 1a has shown an embodiment of a multilayer capacitor;

FIG. 1b has shown a capacitor assembly formed by a plurality of component capacitors electrically connected in parallel with each other;

FIG. 1c(a) has shown an embodiment of the third type fully saturable multilayer capacitor or the fourth type fully saturable multilayer capacitor in side view;

FIG. 1c(b) is a top view of FIG. 1c(a);

FIG. 2a(a) has shown an embodiment of a square closed-loop multilayer magnetic core in top view as shown to the right and the drawing to it left is a side view of the square closed-loop multilayer magnetic core;

FIG. 2a(b) has shown an embodiment of an oval closed-loop multilayer magnetic core in top view as shown to the right and the drawing to it left is a side view of the square closed-loop multilayer magnetic core;

FIG. 2a(c) has shown an embodiment of a round closed-loop multilayer magnetic core in top view as shown to the right and the drawing to it left is a side view of the square closed-loop multilayer magnetic core;

FIG. 2b has shown an embodiment of “a first type n-phase multilayer magnetic core assembly”;

FIG. 2c(a) has shown an embodiment of “a first type m-phase multilayer magnetic core assembly”;

FIG. 2c(b) has shown an embodiment of “a second type n-phase multilayer magnetic core assembly” based on “the first type m-phase multilayer magnetic core assembly” of FIG. 2c(a);

FIG. 2d(a) has shown an embodiment of “a first type n-phase multilayer magnetic core assembly” based on the embodiment of FIG. 2b using square multilayer magnetic cores;

FIG. 2d(b) has shown an embodiment of “a second type n-phase multilayer magnetic core assembly” based on the embodiment of FIG. 2c(b) using square multilayer magnetic cores;

FIG. 2e has shown an embodiment of “a first type n-phase multilayer magnetic core assembly” based on the embodiment of FIG. 2b using round multilayer magnetic cores;

FIG. 2f has shown an embodiment of “a second type n-phase multilayer magnetic core assembly” based on the embodiment of FIG. 2c(b) using round multilayer magnetic cores;

FIG. 2g has shown an embodiment of “a third type n-phase multilayer magnetic core assembly”;

FIG. 2h has shown an embodiment of “a fourth type n-phase multilayer magnetic core assembly”;

FIG. 2i has shown an embodiment of “a fifth type n-phase multilayer magnetic core assembly;

FIG. 3a has shown an embodiment of a first type dc bus level control circuit, a first type battery charge circuit, a first type power factor correction circuit, a first type electric pedal control circuit, or a first type soft start circuit;

FIG. 3b has shown an embodiment of a second type dc bus level control circuit, a second type battery charge circuit, a second type power factor correction circuit, a second type electric pedal control circuit, or a second type soft start circuit;

FIG. 3c has shown an embodiment of a first type dc bus level control circuit, a first type battery charge circuit, a first type power factor correction circuit, a first type electric pedal control circuit, or a first type soft start circuit;

FIG. 3d has shown an embodiment of a second type dc bus level control circuit, a second type battery charge circuit, a second type power factor correction circuit, a second electric pedal control circuit, or a second type soft start circuit;

FIG. 3e has shown an embodiment of a third type dc bus level control circuit, a third type battery charge circuit, a third type power factor correction circuit, a third type electric pedal control circuit, or a third type soft start circuit;

FIG. 3f has shown an embodiment of a fourth type dc bus level control circuit, a fourth type battery charge circuit, a fourth type power factor correction circuit, a fourth type electric pedal control circuit, or a fourth type soft start circuit;

FIG. 3g has shown more detailed circuit of FIG. 3a having only three phases;

FIG. 3h has shown more detailed circuit of FIG. 3b having only three phases;

FIG. 3i has shown an embodiment of a fifth type dc bus level control circuit, a fifth type battery charge circuit, a fifth type power factor correction circuit, a fifth type electric pedal control circuit, or a fifth type soft start circuit;

FIG. 3j has shown an embodiment of the first type dc bus level control circuit, the first type battery charge circuit, the first type power factor correction circuit, or the first type soft start circuit having two positive dc buses;

FIG. 3k has shown an embodiment of the first type dc bus level control circuit, the first type battery charge circuit, the first type power factor correction circuit, or the first type soft start circuit having a positive dc bus and a negative dc bus;

FIG. 3l has shown an embodiment of the first type dc bus level control circuit, the first type battery charge circuit, the first type power factor correction circuit, or the first type soft start circuit having three positive dc buses and a negative dc bus;

FIG. 3m has shown an embodiment of the first type dc bus level control circuit, the first type battery charge circuit, the first type power factor correction circuit, or the first type soft start circuit having two positive dc buses;

FIG. 3n has shown an embodiment of the first type dc bus level control circuit, the first type battery charge circuit, the first type power factor correction circuit, or the first type soft start circuit having n positive dc buses;

FIG. 4a(a) has shown an expression of a multiple-terminal conductive coil of an inductor;

FIG. 4a(b) has shown an another expression of a multiple-terminal conductive coil of an inductor;

FIG. 4b(a) has shown an embodiment of a conductive coil winding around two closed-loop multilayer magnetic cores siding with each other in top view;

FIG. 4b(b) has shown an embodiment of a conductive coil winding around two closed-loop multilayer magnetic cores with one topping on the other in top view;

FIG. 4b(c) has shown an embodiment of a conductive coil winding around a closed-loop multilayer magnetic core;

FIG. 4b(d) is a side view of the first closed-loop multilayer magnetic core of FIG. 4b(a) with a viewing direction shown by an arrow 4213;

FIG. 4b(e) is a side view of the second closed-loop multilayer magnetic core of FIG. 4b(a) with a viewing direction shown by an arrow 4214;

FIG. 4b(f) is a side view of FIG. 4b(b);

FIG. 4b(g) is a side view of FIG. 4b(c);

FIG. 5(a) has shown a prior-art voltage boost circuit;

FIG. 5(b) has shown the prior-art voltage boost circuit of FIG. 5(a) having a low side anti-diode in parallel to the transistor;

FIG. 6a has shown a prior-art open circuit device;

FIG. 6b has shown a first type open circuit device;

FIG. 6c has shown a third type open circuit device;

FIG. 7a has shown an embodiment of a power boost circuit formed by three voltage boost circuits;

FIG. 7b has shown the power boost circuit of FIG. 7(a) with each voltage boost circuit having a positive feedback circuit;

FIG. 7c has shown the embodiment of FIG. 7o with the signal switching the transistor of the voltage boost circuit can be a reference to switch the transistor of the positive feedback circuit so that both the transistors can be synchronous;

FIG. 7d has shown an example of a closed eight-side polygon with each side representing an inductor of a voltage boost circuit of a power boost circuit and each vertex of the closed eight-side polygon represents a coupling capacitor;

FIG. 7e has shown a closed triangle formed with the embodiments of the power boost circuit of FIG. 7a and FIG. 7b with each side of the closed triangle representing an inductor of a voltage boost circuit and each vertex of the triangle represents a coupling capacitor;

FIG. 7f has shown more detailed circuit of the embodiment of the power boost assembly of FIG. 7g having only two power boost circuits for simplicity;

FIG. 7g has shown an embodiment of a power boost assembly having m power boost circuits with each power boost circuit having n voltage boost circuits;

FIG. 7h(a) has shown each inductor of the power boost assembly of FIG. 7(g) is formed by its conductive coil winding around the biggest closed-loop multilayer magnetic core and a closed-loop multilayer magnetic core inside the biggest closed-loop multilayer magnetic core of “the second type n-phase multilayer magnetic core assembly”;

FIG. 7h(b) is a simple expression of FIG. 7h(a);

FIG. 7i(a) has shown each inductor of the power boost assembly of FIG. 7(g) is formed by its conductive coil winding around the biggest closed-loop multilayer magnetic core and a closed-loop multilayer magnetic core inside the biggest closed-loop multilayer magnetic core of “the first type n-phase multilayer magnetic core assembly”;

FIG. 7j has shown an embodiment of a positive feedback circuit based on the voltage boost circuit of FIG. 5(b);

FIG. 7k has shown the embodiment of FIG. 7j with the device and the RC 180° phase-shifter respectively designated by a transient voltage suppressor and a well known 180° phase-shift network formed by three equivalent capacitors and resistors;

FIG. 7l has shown the embodiment of FIG. 7j further comprising a level control detector;

FIG. 7m has shown the embodiment of FIG. 7l further comprising a comparator;

FIG. 7n has shown the embodiment of FIG. 7m further comprising a gas discharge tube and a third diode; and

FIG. 7o has shown the embodiment of FIG. 7n with the device and the RC 180° phase-shifter respectively designated by a transient voltage suppressor and a well known 180° phase-shift network formed by three equivalent capacitors and resistors.

### DETAILED DESCRIPTION OF THE INVENTION

An electric field strength E formed by a voltage applying on a media or a material and current density j in the material can be described as followed:

$$\begin{matrix}j = σ E \\ = σ \frac{V}{d} \\ = \frac{\partial P}{\partial t}\end{matrix}$$

where σ is conductivity of the material and P is polarization of the material by the electric field strength E.

Polarization changing rate

$$\frac{\partial P}{\partial t}$$

relates to capacitance of the material as shown below, where ∈ is dielectric constant of the material and V is voltage applied on the material.

$$E = \frac{V}{d} \\ \begin{matrix}C = ɛ E \\ = ( \frac{ɛ}{σ} ) j \\ = ( \frac{ɛ}{σ} ) \frac{\partial P}{\partial t}\end{matrix} \qquad ( 2 )$$

The equation (2) tells the capacitance of the material is the function of the polarization changing rate

$$\frac{\partial P}{\partial t}$$

of the material and tells how fast the capacitance of the material changes meaning the equation describes the dynamic property of the capacitance of the material by the polarization changing rate.

A dielectric having variable capacitance by an electric field can be described as

$$( \frac{\partial P}{\partial t} ) {\vert}_{t > {t}_{0}} \neq ( \frac{\partial P}{\partial t} ) {\vert}_{t = {t}_{0}}$$

at an initial condition with a first electric field E₀ applied on the dielectric at to and a second electric field E>E₀ is applied at a time t>t₀. E₀ can be zero.

If a dielectric is given

$$( \frac{\partial P}{\partial t} ) {\vert}_{t = {t}_{0}} \neq 0$$

at an initial condition with a first electric field E₀ applied on the dielectric at to and a second electric field E larger than E₀ or E>E₀ is a lied on the dielectric at a time t>t₀ resulting in

$$0 \leq ( \frac{\partial P}{\partial t} ) {\vert}_{t > {t}_{0}} < 1 ,$$

then the capacitance of the dielectric decreases according to equation (2). E₀ can be zero. The

$$\frac{\partial P}{\partial t}$$

at the initial condition takes a time period Δt=t−t₀ to drop in a range between zero and less than one. If take the limit as Δt→0, then it means that the ∂P/∂t at the initial condition immediately drops in zero-wait in a range between zero and less than one. For convenience, it can be expressed by

$$0 \leq {lim}_{Δ t \to 0} ( \frac{\partial P}{\partial t} ) < 1.$$

If a dielectric is given

$$( \frac{\partial P}{\partial t} ) {\vert}_{t = {t}_{0}} \neq 0$$

at an initial condition with a first electric field E₀ applied on the dielectric at to and a second electric field E larger than E₀ or E>E₀ is applied on the dielectric at a time t>t₀ resulting in

$$( \frac{\partial P}{\partial t} ) {\vert}_{t > 0} = 0 ,$$

then the capacitance of the dielectric drops zero or the dielectric is saturated by the second electric field E. For convenience, the dielectric is called “a saturable dielectric” by the second electric field E in the present invention. E₀ can be zero. The

$$\frac{\partial P}{\partial t}$$

at the initial condition takes a time period Δt=t−t₀ to drop to zero. If take the limit as Δt→0, then it means that the

$$\frac{\partial P}{\partial t}$$

at the initial condition immediately drops in zero-wait P to zero, for convenience, it can be expressed by

$${lim}_{Δ t \to 0} ( \frac{\partial P}{\partial t} ) = 0$$

and the dielectric can be called “a zero-wait saturable dielectric” by the second electric field E in the present invention. Obviously, the zero-wait saturable dielectric advantages higher frequency response over the saturable dielectric above.

Two saturable dielectrics having

$${( \frac{\partial P}{\partial t} )}_{1} \neq {( \frac{\partial P}{\partial t} )}_{2} \neq 0$$

at an initial condition with a first electric E₀ applied on the dielectrics at to can be called to have different saturation levels in the present invention. Observed in a conventional P-E hysteresis loop pattern of a material, as electric field E increases, the polarization P approaches a maximum value asymptotically, the saturation level for the material. Obviously, a material having rectangular or square P-E loop is a saturable material.

In P-E domain, when a material in saturation, the polarization P presents no change or dP=0 also naturally satisfying

$$( \frac{\partial P}{\partial t} ) = 0$$

so that the prior-art “saturation in P-E domain” is only a special case of the saturation in P-T domain defined in the present invention. In P-E domain can tell “saturation” but doesn't say anything about how fast goes into saturation. For example, a square P-E loop of a material in a P-E domain is surely a saturable material but nothing talks about how fast goes into saturation. The present invention has a new definition for “saturation” defined in P-T domain and has also revealed how fast goes into saturation.

The polarization changing rate

$$\frac{\partial P}{\partial t}$$

can be used to describe the dynamic characteristic of a capacitor. An inventive capacitor can be revealed on the theory of the polarization changing rate

$$\frac{\partial P}{\partial t} .$$

For a capacitor having two electrodes and a dielectric, q=cv, where v is a voltage across the two electrodes of the capacitor and electrical energy stored in the capacitor can be simply expressed by equation

$${E}_{1} = \frac{1}{2} c {υ}^{2} .$$

If c of the capacitor changes to

$$\frac{c}{a} ,$$

then v changes to av according to equation

$$q = cv = ( \frac{c}{a} ) ( av )$$

for the same
capacitor and electrical energy stored in the capacitor becomes

$${E}_{2} = \frac{1}{2} ( \frac{c}{a} ) {( av )}^{2} = \frac{1}{2} {acv}^{2} = {aE}_{1} .$$

The result has revealed that if a>1, the capacitance c decreases and the electrical energy stored in the capacitor increases and if a<1, the capacitance c increases and the electrical energy stored in the capacitor decreases. For a>1, the capacitor is an electrical energy amplifier or a dielectric amplifier, and obviously, a bigger capacitance drop can lead to a bigger electrical energy amplification. For a<1, the capacitor is an electrical energy absorber or a dielectric absorber. a decides the change of capacitance c which is related to

$$\frac{\partial P}{\partial t}$$

as revealed earlier by the equation.

If an electrical short between the first conductive electrode and the second conductive electrode can take place when all the plurality of saturable dielectric layers are saturated, then at least one of the first conductive electrode and the second conductive electrode has a considerable resistance for providing protection to the electrical short between the first conductive electrode and the second conductive electrode.

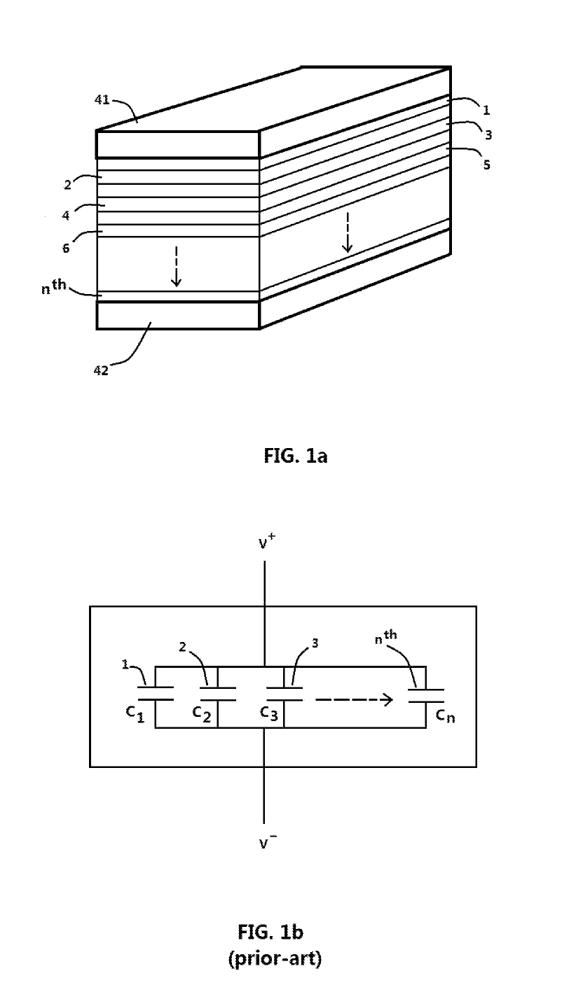

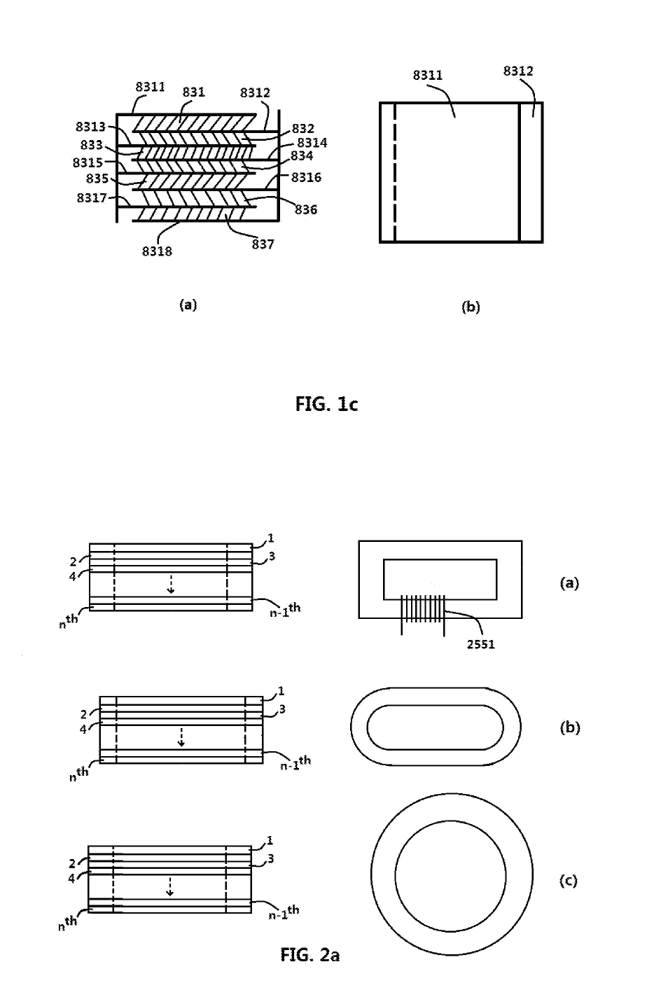

A multilayer capacitor with any shape is formed by a first conductive electrode, a second conductive electrode and a plurality of dielectric layers with one dielectric layer laying on another dielectric layer stacked up together situated between the first conductive electrode and the second conductive electrode as shown in an embodiment of FIG. 1a. FIG. 1a has shown a multilayer capacitor formed by n dielectric layers sandwiched between a first conductive electrode 41 and a second conductive electrode 42.

An inventive multilayer capacitor having variable capacitances can be described by

$${( \frac{\partial P}{\partial t} )}_{i} {{\vert}_{t > {t}_{0}} \neq {( \frac{\partial P}{\partial t} )}_{i} \vert}_{t = {t}_{0}} ,$$

where i≧1 and i stands for any one dielectric layer of the multilayer capacitor, at an initial condition with a first electric field E₀ applied on the multilayer capacitor at to and a second electric field E larger than E₀ or E>E₀ is applied on the multilayer capacitor when t>t₀. E₀ can be zero.

A first embodiment of the inventive multilayer capacitor can be described by: given

$${( \frac{\partial P}{\partial t} )}_{1} \neq {( \frac{\partial P}{\partial t} )}_{2} \neq … \neq {( \frac{\partial P}{\partial t} )}_{n} \neq 0$$

meaning the inventive multilayer capacitor having n dielectric layers with different non-zero

$$\frac{\partial P}{\partial t}$$

from each other or given

$${( \frac{\partial P}{\partial t} )}_{1} \neq 0 , {( \frac{\partial P}{\partial t} )}_{2} \neq 0 , … , {( \frac{\partial P}{\partial t} )}_{n} \neq 0 and {( \frac{\partial P}{\partial t} )}_{i} = {( \frac{\partial P}{\partial t} )}_{j} ,$$

where 1≦i≠j≦n, meaning the inventive multilayer capacitor having n dielectric layers respectively having a non-zero

$$\frac{\partial P}{\partial t}$$

and any tow dielectric layers can have same

$$\frac{\partial P}{\partial t}$$

at an initial condition with a first electric field E₀ applied on the multilayer capacitor at t=t₀, and a second electric field E₀ larger than E₀ or E>E₀ is applied on the multilayer capacitor when t>t₀ resulting in

$$0 \leq {( \frac{\partial P}{\partial t} )}_{k} {\vert}_{t > {t}_{0}} < 1 ,$$

where 1≦k≦n and k stands for any one dielectric layer of the multilayer capacitor, meaning the

$$\frac{\partial P}{\partial t}$$

of at least one dielectric layer of the multilayer capacitor varies between zero and less than one by the second electric field E.

A second embodiment of the inventive multilayer capacitor based on the first embodiment of the inventive multilayer capacitor, the

$${( \frac{\partial P}{\partial t} )}_{k}$$

of a k^{th} dielectric layer of the multilayer capacitor at the initial condition takes a time period Δt=t−t₀ to drop in a range between zero and less than one. If take the limit as Δt→0 or expressed by

$$0 \leq {lim}_{Δ t \to 0} {( \frac{\partial P}{\partial t} )}_{k} < 1 ,$$

then it means that the

$${( \frac{\partial P}{\partial t} )}_{k}$$

of the k^{th} dielectric layer of the multilayer capacitor at the initial condition immediately drops in zero-wait in a range between zero and less than one.

A third embodiment of the inventive multilayer capacitor can be described by: (1) given

$${( \frac{\partial P}{\partial t} )}_{1} \neq {( \frac{\partial P}{\partial t} )}_{2} \neq … \neq {( \frac{\partial P}{\partial t} )}_{n} \neq 0$$

meaning the inventive multilayer capacitor having n dielectric layers with different non-zero

$$\frac{\partial P}{\partial t}$$

from each other or given

$${( \frac{\partial P}{\partial t} )}_{1} \neq 0 , {( \frac{\partial P}{\partial t} )}_{2} \neq 0 , … , {( \frac{\partial P}{\partial t} )}_{n} \neq 0 and {( \frac{\partial P}{\partial t} )}_{i} = {( \frac{\partial P}{\partial t} )}_{j} ,$$

where 1≦i≠j≦n, meaning the inventive multilayer capacitor having n dielectric layers respectively having a n-zero

$$\frac{\partial P}{\partial t}$$

and any two dielectric layers can have same

$$\frac{\partial P}{\partial t}$$

an initial condition with a first electric field E₀ applied on the multilayer capacitor at t=t₀, and (2) a second electric field E larger than E₀ or E>E₀ is applied on the multilayer capacitor when t>t₀ resulting

$$0 \leq {( \frac{\partial P}{\partial t} )}_{k} {\vert}_{t > {t}_{0}} < 1 ,$$

where ∀ k=1, 2, . . . , n meaning the

$$\frac{\partial P}{\partial t}$$

respectively of all the dielectric layers of the multilayer capacitor drop between zero and less than one.

A fourth embodiment of the inventive multilayer capacitor based on the third embodiment of the inventive multilayer capacitor, the

$${( \frac{\partial P}{\partial t} )}_{k}$$

of a k^{th} dielectric layer of the multilayer capacitor at the initial condition takes a time period Δt=t−t₀ to drop in a range between zero and less than one. If take the limit as Δt→0 or expressed by

$$0 \leq {lim}_{Δ t \to 0} {( \frac{\partial P}{\partial t} )}_{k} < 1 ,$$

then it means that the

$${( \frac{\partial P}{\partial t} )}_{k}$$

of the k^{th} dielectric layer of the multilayer capacitor at the initial condition immediately drops in zero-wait in a range between zero and less than one.

A fifth embodiment of the inventive multilayer capacitor can be described by: given

$${( \frac{\partial P}{\partial t} )}_{1} \neq {( \frac{\partial P}{\partial t} )}_{2} \neq … \neq {( \frac{\partial P}{\partial t} )}_{n} \neq 0$$

meaning the inventive multilayer capacitor having n dielectric layers with different non-zero

$$\frac{\partial P}{\partial t}$$

from each other or given

$${( \frac{\partial P}{\partial t} )}_{1} \neq 0 , {( \frac{\partial P}{\partial t} )}_{2} \neq 0 , … , {( \frac{\partial P}{\partial t} )}_{n} \neq 0 and {( \frac{\partial P}{\partial t} )}_{i} = {( \frac{\partial P}{\partial t} )}_{j} ,$$

for 1≦i≠j≦n meaning the inventive multilayer capacitor having n dielectric layers respectively having a non-zero

$$\frac{\partial P}{\partial t}$$

and any two dielectric layers can have same

$$\frac{\partial P}{\partial t}$$

at an initial condition with a first electric field E₀ applied on the multilayer capacitor at t=t₀, and a second electric field E larger than E₀ or E>E₀ is applied on the multilayer capacitor when t>t₀ resulting in

$${( \frac{\partial P}{\partial t} )}_{k} = 0 ,$$

where 1≦k≦n, where k stands for any one dielectric layer of the multilayer capacitor, meaning at least one dielectric layer of the multilayer capacitor will saturate.

A sixth embodiment of the inventive multilayer capacitor based on the fifth embodiment of the inventive multilayer capacitor, the

$${( \frac{\partial P}{\partial t} )}_{k}$$

of a k^{th} dielectric layer of the multilayer capacitor at the initial condition takes a time period at =t−t₀ to drop to zero. If take the limit as Δt→0 or expressed by

$${lim}_{Δ t -> 0} {( \frac{\partial P}{\partial t} )}_{k} = 0 ,$$

then it means that the

$${( \frac{\partial P}{\partial t} )}_{k}$$

of the k^{th} dielectric layer of the multilayer capacitor at the initial condition immediately drops in zero-wait to zero.

A seventh embodiment of the inventive multilayer capacitor can be described by: (1) given

$${( \frac{\partial P}{\partial t} )}_{1} \neq {( \frac{\partial P}{\partial t} )}_{2} \neq … \neq {( \frac{\partial P}{\partial t} )}_{n} \neq 0$$

meaning the inventive multilayer capacitor having n dielectric layers with different non-zero

$$\frac{\partial P}{\partial t}$$

from each other or given

$${( \frac{\partial P}{\partial t} )}_{1} \neq 0 , {( \frac{\partial P}{\partial t} )}_{2} \neq 0 , … , {( \frac{\partial P}{\partial t} )}_{n} \neq 0 and {( \frac{\partial P}{\partial t} )}_{i} = {( \frac{\partial P}{\partial t} )}_{j} ,$$

for 1≦i≠j≦n meaning the inventive multilayer capacitor having n dielectric layers respectively having a non-zero

$$\frac{\partial P}{\partial t}$$

and any two dielectric layers can have same

$$\frac{\partial P}{\partial t}$$

at an initial condition with a first electric field E₀ applied on the multilayer capacitor at t=t₀, and (2) a second electric field E₀ larger than E₀ or E>E₀ is applied on the multilayer capacitor when t>t₀ resulting in

$${( \frac{\partial P}{\partial t} )}_{k} = 0 ,$$

where ∀ k=1, 2, 3, . . . , n, meaning the

$$\frac{\partial P}{\partial t}$$

respectively of all the dielectric layers of the multilayer capacitor drop to zero. This multilayer capacitor is called “a fully saturable multilayer capacitor” in the present invention.

An eighth embodiment of the inventive multilayer capacitor based on the seventh embodiment of the inventive multilayer capacitor, the

$${( \frac{\partial P}{\partial t} )}_{k}$$

of a k^{th} dielectric layer of the multilayer capacitor at the initial condition takes a time period Δt=t−t₀ to drop to zero. If take the limit as Δt→0 or expressed by

$${lim}_{Δ t -> 0} {( \frac{\partial P}{\partial t} )}_{k} = 0 ,$$

then it means that the

$${( \frac{\partial P}{\partial t} )}_{k}$$

of the k^{th} dielectric layer of the multilayer capacitor at the initial condition immediately drops in zero-wait to zero. For convenience, the multilayer capacitor is called “a zero-wait fully saturable multilayer capacitor” in the present invention.

A nineth embodiment of the inventive multilayer capacitor can be described by:

$${( \frac{\partial P}{\partial t} )}_{1} \neq {( \frac{\partial P}{\partial t} )}_{2} \neq … \neq {( \frac{\partial P}{\partial t} )}_{n} \neq 0$$

meaning the inventive multilayer capacitor having n dielectric layers with different non-zero

$$\frac{\partial P}{\partial t}$$

from each other or given

$${( \frac{\partial P}{\partial t} )}_{1} \neq 0 , {( \frac{\partial P}{\partial t} )}_{2} \neq 0 , … , {( \frac{\partial P}{\partial t} )}_{n} \neq 0 and {( \frac{\partial P}{\partial t} )}_{i} = {( \frac{\partial P}{\partial t} )}_{j} ,$$

for 1≦i≠j≦n meaning the inventive multilayer capacitor having n dielectric layers respectively having an non-zero

$$\frac{\partial P}{\partial t}$$

and any two dielectric layers can have same

$$\frac{\partial P}{\partial t}$$

at an initial condition with a first electric field E₀ applied on the multilayer capacitor at t=t₀, and (2) a second electric field E larger than E₀ or E>E₀ is applied on the multilayer capacitor when t>t₀ resulting in

$${( \frac{\partial P}{\partial t} )}_{k} = 0 ,$$

where 1≦k<n, meaning only a portion of the dielectric layers of the multilayer capacitor are saturated by the second electric field E. This multilayer capacitor is called a partially saturable multilayer capacitor in the present invention.

A tenth embodiment of the inventive multilayer capacitor based on the nineth embodiment of the inventive multilayer capacitor, the

$${( \frac{\partial P}{\partial t} )}_{k}$$

of a k^{th} dielectric layer of the multilayer capacitor at the initial condition takes a time period Δt=t−t₀ to drop to zero. If take the limit as Δt→0 or expressed by

$${lim}_{Δ t -> 0} {( \frac{\partial P}{\partial t} )}_{k} = 0 ,$$

then it means that the

$${( \frac{\partial P}{\partial t} )}_{k}$$

of the k^{th} dielectric layer of the multilayer capacitor at the initial condition immediately drops in zero-wait to zero. For convenience, the multilayer capacitor is called a zero-wait partially saturable multilayer capacitor in the present invention.

An eleventh embodiment of the inventive multilayer capacitor can be described by: (1) given

$${( \frac{\partial P}{\partial t} )}_{1} \neq {( \frac{\partial P}{\partial t} )}_{2} \neq … \neq {( \frac{\partial P}{\partial t} )}_{n} \neq 0$$

meaning the inventive multilayer capacitor having n dielectric layers with different non-zero

$$\frac{\partial P}{\partial t}$$

from each other or given

$${( \frac{\partial P}{\partial t} )}_{1} \neq 0 , {( \frac{\partial P}{\partial t} )}_{2} \neq 0 , … , {( \frac{\partial P}{\partial t} )}_{n} \neq 0 and {( \frac{\partial P}{\partial t} )}_{i} = {( \frac{\partial P}{\partial t} )}_{j} ,$$

for 1≦i≠j≦n meaning the inventive multilayer capacitor having n dielectric layers respectively having a non-zero

$$\frac{\partial P}{\partial t}$$

and any two dielectric layers can have same

$$\frac{\partial P}{\partial t}$$

at an initial condition with a first electric field E₀ applied on the multilayer capacitor at t=t₀, and (2) a second electric field E larger than E₀ or E>E₀ is applied on the multilayer capacitor when t>t₀ resulting in

$${( \frac{\partial P}{\partial t} )}_{k}$$

=0, for ∀ k=1, 2, 3, . . . (n−1) and

$${( \frac{\partial P}{\partial t} )}_{k} \neq 0 ,$$

for k=n, meaning only one dielectric layer of the multilayer capacitor is not saturated by the second electric field E and the rest of the dielectric layers of the multilayer capacitor are saturated by the second electric field E. Obviously, the inventive multilayer capacitor in the eleventh embodiment is a partially saturable multilayer capacitor.

A twelfth embodiment of the inventive multilayer capacitor based on the eleventh embodiment of the inventive multilayer capacitor, the

$${( \frac{\partial P}{\partial t} )}_{k}$$

of a k^{th} dielectric layer of the multilayer capacitor at the initial condition takes a time period Δt=t−t₀ to drop to zero. If take the limit as Δt→0 or expressed by

$${lim}_{Δ t -> 0} {( \frac{\partial P}{\partial t} )}_{k} = 0$$

for ∀ k=1, 2, 3, . . . (n−1), then it means that the

$${( \frac{\partial P}{\partial t} )}_{k}$$

of the k^{th} dielectric layer of the multilayer capacitor at the initial condition immediately drops in zero-wait to zero. Obviously, the multilayer capacitor in the twelfth embodiment is a zero-wait partially saturable multilayer capacitor in the present invention.

The capacitance of the fully saturable multilayer capacitor drops to zero when all the dielectric layers of the multilayer capacitor are saturated to electrically connect the first conductive electrode with the second conductive electrode of the multilayer capacitor.

For convenience, the inventive multilayer capacitor including in all the embodiments is called a first type multilayer capacitor in the present invention.

The electric field is not limited to any particular electric field, for example, the electric field can be a voltage applied across the first conductive electrode and the second conductive electrode of the inventive multilayer capacitor, a current flowing through the first conductive electrode and the second conductive electrode of the inventive multilayer capacitor, or an electric field nearby electrically coupling the dielectric layers of the inventive multilayer capacitor.

Any one dielectric layer of the first type multilayer capacitor can be made of nano treated materials featuring higher mobility or conductivity advantaging for higher frequency responses capability. The nano treated material is not limited to any particular nano treated material, for example, the nano treated material can be carbon nano tube (or CNT), graphene, conductive nano silicon or conductive nano metal.

The multiple saturations with different

$$\frac{\partial P}{\partial t}$$

are explained. Assuming n saturable dielectric layers are in the first type multilayer capacitor. When an electric field built between the two electrodes goes up to saturate any one of n saturable dielectric layers, for example, a first dielectric layer, and then n−1 saturable dielectric layers become to sustain the electric field or the possibly still growing electric field meaning each dielectric layer of the n−1 saturable dielectric layers becomes to be distributed by a bigger electric field as the result of the saturation of the first dielectric layer so that the n−1 saturable dielectric layers can be easier saturated, for example, then a second dielectric layer becomes saturated, and then n−2 saturable dielectric layers become to sustain the electric field or each dielectric layer of the n−2 saturable dielectric layers is distributed by a bigger electric field as the result of the saturations of the first dielectric layer and the second dielectric layer and the possibly still growing electric field to further easier to saturate any one of n−2 saturable dielectric layers, for example, a third dielectric layer becomes saturated this time, and a chain of saturations continues until a final dielectric layer is saturated, which has featured multiple landsliding saturations of all the saturable dielectric layers.

Each saturation can produce a voltage jump expressed by v₁=a₁v for a₁>1, where v is an applied voltage and v₁ is a jump voltage after each saturation. Each of the multiple saturations can be expressed by v₁=a₁v, v₂=a₂v₁, v₃=a₃v₂, and v₄=a₄v₃, where v is an applied voltage, v₁ is a first voltage jump by a first saturation, v₂ is a second voltage jump by a second saturation, v₃ is a third voltage jump by a third saturation, and v₄ is a fourth voltage jump on the gate by a fourth saturation and a₁, a₂, a₃ and a₄ are respectively larger than 1. According to v₁=a₁v, v₂=a₂v₁, v₃=a₃v₂, and v₄=a₄v₃ obtains v₄=a₁a₂a₃a₄v, which means that the final jump voltage is decided by the multiplications of a₁a₂a₃a₄ for all larger than 1 and the result of multiplication can be very high.

The first type multilayer capacitor including its all the embodiments discussed above can further comprise a PDR device and a NDR device, and the PDR device, the NDR device and the dielectric layer or dielectric layers are electrically connected in series with each other.

The first conductive electrode of the first type multilayer capacitor can be made of a PDR device and the second conductive electrode of the first type multilayer capacitor can be made of a NDR device or the first conductive electrode of the first type multilayer capacitor can be made of a NDR device and the second conductive electrode of the first type multilayer capacitor can be made of a PDR device, if those are the cases, the PDR device and the NDR device are made of conductive materials. For convenience, the first type multilayer capacitor including all the embodiments having a PDR device and a NDR device is called a second type multilayer capacitor in the present invention. The second type multilayer capacitor has featured a RC network having variable resistances and capacitances so that its bandwidth is a lot more broadened than that of the first type multilayer capacitor.

Because the PDR device and the NDR device electrically connected in series forms a damper which can dissipate electric power flowing through them so that the first type multilayer capacitor having a PDR device and a NDR device can be viewed as an inventive damper. For convenience, the first type multilayer capacitor having a PDR device and a NDR device is also called “a first type multilayer capacitor damper” in the present invention. The capacitance of a fully saturable multilayer capacitor drops to zero when all the dielectric layers of the fully multilayer capacitor are saturated to electrically connect the first conductive electrode with the second conductive electrode of the fully multilayer capacitor so that any electrical energy that includes ac and dc can pass through the multilayer capacitor and the electrical energy ac and dc can be dissipated by the PDR device and the NDR device electrically connected in series. A partially saturable multilayer only passes ac. The PDR device and the NDR device can respectively be a dielectric layer disposed between the first conductive electrode and the second conductive electrode of the first type multilayer capacitor.

It has also been known that the equivalent capacitance of a plurality of capacitors electrically connected in parallel with each other is the sum of the capacitance of each capacitor of the plurality of capacitors. FIG. 1b has shown a capacitor assembly formed by a plurality of component capacitors electrically connected in parallel with each other. The equivalent capacitance C of the capacitor assembly is the sum of the capacitance of each component capacitor as shown by C=C₁+C₂+C₃+ - - - +Cₙ. An expected equivalent capacitance of the plurality of component capacitors electrically connected in parallel with each other can be obtained depending on the number of the component capacitors. If the capacitance of a component capacitor of the capacitor assembly drops to zero by an electric field to electrically connect the two electrodes of the component capacitor, then the component capacitor can be viewed to become a conductor or a conductive resistor and then current will choose to go through the conductive resistor and the equivalent capacitance of the capacitor assembly will drop to zero by the electric field. For example, if the capacitance C₃ of a component capacitor drops to zero at a time by an electric field, then the equivalent capacitance C of the capacitor assembly drops to zero by the electric filed at the time. When the electric field is removed, the capacitance C₃ of the component capacitor restores to a non-zero capacitance and the equivalent capacitance C of the capacitor assembly restores to a non-zero capacitance.

The first type fully saturable multilayer capacitor or the second type fully saturable multilayer capacitor can be electrically connected in parallel with a plurality of capacitors with each other to form an capacitor assembly having an expected equivalent capacitance. When the first type fully saturable multilayer capacitor or the second type fully saturable multilayer capacitor is saturated to electrically connect the first electrode with the second electrode viewed as a conductive resistor, current will choose to go through the conductive resistor so the equivalent capacitance of the capacitor assembly will drop from the expected capacitance to zero. For convenience, the capacitor assembly having the first type fully saturable multilayer capacitor including its embodiment is called a third type fully saturable multilayer capacitor in the present invention and the capacitor assembly having the second type fully saturable multilayer capacitor including its embodiment is called a fourth type fully saturable multilayer capacitor in the present invention.

The embodiment of the third type fully saturable multilayer capacitor and the fourth type fully saturable multilayer capacitor of FIG. 1b can respectively be in a form shown in an embodiment of FIG. 1c, a left drawing FIG. 1c(a) of FIG. 1c has shown a capacitor assembly having an expected capacitance in side view formed by a plurality of component capacitors, for simplification only seven component capacitors are demonstrated although the present invention is not so limited, electrically connected in parallel with each other respectively as a first component capacitor 831 formed by a first conductive electrode 8311 and a second conductive electrode 8312, a second component capacitor 832 formed by the second conductive electrode 8312 and a third conductive electrode 8313, a third component capacitor 833 formed by the third conductive electrode 8313 and a fourth conductive electrode 8314, a fourth component capacitor 834 formed by the fourth conductive electrode 8314 and a fifth conductive electrode 8315, a fifth component capacitor 835 formed by the fifth conductive electrode 8315 and a sixth conductive electrode 8316, a sixth component capacitor 836 formed by the sixth conductive electrode 8316 and a seventh conductive electrode 8317 and a seventh component capacitor 837 formed by the seventh conductive electrode 8317 and an eighth conductive electrode 8318 stacked up together with one electrode of a component capacitor shared with another component capacitor. For example, the third electrode 8313 is shared by the second component capacitor 832 and the third component capacitor 833. One electrode of each component capacitor of the plurality of component capacitors are electrically connected together to form a first conductive electrode of the capacitor assembly and the other electrode of each component capacitor of the plurality of component capacitors are electrically connected together to form a second conductive electrode of the capacitor assembly as shown in the embodiment of FIG. 1b. A right drawing FIG. 1c(b) of FIG. 1c is the top view of the left drawing of FIG. 1c(a) showing that the first conductive electrode 8311 the eighth conductive electrode 8318 respectively having an area.

The capacitor assembly is the third type fully saturable multilayer capacitor if any one of the plurality of component capacitors is the first type fully saturable multilayer capacitor by an electric field, and the capacitor assembly is the fourth type fully saturable multilayer capacitor if any one of the plurality of component capacitors is the second type fully saturable multilayer capacitor by an electric field.

The third type fully saturable multilayer capacitor and the fourth type fully saturable multilayer capacitor can respectively have a capacitance variations in a range between zero and an expected non-zero number by an electric field.

The number of component capacitors of the third type fully saturable multilayer capacitor and the fourth type fully saturable multilayer capacitor is respectively not limited to any particular number.

The capacitance drop of the multilayer capacitor increases the electrical energy stored in the multilayer capacitor so that the first type multilayer capacitor including its embodiments, the second type multilayer capacitor including its embodiments, the third type fully saturable multilayer capacitor including its embodiments and the fourth type fully saturable multilayer capacitor including its embodiments having capacitance drop by an electric field can respectively be an electrical amplifier.

A finger touching or pressing a capacitor shortens the distance between the two electrodes of the capacitor resulting in increasing the electric field across the two electrodes of the capacitor. If the first electric field E₀ is formed by a voltage applied across the two electrodes of the multilayer capacitor and the second electric field E is formed by a finger touching or pressing the multilayer capacitor to shorten the distance between the two electrodes, then the first type multilayer capacitor including its all the embodiments can be a touch panel. The capacitance drop of the multilayer capacitor leads to a transient voltage increasing taken at the first conductive electrode and the second conductive electrode as a signal indicating a pressing on the multilayer capacitor. For convenience, the first type multilayer capacitor including its all the embodiments is called a first type touch panel in the present invention. The first conductive electrode of the first type touch panel can be made of a PDR device and the second conductive electrode of the first type touch panel can be made of a NDR device or the first conductive electrode of the first type touch panel can be made of a NDR device and the second conductive electrode of the first type touch panel can be made of a PDR device. For convenience, the first type touch panel having the PDR device and the NDR device is called a second type touch panel in the present invention. The PDR device also functions to limit the current as current limiter. The second touch panel has featured a RC network having variable capacitances and resistances advantaging for higher sensitivity. The third type fully saturable multilayer capacitor and the fourth type fully saturable multilayer capacitor are respectively a touch panel.

A FET (field-effect transistor) and an IGBT (insulated gate bipolar transistor) are well known that its gate is electrically isolated from its body having drain and source for FET and its body having collector and emitter for IGBT. The inventive first type multilayer capacitor, second type multilayer capacitor, third type multilayer capacitor or fourth type multilayer capacitor respectively including all its embodiments can be the gate of a FET and an IGBT if it is electrically isolated from its body such as by having an insulator between the body and a conductive electrode of the capacitor or replacing a conductive electrode of the capacitor close to the body with an insulator. The capacitance drop of the gate can quickly raise the voltage on the gate resulting in quickly turning on a n-type FET and an IGBT or quickly turning off a p-type FET.

For example, an embodiment, assuming n saturable dielectric layers are in the first type multilayer capacitor. When an electric field built between the two electrodes goes up to saturate any one of n saturable dielectric layers, for example, a first dielectric layer, and then n−1 saturable dielectric layers become to sustain the electric field or the possibly still growing electric field meaning each dielectric layer of the n−1 saturable dielectric layers becomes to be distributed by a bigger electric field as the result of the saturation of the first dielectric layer so that the n−1 saturable dielectric layers can be easier saturated, for example, then a second dielectric layer becomes saturated, and then n−2 saturable dielectric layers become to sustain the electric field or each dielectric layer of the n−2 saturable dielectric layers is distributed by a bigger electric field as the result of the saturations of the first dielectric layer and the second dielectric layer and the possibly still growing electric field to further easier to saturate any one of n−2 saturable dielectric layers, for example, a third dielectric layer becomes saturated this time, and a chain of saturations continues until a final dielectric layer is saturated, which has featured multiple landsliding saturations of all the saturable dielectric layers.

Each saturation can produce a voltage jump expressed by v₁=a₁v for a₁>1, where v is an applied voltage and v₁ is a jump voltage after each saturation. Each of the multiple saturations can be expressed by v₁=a₁v, v₂=a₂v₁, v₃=a₃v₂, and v₄=a₄v₃, where v is an applied voltage, v₁ is a first voltage jump by a first saturation, v₂ is a second voltage jump by a second saturation, v₃ is a third voltage jump by a third saturation, and v₄ is a fourth voltage jump on the gate by a fourth saturation and a₁, a₂, a₃ and a₄ are respectively larger than 1. According to v₁=a₁v, v₂=a₂v₁, v₃=a₃v₂, and v₄=a₄v₃ obtains v₄=a₁a₂a₃a₄v, which means that the final jump voltage is decided by the multiplications of a₁a₂a₃a₄ for all larger than 1 and the result of multiplication can be very high.

The quick voltage jump of the gate through the multiple saturations advantages to quickly turn on a n-type FET and an IGBT or turn off a p-type FET and the transistor can be so quickly turned on or off meaning the so called “Miller effect” can be cancelled.

Reviewing the Faraday's induction law,

$$V = L \frac{d i}{d t}$$

where V is a voltage across an inductor, L is inductance of the inductor and i is current flowing through a conductive coil of the inductor.

An energy stored in the inductor can be described as

$$E = \frac{1}{2} {Li}^{2}$$

Faraday's induction law above can also be described as

$$V = ( \frac{L}{a} ) ( \frac{a d i}{d t} )$$

If a>1, then

$$\frac{L}{a}$$

is smaller than L meaning the inductance of the inductor becomes smaller. If L of the inductor changes to

$$\frac{L}{a} ,$$

then

$$\frac{d i}{d t}$$

changes to

$$\frac{a d i}{d t}$$

according to equation

$$V = L \frac{d i}{d t} = ( \frac{L}{a} ) ( \frac{a d i}{d t} )$$

for the same inductor and electrical energy stored in the capacitor becomes

$$\begin{matrix}{E}_{2} = \frac{1}{2} ( \frac{L}{a} ) {( ai )}^{2} \\ = a ( \frac{1}{2} {Li}^{2} ) \\ = {aE}_{1} > {E}_{1}\end{matrix} \qquad ( 3 )$$

such that the stored energy becomes larger if a>1 or the inductance L becomes smaller.

It has been known that the prior-art LC oscillator comprises a capacitor and an inductor forming an electrically closed loop with the capacitor. An inventive LC oscillator comprises the inventive multilayer capacitor revealed above in the present invention and an inventive inductor revealed in our previous patent with public no. Before going further, a multilayer inductor is introduced.

A multilayer device with any shape can be formed by a plurality of layers (or n layers for n≧2) with one layer laying on another layer stacked up together. The multilayer device is a multilayer magnetic core if the plurality of layers have a least two magnetic conductors (or m magnetic conductors for m≧2). The n and the m can be same or different. The n and the m are same meaning all the layers are magnetic conductor layers. The n and the m are different meaning only a portion of the n layers are magnetic conductor layers. For example, assuming the multilayer magnetic core has 10 layers, all the 10 layers can be a magnetic conductor layers meaning n=m or a layer 1, a layer 3, a layer 5, a layer 7 and a layer 9 are magnetic conductor layers and a layer 2, a layer 4, a layer 6, a layer 8 and a layer 10 are not magnetic conductor layers such as electrically insulating layers.

Any two of the plurality of magnetic conductor layers of the multilayer magnetic core can have same or different saturation levels by a current flowing through a conductive coil winding around the plurality of magnetic conductor layers, a static magnet nearby magnetically coupling the plurality of magnetic conductor layers, or an induced magnetic field nearby magnetically coupling the plurality of magnetic conductor layers.

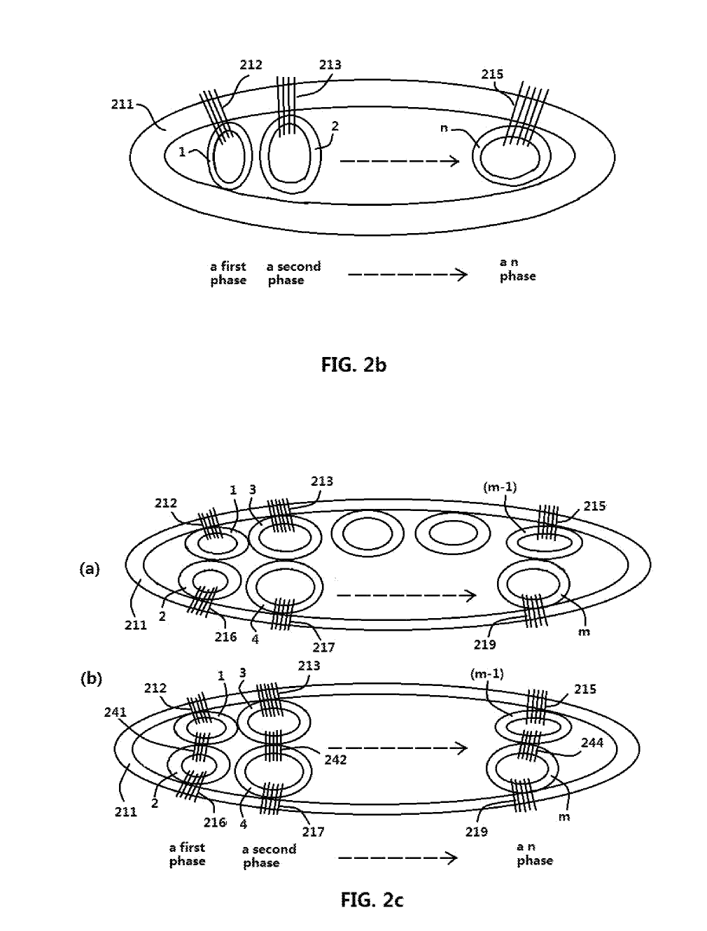

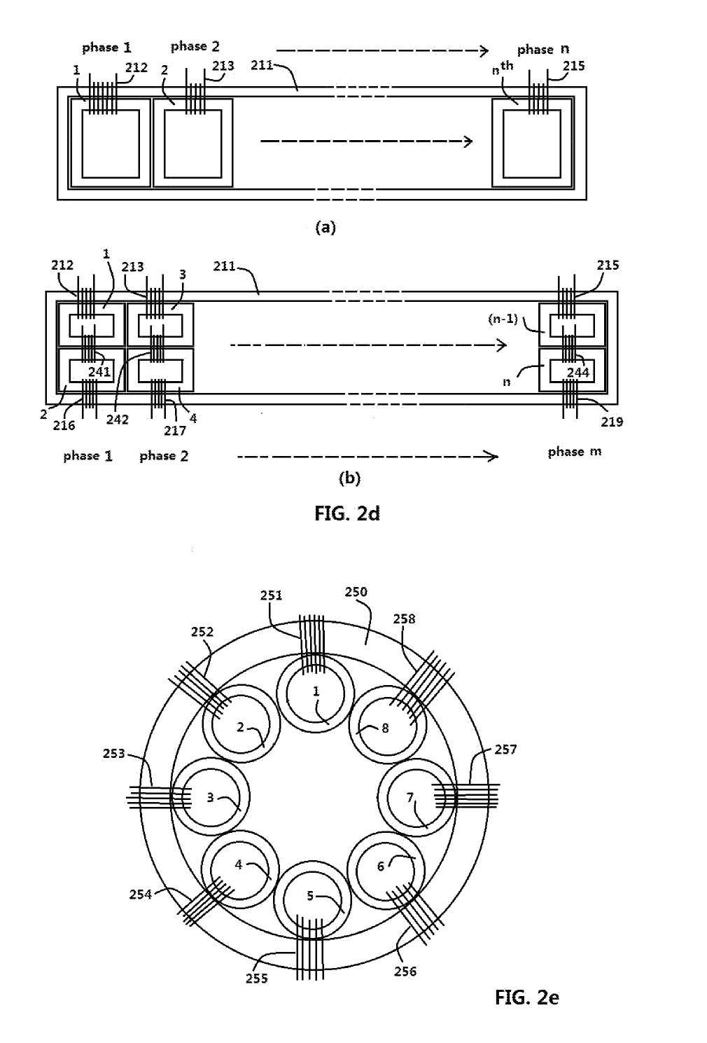

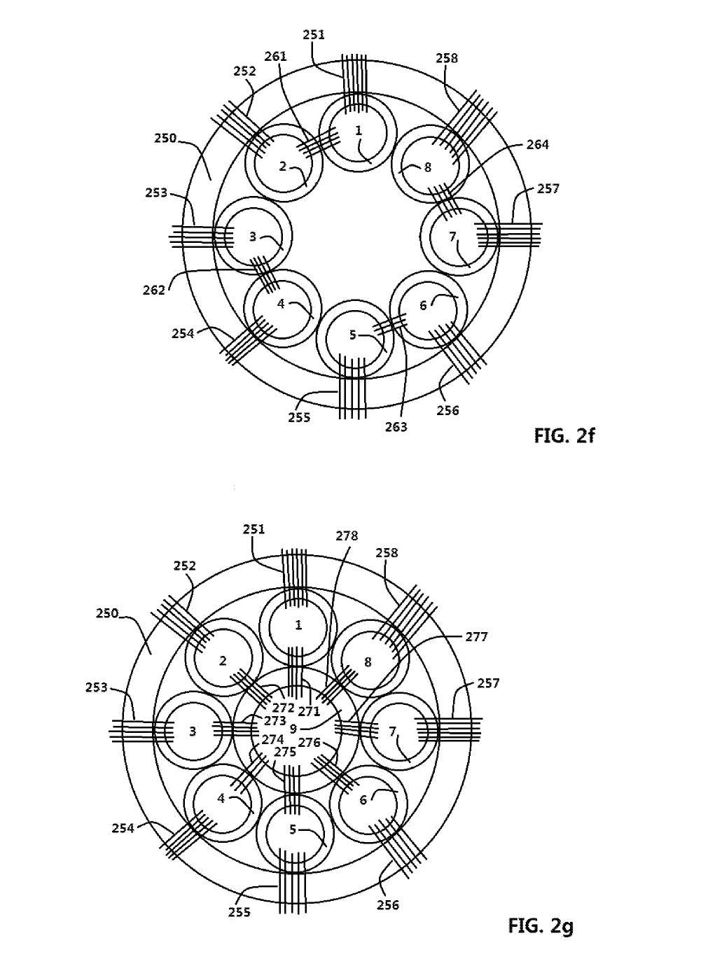

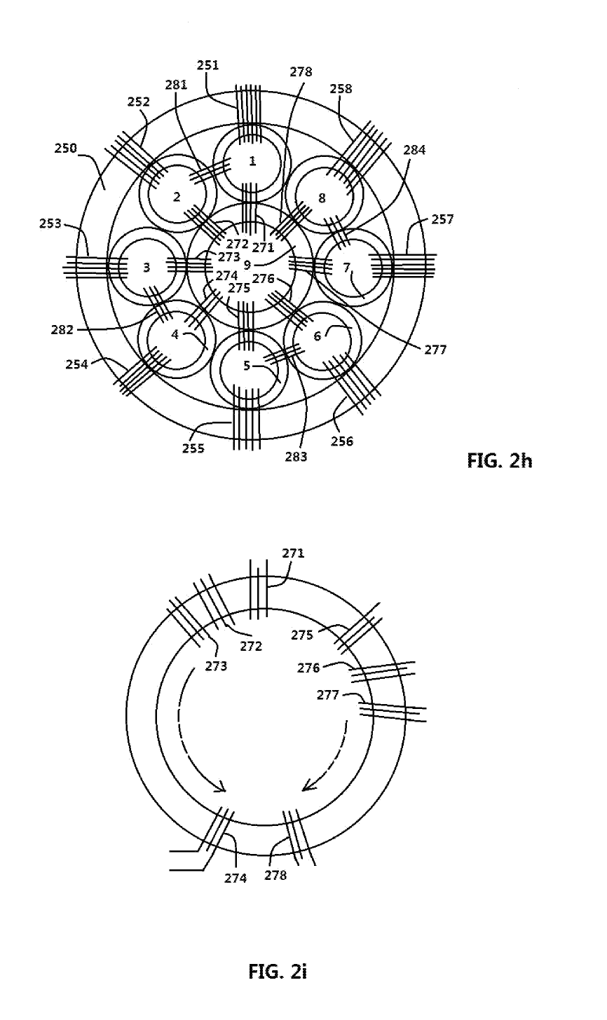

The multilayer magnetic core is not limited to any particular shape, for example, the multilayer magnetic core can be in a closed loop with any shape such as a square closed-loop magnetic core in top view as shown in the right drawing of FIG. 2a(a), an oval-shaped closed-loop magnetic core in top view as shown in the right drawing of FIG. 2a(b), and a round closed-loop magnetic core in top view as shown in the right drawing of FIG. 2a(c) with each having a plurality of layers comprising a plurality of magnetic conductor layers respectively shown as the left drawing of each of FIG. 2a(a), FIG. 2a(b) and FIG. 2a(c), which respectively are the side view of the right drawing of FIG. 2a(a), FIG. 2a(b) and FIG. 2a(c). For convenience, the multilayer magnetic core in closed loop can be called closed-loop multilayer magnetic core in the present invention. It has been known that the closed-loop multilayer magnetic core has continuous magnetic flux for having better magnetically conductive efficiency.

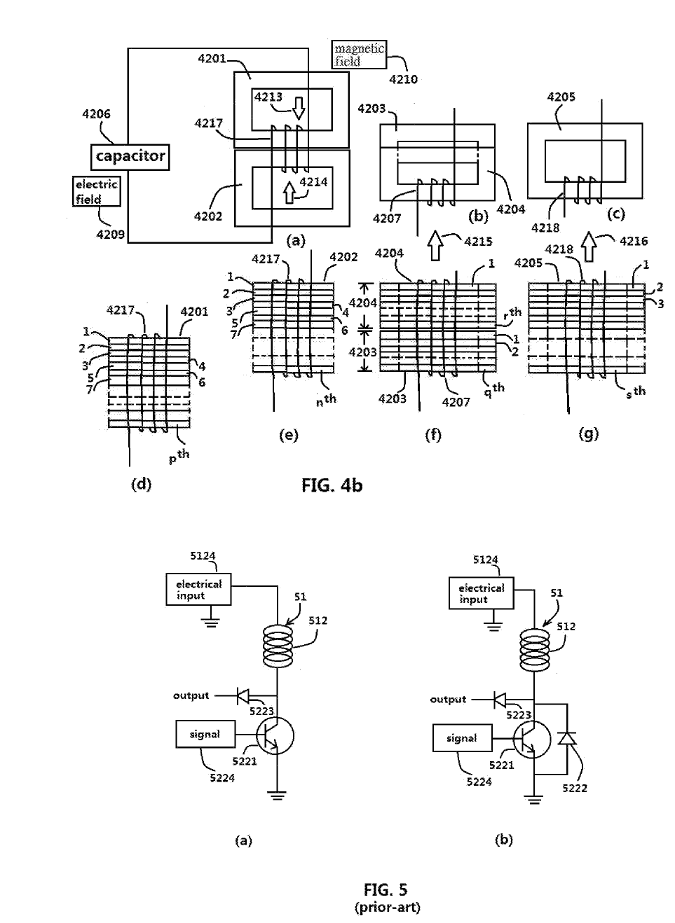

A conductive coil can wind around a plurality of magnetic conductor layers to form a multilayer inductor which form one closed-loop multilayer magnetic core as shown in FIG. 4b(c) or form a plurality of different closed-loop multilayer magnetic cores as shown in FIG. 4b(a) and FIG. 4b(b).

FIG. 4b(c) has shown a multilayer inductor is formed by a conductive coil 4218 winding around a plurality of magnetic conductor layers which form a closed-loop multilayer magnetic core 4205 and FIG. 4b(g) is a side view of FIG. 4b(c) showing a plurality of magnetic conductor layers of the closed-loop multilayer magnetic core 4205.

FIG. 4b(b) has shown a multilayer inductor is formed by a conductive coil 4207 winding around a plurality of magnetic conductor layers shared by a first closed-loop multilayer magnetic core 4203 and a second closed-loop multilayer magnetic core 4204 topping on the first closed-loop multilayer magnetic core 4203. FIG. 4b(f) is a side view of FIG. 4b(b) showing each of the first closed-loop multilayer magnetic core 4203 and the second closed-loop multilayer magnetic core 4204 has a plurality of magnetic conductor layers.

FIG. 4b(a) has shown a multilayer inductor is formed by a conductive coil 4217 winding around a plurality of magnetic conductor layers which are shared by a first closed-loop multilayer magnetic core 4201 and a second closed-loop multilayer magnetic core 4202 siding by the first closed-loop multilayer magnetic core 4213. FIG. 4b(d) and FIG. 4b(e) are respectively a side view of the first closed-loop multilayer magnetic core 4201 and the second closed-loop multilayer magnetic core 4202 respectively showing a plurality of magnetic conductor layers.

If at least one of a plurality of magnetic conductor layers of the multilayer inductor is saturated and at least one of the plurality of magnetic conductor layers of the multilayer inductor is not saturated by a current flowing through a conductive coil around the multilayer inductor, a static magnet nearby magnetically coupling the multilayer inductor and/or an induced magnetic field nearby magnetically coupling the multilayer inductor, then the multilayer inductor is called “partially saturable multilayer inductor” by the current flowing through the conductive coil, the static magnet nearby the multilayer inductor and/or the induced magnetic field nearby magnetically coupling the multilayer inductor.

If all the magnetic conductor layers of the multilayer inductor are saturated by a current flowing through a conductive coil winding around the multilayer inductor, a static magnet nearby magnetically coupling the multilayer inductor and/or an induced magnetic field nearby magnetically coupling the multilayer inductor, then the multilayer inductor is called “fully saturable multilayer inductor” by the current flowing through the conductive coil, the static magnet nearby magnetically coupling the multilayer inductor and/or the induced magnetic field nearby magnetically coupling the multilayer inductor.

An open circuit device comprises a first terminal and a second terminal separating the first terminal by an open gap having an open gap width d and an electrical discharge between the first terminal and the second terminal can take place if a voltage is applied across the first terminal and the second terminal and at least one of the first terminal and the second terminal is a discharge electrode of the electrical discharge. For convenience, the voltage applied across the first terminal and the second terminal of the open circuit device is called “electrical discharge voltage”, “threshold voltage” or simply “threshold” in the present invention. In other words, an open circuit device has a threshold voltage for the occurrence of an electrical discharge. The electrical discharge of the open circuit device is not limited to a particular electrical discharge, for example, it can be an electrical corona discharge or electrical glowing discharge.

An occurrence of an electrical discharge between the first terminal and the second terminal of the open circuit device relates to a voltage across the first terminal and the second terminal, the frequency of the voltage applied across the first terminal and the second terminal, the open gap width d of the open gap between the first terminal and the second terminal, a medium disposed between the first terminal and the second terminal, an ionization condition between the first terminal and the second terminal, an electrical field condition between the first terminal and the second terminal, temperature condition between the first terminal and the second terminal, the geometric shapes of the first terminal and the second terminal, and/or the materials made of the first terminal and the second terminal, etc. For example, a medium disposed in the open gap can be a gas such as air or inert gas for isolating the first terminal and the second terminal from outside environment against oxidizing. A illuminating medium can be disposed in the open gap 603 to illuminate when electrical discharge occurs as an indication of the occurrence of electrical discharge.

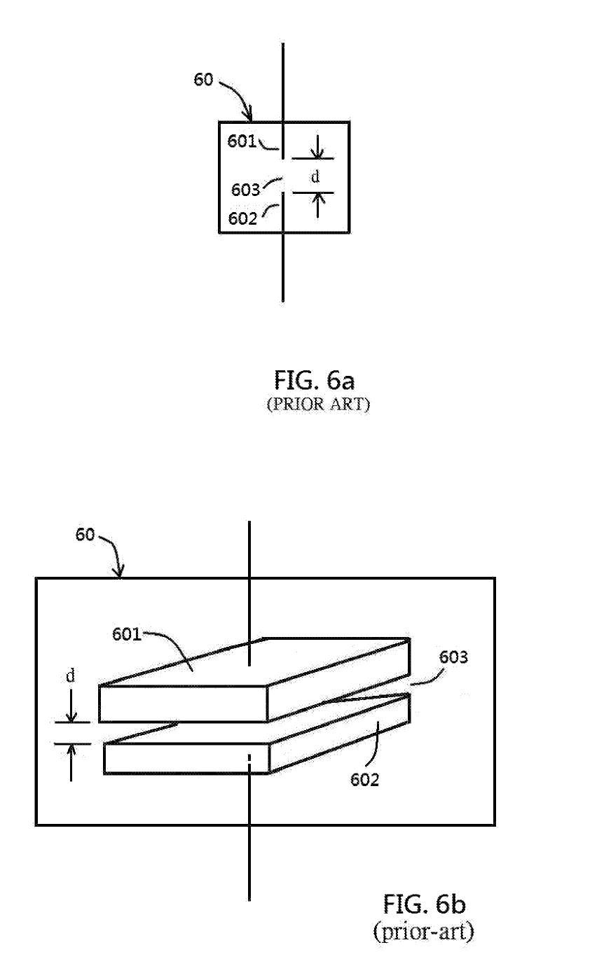

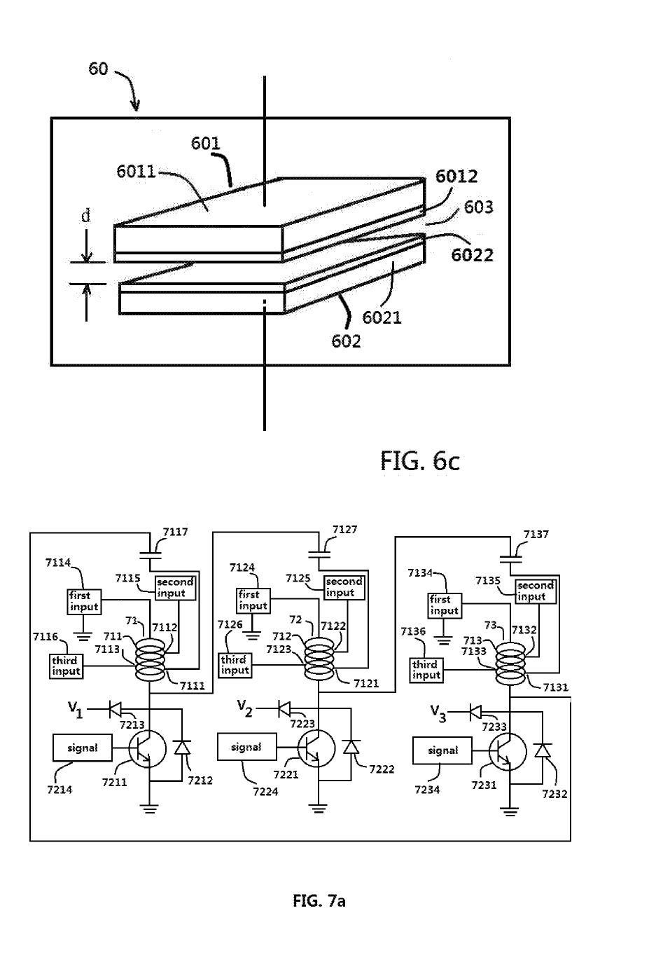

The shapes of the first terminal and the second terminal are not limited, for example, the first terminal and the second terminal can be respectively shaped as needle point as shown in FIG. 6a advantaging for an easier and more controllable occurrence of the an electrical discharge or shaped having an area as shown in FIG. 6b viewed to have a plurality of needle points featuring multiple electrical discharges between the first terminal and the second terminal. Multiple electrical discharges between the first terminal and the second terminal feature bigger current capability flowing through the first terminal and the second terminal at electrical discharges. FIG. 6a and FIG. 6b have respectively shown a first terminal 601, a second terminal 602 and an open gap 603 having an open gap width d.

An open circuit device with its first terminal and second terminal respectively having an area as shown in FIG. 6b is called a first type open circuit device in the present invention. Nanoscaled material can be viewed to be formed or treated by numerous nanoscaled particles which can be reasonably viewed as “micro needle array”. Needle points can be in micro or nano scale if the first terminal 601 and the second terminal 602 of an open circuit device 60 of FIG. 6a or FIG. 6b are made of nanoscaled materials. Examples of conductive nanoscaled material (or called a conductive nanoscaled device) are CNT, graphene, diamond-like carbon, or C₆₀ family, etc,.

Smaller scaled needle points feature more precise control to an occurrence of an electrical discharge, higher density of discharge points, more numbers of occurrences of electrical discharges, bigger current capability flowing between the first terminal 601 and the second terminal 602, and more complicated and variable electrical discharge routes.

A first embodiment, the first terminal 601 and the second terminal 602 of the first open circuit device of FIG. 2b respectively can be made of a conductive nanoscaled material having micro needle array. For the purpose of convenience, the open circuit device is called a second type open circuit device in the present invention.

A second embodiment, an open circuit device is shown in FIG. 6c, FIG. 6c has shown a first terminal 601 of the open circuit device 60 comprising a first conductor 6011 and a first conductive nanoscaled device 6012 fixed to the first conductor 6011, a second terminal 602 of the open circuit device 60 comprising a second conductor 6021 and a second conductive nanoscaled device 6022 fixing to the second conductor 6021, and an open gap 603 is formed between the first conductive nanoscaled device 6012 and the second conductive nanoscaled device 6022. Electrical discharges take place between the first conductive nanoscaled device 6012 and the second conductive nanoscaled device 6022. For the purpose of convenience, the open circuit device is called a third type open circuit device in the present invention.

Any one of the first conductor 6011 and the second conductor 6021 of the third open circuit device can be a conductive PDR device and the other one of the first conductor 6011 and the second conductor 6021 of the third open circuit device can be a conductive NDR device. For the purpose of convenience, the open circuit device is called a fourth type open circuit device in the present invention.

The first conductive nanoscaled device 6012 and the second conductive nanoscaled device 6022 having micro needle array a lot increases surfaces for more charges to stay, in other words, the third type open circuit device and the fourth type open circuit device respectively advantage to raise its capacitance.

The third type open circuit device and the fourth type open circuit device have respectively featured that both ac and dc can pass them. Ac can pass them and dc exceeding its respectively threshold voltage can pass them.

The fourth type open circuit device having the PDR device and the NDR device has featured better sensitivity and is also a damper which can dissipate electrical power flowing through them.

The behavior of the electrical discharge of an open circuit device is very complicated, which can be seen in its I-V curve. Explaining the complicated behavior in a simple way, the complicated behavior of the electrical discharge of an open circuit device can be categoried into a PDR (Positively Differential Resistance), a NDR (Negatively Differential Resistance) and a pure resistance. By using FIG. 6a as an example, when a voltage built between the first terminal 601 and the second terminal 602 of the open circuit device 60 reaches its “threshold voltage”, an electrical discharge takes place causing current to flow through the first terminal 601 and the second terminal 602 to present a NDR, then the voltage across the first terminal 601 and the second terminal 602 will drop to a level as the result of the electrical discharge unable to keep the electrical discharge, then current stops flowing between the first terminal 601 and the second terminal 602 and a voltage across the first terminal 601 and the second terminal 602 will be built again to present a PDR until reaching to a next threshold voltage for a next electrical discharge. The PDR and the NDR will alternatively proceed with its current between zero and a non-zero value and its impedance chaotically randomly varying between zero and infinity. An alternative PDR and NDR can also be referred to “tunneling” known by the people skilled in the art.

The PDR device and the NDR device are not limited. The PDR device can be easily found anywhere, for example, an embodiment, the PDR device can be a Positive Temperature Coefficient (or PTC in short). The NDR device can be a metal oxided material such as ZnO or a Negative Temperature Coefficient (or NTC in short) as revealed in the background information above

The term “open circuit device” used in the present invention can be the first type open circuit device, the second type open circuit device, the third type open circuit device, or the fourth type open circuit device.

A conductive coil of an inductor can have at least a conductive terminal between its two end conductive terminals forming multiple conductive terminals capable of defining multiple two-terminal pairs besides its two end conductive terminals of the conductive coil of the inductor and capable of receiving multiple electrical inputs featuring an electrical modulation of multiple electrical power inputs.

The orientation of current flowing through any two conductive terminals of the conductive coil has to be in phase meaning current flowing through any two conductive terminals of the conductive coil has to be same with that of current flowing through its two end conductive terminals of the conductive coil. For example, as shown in an embodiment of FIG. 4a, two conductive end terminals (or two end terminals in short) 47121 and 47126 and a plurality of conductive terminals 47122, 47123, 47124 and 46125 between the two conductive end terminals 47121 and 47126 of a conductive coil 4712 of an inductor can form multiple two-terminal pairs of the conductive coil 4712 such as 47121 and 47122, 47121 and 47123, 47121 and 47124, 47121 and 47125, 47121 and 47126, 47122 and 47123, 47122 and 47124, 47122 and 47125, and 47122 and 47126, 37123 and 47124, 47123 and 47125, 47123 and 47126, 47124 and 47125, 47124 and 47126, and 47125 and 47126. Each two-terminal pair can define a specific number of coil turns on the conductive coil. For convenience, the conductive coil is called “multiple-terminal conductive coil” in the present invention.

The multiple conductive terminals allow to receive a plurality of electrical power inputs featuring and advantaging for an electrical modulation of the plurality of electrical power inputs. The orientation of current flowing through any two-terminals pair of the conductive coil 4712 has to be same with that of current flowing through the two end terminals 47121 and 47126 of the conductive coil 4712. Five inventive “multi-phase multilayer magnetic core assemblies” are revealed.

FIG. 2b has shown n closed-loop multilayer magnetic cores with each in any shape, for n≧2, surrounded by a largest closed-loop multilayer magnetic core 211 in any shape, in other words, the n closed-loop multilayer magnetic cores are disposed inside the largest closed-loop multilayer magnetic core 211.

A conductive coil winding around the largest closed-loop multilayer magnetic core 211 and a closed-loop multilayer magnetic core inside the largest closed-loop multilayer magnetic core 211 forms an inductor. At least a conductive coil winds around the largest closed-loop multilayer magnetic core 211 and a closed-loop multilayer magnetic core inside the largest closed-loop multilayer magnetic core 211 to form a phase so that there are n phases formed in the embodiment of FIG. 2b for n≧2. Seen in FIG. 2b, FIG. 2b has shown a first conductive coil 212 winding around the largest closed-loop multilayer magnetic core 211 and a first closed-loop multilayer magnetic core 1 inside the largest closed-loop multilayer magnetic core 211, a second conductive coil 213 winding around the largest closed-loop multilayer magnetic core 211 and a second closed-loop multilayer magnetic core 2 inside the largest closed-loop multilayer magnetic core 211, and so on to a n^{th} conductive coil 215 winding around the largest closed-loop multilayer magnetic core 211 and a n^{th} closed-loop multilayer magnetic core n inside the largest closed-loop multilayer magnetic core 211 so that n phases are formed. For convenience, the multilayer magnetic core assembly shown in FIG. 2b is called “a first type n-phase multilayer magnetic core assembly” in the present invention.

Any two closed-loop multilayer magnetic cores of “the first type n-phase multilayer magnetic core assembly” can be same or different in shape, size, thickness, the number of layers, material made of each layer, or/and thickness of each layer.

Based on “the first type n-phase multilayer magnetic core assembly”, at least a conductive coil can wind around two neighboring closed-loop multilayer magnetic cores in the biggest closed-loop multilayer magnetic core 211 of “the first type n-phase multilayer magnetic core assembly” and the two closed-loop multilayer magnetic cores and the biggest closed-loop multilayer magnetic core 211 form a phase so that p phases of “a second type p-phase multilayer magnetic core assembly” can be formed for p≧1.

For example, FIG. 2c(a) has shown “a first type m-phase multilayer magnetic core assembly” having m closed-loop multilayer magnetic cores inside a largest closed-loop multilayer magnetic core 211 and based on FIG. 2c(a), a phase of “a second type n-phase multilayer magnetic core assembly” is formed by at least a conductive coil winding around two closed-loop multilayer magnetic cores inside the largest closed-loop multilayer magnetic core 211 so that “a second type n-phase multilayer magnetic core assembly” having n phases for n≧1 can be obtained as shown in FIG. 2c(b). FIG. 2c(b) has shown a second type n-phase multilayer magnetic core assembly having n phases for n≧1.

Square and round closed-loop multilayer magnetic cores are popular and easier to manufacture. Two embodiments of “the first type n-phase multilayer magnetic core assembly” of FIG. 2b respectively by using square and round closed-loop multilayer magnetic cores are respectively shown in FIG. 2d(a) and FIG. 2e and two embodiments of “the second type n-phase multilayer magnetic core assembly” of FIG. 2c(b) respectively by using square and round closed-loop multilayer magnetic cores are respectively shown in FIG. 2d(b) and FIG. 2f.

The embodiment of the first type n-phase multilayer magnetic core assembly of FIG. 2e has shown eight phases respectively as a first phase formed by a biggest round closed-loop multilayer magnetic core 250 and a first round closed-loop multilayer magnetic core 1 inside the biggest round closed-loop multilayer magnetic core 250 wound by a first conductive coil 251, a second phase formed by the biggest round closed-loop multilayer magnetic core 250 and a second round closed-loop multilayer magnetic core 2 inside the biggest round closed-loop multilayer magnetic core 250 wound by a second conductive coil 252, a third phase formed by the biggest round closed-loop multilayer magnetic core 250 and a third round closed-loop multilayer magnetic core 3 inside the biggest round closed-loop multilayer magnetic core 250 wound by a third conductive coil 253, a fourth phase formed by the biggest round closed-loop multilayer magnetic core 250 and a fourth round closed-loop multilayer magnetic core 4 inside the biggest round closed-loop multilayer magnetic core 250 wound by a fourth conductive coil 254, a fifth phase formed by the biggest round closed-loop multilayer magnetic core 250 and a fifth round multilayer magnetic core 5 inside the biggest round multilayer magnetic core 250 wound by a fifth conductive coil 255, a sixth phase formed by the biggest round closed-loop multilayer magnetic core 250 and a sixth round closed-loop multilayer magnetic core 6 inside the biggest round multilayer magnetic core 250 wound by a sixth conductive coil 256, a seventh phase formed by the biggest round multilayer magnetic core 250 and a seventh round closed-loop multilayer magnetic core 7 inside the biggest round closed-loop multilayer magnetic core 250 wound by a seventh conductive coil 257, and an eighth phase formed by the biggest round closed-loop multilayer magnetic core 250 and an eighth round closed-loop multilayer magnetic core 8 inside the biggest round closed-loop multilayer magnetic core 250 wound by an eighth conductive coil 258.

Based on the embodiment of the first type n-phase multilayer magnetic core assembly of FIG. 2e, a second type 4-phase multilayer magnetic core assembly can be obtained as shown in FIG. 2f by a ninth conductive coil 261 winding around the first round closed-loop multilayer magnetic core 1 and the second round closed-loop multilayer magnetic core 2, a tenth conductive coil 262 winding around the third round closed-loop multilayer magnetic core 3 and the fourth round closed-loop multilayer magnetic core 4, an eleventh conductive coil 263 winding around the fifth round closed-loop multilayer magnetic core 5 and the sixth round closed-loop multilayer magnetic core 6, and a twelfth conductive coil 264 winding around the seventh round closed-loop multilayer magnetic core 7 and the eighth round closed-loop multilayer magnetic core 8. The embodiment of the second type 4-phase multilayer magnetic core assembly of FIG. 2f has four phases respectively as a first phase formed by the first round closed-loop multilayer magnetic core 1, the second round closed-loop multilayer magnetic core 2 and the biggest round closed-loop multilayer magnetic core 250, a second phase formed by the third round closed-loop multilayer magnetic core 3, the fourth round closed-loop multilayer magnetic core 4 and the biggest round closed-loop multilayer magnetic core 250, a third phase formed by the fifth round closed-loop multilayer magnetic core 5, the sixth round closed-loop multilayer magnetic core 6 and the biggest round closed-loop multilayer magnetic core 250, and a fourth phase formed by the seventh round closed-loop multilayer magnetic core 7, the eighth round closed-loop multilayer magnetic core 8 and the biggest round closed-loop multilayer magnetic core 250.

A round closed-loop multilayer magnetic core can be disposed at the center inside the biggest closed-loop multilayer magnetic core of the first and the second type round closed-loop n-phase multilayer magnetic core assemblies to keep all the closed-loop multilayer magnetic cores inside the biggest closed-loop multilayer magnetic core firmly held in position and provide more coil-wound area for collecting more electrical power converted from the magnetic coupling. For convenience, the round closed-loop multilayer magnetic core disposed at the center inside the biggest closed-loop multilayer magnetic core is also called “the centered round closed-loop multilayer magnetic core” in the present invention.

By using the embodiments of FIG. 2e and FIG. 2f, the centered round closed-loop multilayer magnetic core can be disposed at the center inside the biggest closed-loop multilayer magnetic core 250 to keep all the closed-loop multilayer magnetic cores inside the biggest closed-loop multilayer magnetic core 250 firmly held in position and the centered round closed-loop multilayer magnetic core and each closed-loop multilayer magnetic core inside the biggest closed-loop multilayer magnetic core can be coiled respectively shown by a plurality of conductive coils 271, 272, 273, 274, 275, 276, 277 and 278 in FIG. 2g and FIG. 2h. The embodiment of the multilayer magnetic core assembly of FIG. 2g is called “a third type n-phase multilayer magnetic core assembly” in the present invention and the embodiment of multilayer magnetic core assembly of FIG. 2h is called “a fourth type n-phase multilayer magnetic core assembly” in the present invention.

FIG. 2i has shown “a round closed-loop multiple phase multilayer magnetic core assembly”.

A plurality of conductive coils wind around the round closed-loop n-phase multilayer magnetic core assembly. Assuming n conductive coils are input coils and m conductive coils are output coils where n=m or n≠m. An embodiment of “the round closed-loop n-phase multilayer magnetic core assembly”, an input coil and an output coil form a phase. For example, FIG. 2i has shown n input coils 271-274 and m output coils 275-278 where n=m or n≠m. For convenience, the closed-loop round multilayer magnetic core assembly of FIG. 2i is called “a fifth type n-phase multilayer magnetic core assembly” in the present invention.

A conductive coil can directly wind around a magnetic core, a bobbin can be broken down into two pieces and then wrap the two-piece bobbins around a magnetic core and then a conductive coil winds around the two-piece bobbin, or a magnetic core can be broken down into two pieces and then put a coil-wound bobbin through any one piece magnetic core and then tightly couples the two-piece magnetic cores. An inventive method to put on coil-wound bobbins on the second type square closed-loop n-phase multilayer magnetic core assembly shown in FIG. 2d(b) is revealed in FIG. 2j.

FIG. 2j have shown each square closed-loop multilayer magnetic core is broken down into two pieces. The breaking points of the biggest closed-loop multilayer magnetic core 211 should be respectively on its two longer sides and the breaking points of each closed-loop multilayer magnetic core inside the biggest closed-loop multilayer magnetic core should be respectively on its two sides in parallel to the side having the breaking point of the biggest closed-loop multilayer magnetic core as shown in FIG. 2j. For example, as shown in FIG. 2j, breaking points 2111 and 2112 are broken at two longer sides of the biggest closed-loop multilayer magnetic core 211 and breaking points 1911 and 1912 of the closed-loop multilayer magnetic core 3 inside the biggest closed-loop multilayer magnetic core 211 are broken at two sides in parallel to the sides having the breaking points of the biggest closed-loop multilayer magnetic core 211. A plurality of squares 4718, 4728, 4758 and 4716 respectively stand for coil-wound bobbins. The two broken-down pieces of each closed-loop multilayer magnetic core should be tightly coupled after the coil-wound bobbin is put on.

A LC-oscillator is known to be formed by an inductor and a capacitor electrically connected.

An inventive oscillator or an electrical power generator is revealed by using the inventive multilayer capacitor and the inventive multilayer inductor. The multilayer capacitor can be the inventive first type multilayer capacitor including its all the embodiments, second type multilayer capacitor based on the first type multilayer capacitor including its all the embodiments, third type fully saturable multilayer capacitor based on the first type fully saturable multilayer capacitor or fourth type fully saturable multilayer capacitor based on the second type fully saturable multilayer capacitor discussed above. The multilayer inductor can be the “partially saturable multilayer inductor” or the “fully saturable multilayer inductor”.

An inventive oscillator or an electrical power generator comprising the inventive multilayer capacitor and an inductor including “the inventive first n-phase multilayer magnetic core assembly” and “the inventive second n-phase multilayer magnetic core assembly” discussed above forming a close-loop with the inventive multilayer capacitor.

The multilayer capacitor of the inventive oscillator or electrical power generator can be the inventive first type multilayer capacitor including its all the embodiments, second type multilayer capacitor based on the first type multilayer capacitor including its all the embodiments, third type fully saturable multilayer capacitor based on the first type fully saturable multilayer capacitor or fourth type fully saturable multilayer capacitor based on the second type fully saturable multilayer capacitor discussed above.

The inductance of a saturable magnetic conductor layer of a multilayer magnetic core will disappear at the time when the saturable magnetic conductor layer is saturated causing the inductance of the multilayer magnetic core to drop, then current flowing through the conductive coil winding around the multilayer magnetic core will become bigger by the inductance drop. When more magnetic conductor layers of the multilayer magnetic core are saturated, the inductance of the multilayer magnetic core drops further leading to further bigger current flowing through the conductive coil. If a plurality of saturable magnetic conductor layers of the multilayer magnetic core have different saturation levels from each other, current will become bigger and bigger through a plurality of saturations. More information about the fully saturable inductor, partially saturable inductor and saturable inductor can be referred to our previous patent with application Ser. No. 13/193,620.

For example, when a current flowing through the conductive coil saturates at least a magnetic conductor layer of the inductor, current becomes larger to more quickly charge the multilayer capacitor and starts to saturate at least a dielectric layer of the multilayer capacitor to drop the capacitance of the capacitor transiently raising the voltage across the multilayer capacitor resulting in landsliding multiple saturations in the multilayer capacitor and then the voltage across the capacitor will drop to restore to a capacitance of the multilayer capacitor when the voltage is converted into a bigger current flowing through the oscillator loop to easier saturate more magnetic conductor layers of the inductor to produce further bigger current. The process can be described as a positive feedback and the process can continue to form a continuing oscillation. As revealed earlier, the capacitance drop and the inductance drop also will amplify electrical power so that the inventive oscillator is also an inventive electrical power generator.

A first embodiment of the oscillator or the electrical power generator, the multilayer inductor of the oscillator or the electrical power generator can be a partially saturable inductor and the multilayer capacitor of the oscillator or the electrical power generator can be a fully saturable multilayer capacitor. The fully saturable multilayer capacitor can be the first type fully saturable multilayer capacitor including its all embodiments, the second type fully saturable multilayer capacitor based on the first type fully saturable multilayer capacitor including its all embodiments, the third type fully saturable multilayer capacitor based on first type fully saturable multilayer capacitor including its all embodiments, or the fourth type fully saturable multilayer capacitor based on the second type fully saturable multilayer capacitor discussed above in the present invention.

A second embodiment of the oscillator or the electrical power generator, the multilayer inductor of the oscillator or the electrical power generator can be a partially saturable inductor and the multilayer capacitor of the oscillator or the electrical power generator can be a partially saturable multilayer capacitor. The partially saturable multilayer capacitor can be the first type partially saturable multilayer capacitor including its all embodiments or the second type partially saturable multilayer capacitor based on first type fully saturable multilayer capacitor including its all embodiments.

A third embodiment of the oscillator or the electrical power generator, the multilayer inductor of the oscillator or the electrical power generator can be a fully saturable inductor and the multilayer capacitor of the oscillator or the electrical power generator can be a partially saturable multilayer capacitor. The partially saturable multilayer capacitor can be the first type partially saturable multilayer capacitor including its all embodiments or the second type partially saturable multilayer capacitor based on first type fully saturable multilayer capacitor including its all embodiments.

A fourth embodiment of the oscillator or the electrical power generator, the multilayer inductor of the oscillator or the electrical power generator can be a fully saturable inductor and the multilayer capacitor of the oscillator or the electrical power generator can be a fully saturable multilayer capacitor. The fully saturable multilayer capacitor can be the first type fully saturable multilayer capacitor including its all embodiments, the second type fully saturable multilayer capacitor based on the first type fully saturable multilayer capacitor including its all embodiments, the third type fully saturable multilayer capacitor based on first type fully saturable multilayer capacitor including its all embodiments, or the fourth type fully saturable multilayer capacitor based on the second type fully saturable multilayer capacitor discussed above in the present invention. If both the multilayer capacitor and the multilayer inductor of the oscillator or the electrical power generator are in a saturation condition, then the oscillation may possibly stop.

If the multilayer capacitor is a partially saturable multilayer capacitor, then the multilayer capacitor can only allow to pass ac, but if the multilayer capacitor is a fully saturable capacitor, then the capacitor features to allow to pass ac and dc when the multilayer capacitor is saturated to electrically connect the first conductive electrode with the second conductive electrode of the multilayer capacitor. If the inductor and capacitor of the inventive oscillator or the inventive electrical power generator are in a RF band, then the inventive oscillator or the inventive electrical power generator is an inventive RF antenna or a RFID.

The RF electrical power generator may need an electrical field and/or a magnetic field excitations to help the saturations of the inductor and the capacitor to improve the performance of the RF electrical power generator. For example, if the inventive oscillator or the inventive electrical power generator has a PDR device and a NDR device as the second type multilayer capacitor or the fourth type fully saturable multilayer capacitor, then the inventive oscillator or the inventive electrical power generator has a PDR (positive differential resistance), a NDR (negative differential resistance), a PDC (positive differential capacitance), a NDC (negative differential capacitance), a PDI (positive differential inductance), a NDI (negative differential inductance) so the inventive oscillator or the inventive electrical power generator can be viewed as a positive and negative differential impedance network or simply expressed by PNDIN, which can be used to be analog to any circuit or used as a matching network.

A power boost circuit having multiple voltage boost circuits is revealed in the present invention. A prior-art voltage boost circuit shown in FIG. 5(a) is known to be formed by an inductor 51 having a conductive coil 512 and a transistor 5221 switched by a signal 5224 electrically connected in series and a high side diode 5223 in parallel to the inductor for outputting. Sometimes in prior-art applications, the high side diode 5223 may be an anti-diode of another transistor having a so-called synchronizing rectification. The signal 5224 for switching the transistor 5221 is not limited to a particular signal, for example, the signal can be from a PWM controller, a self-excitation signal, or a signal produced in a circuit working with the voltage boost circuit. The prior-art voltage boost circuit is notoriously known to boost voltage with dropping current, in other words, the prior-art voltage boost circuit can not boost electrical power.

Based on the prior-art voltage boost circuit of FIG. 5(a), a low side anti-diode 5222 in parallel to the transistor 5221 is added to the voltage boost circuit of FIG. 5(a) is shown in FIG. 5(b) and the high side diode 5223 can be an anti-diode of another transistor as revealed earlier.

An inventive power boost circuit comprises n voltage boost circuits of FIG. 5(b) for n≧2 and the conductive coil of each inductor of the power boost circuit can be a multiple-terminal conductive coil capable of defining multiple two-terminal pairs for receiving multiple electrical inputs and different kinds of electrical inputs such as dc or/and ac inputs. The ac input may not directly electrically connect to the multiple-terminal conductive coil instead the ac input inputs into the multiple-terminal conductive coil through a coupling capacitor.

The multiple-terminal conductive coil can define multiple two-terminal pairs with each two-terminal pair defining a specific number of coil turns for a specific electrical input.

Each inductor of the power boost circuit can define a two-terminal pair on its multiple-terminal conductive coil and all the two-terminal-pair defined inductors respectively of n voltage boost circuits form a closed n-side polygon with each vertex of the n-side polygon representing a coupling capacitor, and all the inductors of the power boost circuit have at least a common or same magnetic conductor meaning that all the conductive coils respectively of all the inductors of the power boost circuits wind around at least a same or common magnetic conductor and each magnetic flux induced in the common magnetic conductor or conductors by current flowing through the conductive coil of each inductor and/or a nearby magnetic field magnetically coupling the common magnetic conductor or conductors should be in same direction or magnetically in phase to get maximum magnetization on the common magnetic conductor or conductors, in other words, for example, assuming φ₁, φ₂, φ₃, to φₙ are respectively magnetic fluxes induced on the common magnetic conductor or conductors by current flowing through the conductive coil of each inductor and the φ₁, φ₂, φ₃, to φₙ, are in same sign to get maximum magnetization on the common magnetic conductor or conductors because the magnizations in different signs cancel each other out, for example, the total fluxes

φ=φ₁+φ₂+φ₃+ . . . +φₙ

or

φ=φ₁−φ₂−φ₃− . . . −φₙ

to get maximum magnetization on the common magnetic conductor or conductors, for convenience, the φ₁, φ₂, φ₃, to φₙ, or all the inductors are called “magnetically in phase”. The common magnetic conductor or conductors are not limited to any particular magnetic conductor, for example, the common magnetic conductor can be a multilayer magnetic core, a partial saturable multilayer magnetic core, a fully saturable multilayer magnetic core, a closed-loop multilayer magnetic core, a closed-loop partial saturable multilayer magnetic core, or a closed-loop fully saturable multilayer magnetic core by a current flowing through a conductive coil winding around the common magnetic conductor or conductors or a magnetic field magnetically coupling with the common magnetic conductor or conductors, in other words, each inductor can be a prior-art inductor, a partially saturable multilayer inductor, a closed-loop partially saturable multilayer inductor, a fully saturable saturable multilayer inductor, or a closed-loop fully saturable saturable multilayer inductor by a current flowing through the conductive coil of the inductor or a magnetic field nearby magnetically coupling the inductor. For example, each inductor can be formed by a conductive coil winding around the biggest closed-loop multilayer magnetic core and a closed-loop multilayer magnetic core inside the biggest round closed-loop multilayer magnetic core of “the first type n-phase multilayer magnetic core assembly”, “the second type n-phase multilayer magnetic core assembly”, “the third type n-phase multilayer magnetic core assembly”, or “the fourth type n-phase multilayer magnetic core assembly”, or a conductive coil winding around “the fifth type n-phase multilayer magnetic core assembly” as revealed in the present invention.

An oscillator formed by a capacitor including the inventive capacitor with all its embodiments and an inductor with its conductive coil winding around at least the common magnetic conductor or conductors of the power boost circuit may be needed to provide a signal or a waveform modulated with the signal to switch the transistor of each voltage boost circuit of the power boost circuit.

The inventive power boost circuit has featured electrical couplings and the magnetic couplings. The inventive power boost circuit has featured ac flowing through each inductor can induce ac among each other through the couplings of the common magnetic conductor or conductors, ac in each voltage boost circuit can be coupled to another voltage boost circuit through the coupling capacitor to get boosted, and two low side anti-diodes and two high side diodes of two voltage boost circuits function a full bridge rectifier to rectify ac into dc output for each voltage boost circuit.

An electrical input to a voltage boost circuit of the power boost circuit can be a battery. An ac flowing through a conductive coil winding around at least the common magnetic conductor or conductors of the driving power boost circuit is rectified for electrically charging the battery or rectified and low-pass filtered for electrically charging the battery. For example, the conductive coil can wind around the biggest closed-loop multilayer magnetic core and a closed-loop multilayer magnetic core inside the biggest round closed-loop multilayer magnetic core of “the first type n-phase multilayer magnetic core assembly”, “the second type n-phase multilayer magnetic core assembly”, “the third type n-phase multilayer magnetic core assembly”, or “the fourth type n-phase multilayer magnetic core assembly”, or the conductive coil can wind around “the fifth type n-phase multilayer magnetic core assembly” as revealed above in the present invention.

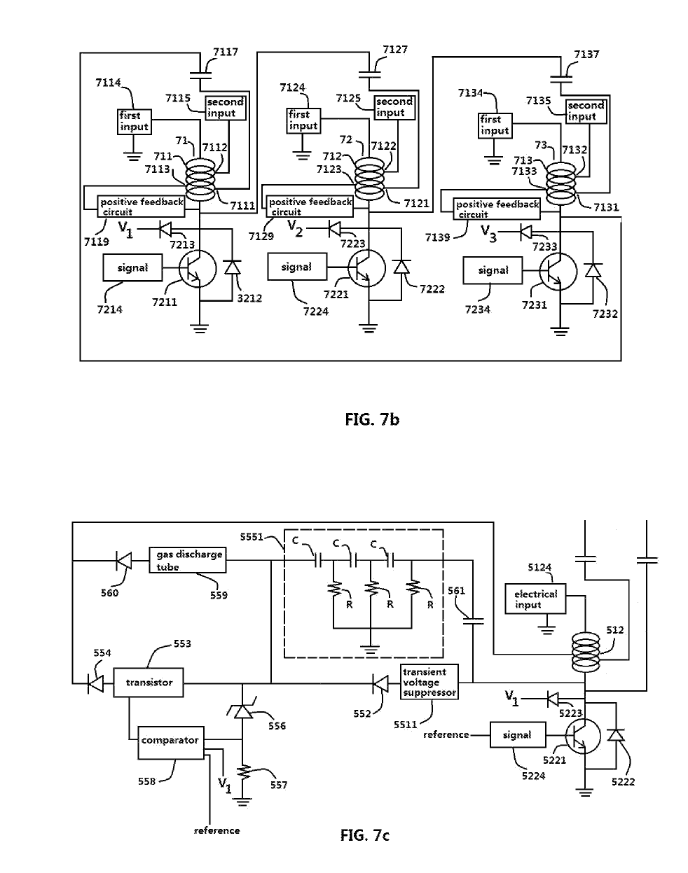

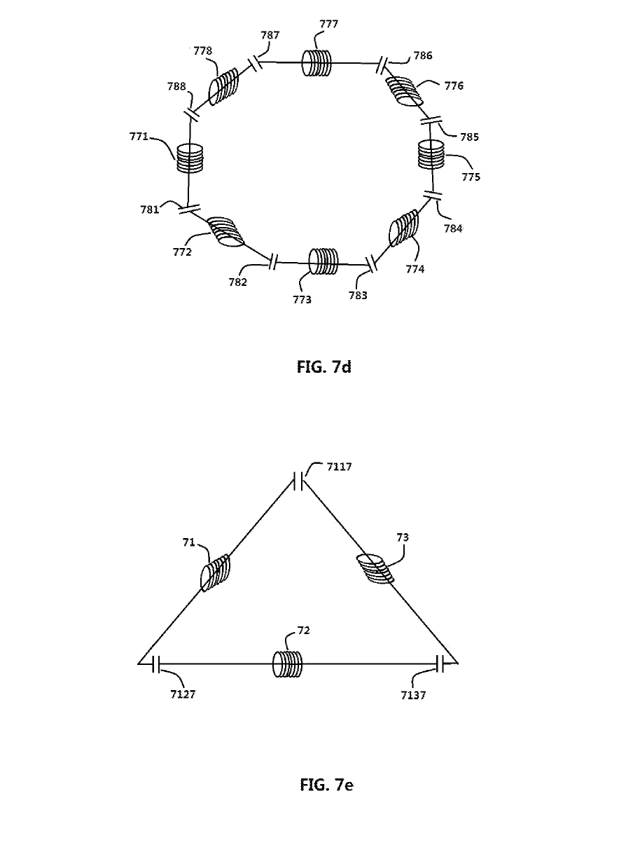

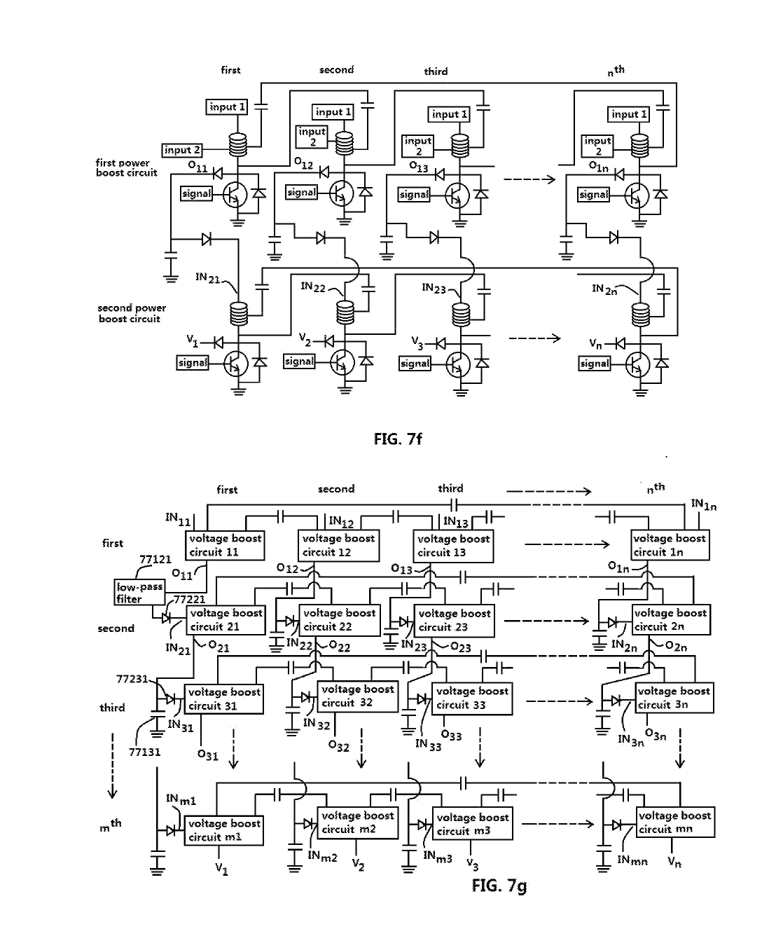

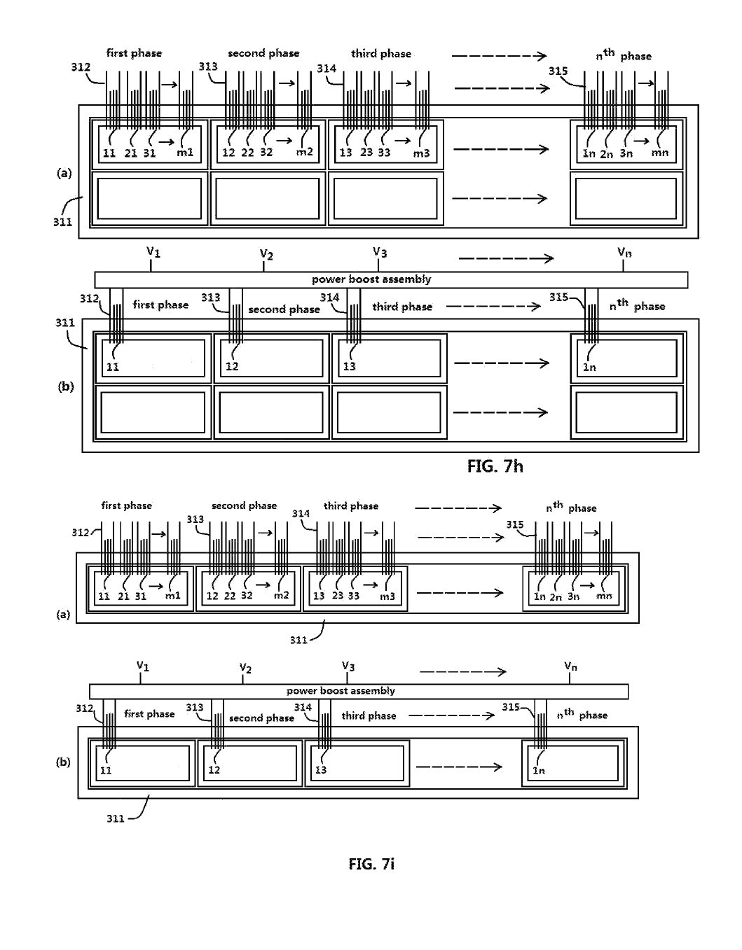

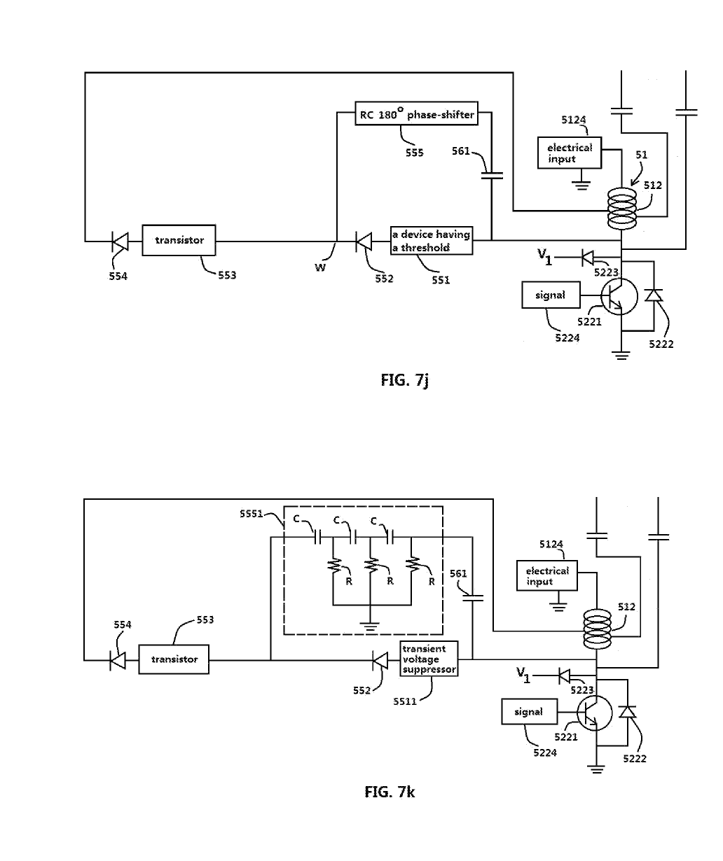

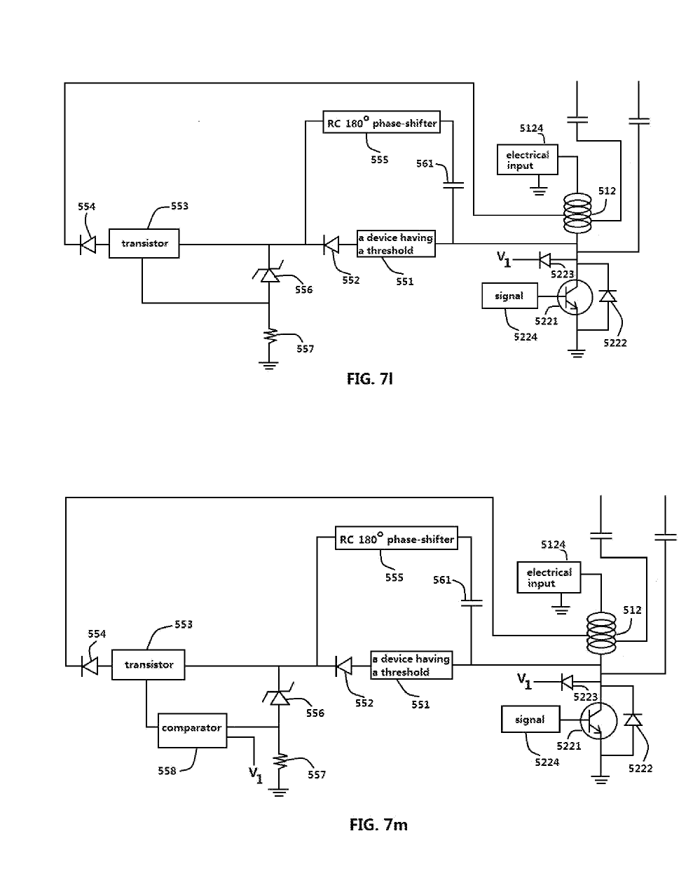

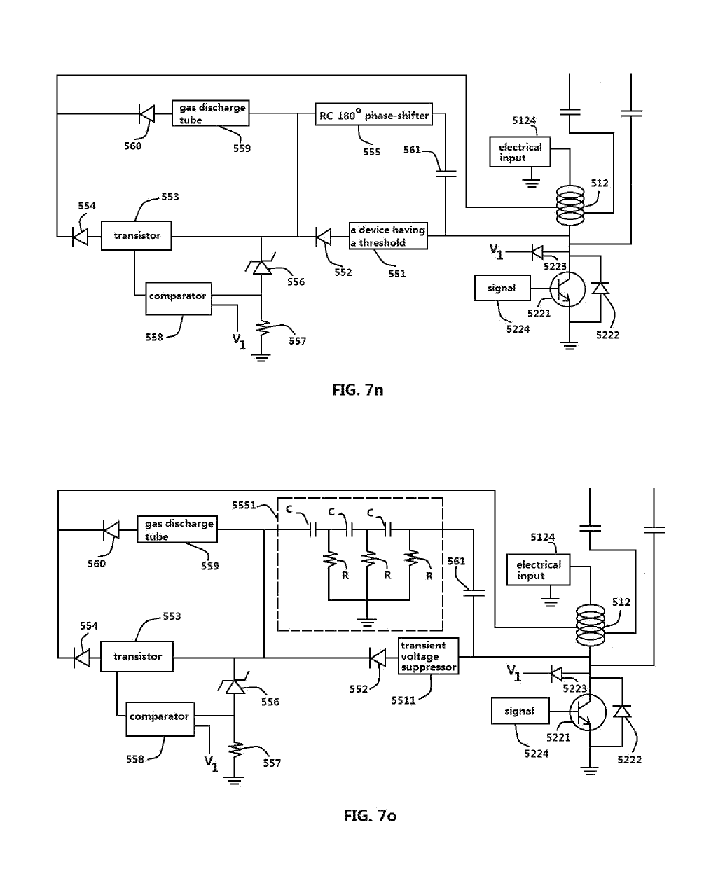

FIG. 7d has shown an example of the couplings of eight inductors in a power boost circuit having eight voltage boost circuits. FIG. 7d has shown a closed 8-side polygon with each side representing a two-terminal pair chosen inductor of a voltage boost circuit of the inventive power boost circuit respectively shown as 771, 772, 773, 774, 775, 776, 777 and 778 and each vertex of the closed eight-side polygon represents a coupling capacitor respectively shown as 781, 782, 783, 784, 785, 786, 787 and 788.

Furthermore, an output of a voltage boost circuit can be positively fedback as an electrical input to the voltage boost circuit to form a positive feedback circuit advantaging for increasing the output of the voltage boost circuit. An embodiment of a positive feedback circuit based on the voltage boost circuit of FIG. 5(b) having a dc output shown as V₁ is shown in FIG. 7j. FIG. 7j has shown the positive feedback circuit comprises a first circuit comprising a device 551 having a threshold, a first diode 552, a transistor 553, and a second diode 554 electrically connected in series with each other and a second circuit comprising a RC 180° phase-shifter 555 and a coupling capacitor 561 for coupling ac into the RC 180° phase-shifter 555 electrically connected in series in parallel to the device 551 and the first diode 552. The output of the second diode 554 is fedback as input to the voltage boost circuit. The positive feedback circuit can be input through a chosen two-terminal pair of the multiple-terminal conductive coil with a desired coil turns.

The device 551 having a threshold can cut off some peaks of the output of the voltage boost circuit and only an expected significant output of the voltage boost circuit exceeding the threshold of the device 551 can go through the device 551 and an ac output of the voltage boost circuit through the coupling capacitor 561 will go through the RC 180° phase-shifter 555 to get 180° phase-shifted so the fedback ac can come back to the inductor 51 of the voltage boost circuit at the time when the transistor 5221 of the voltage boost circuit is on or called in phase to optimally magnetize the inductor 51.

By turning the transistor 553 off or on can electrically open or close the positive feedback circuit. The controllable transistor 553 has some functions as (1) only an expected voltage built after the RC 180° phase-shifter 555 and the first diode 552 is allowed to pass the transistor 553, (2) the dc output V₁ of the voltage boost circuit can be monitored against a limit by turning off the transistor 553 meaning the transistor 553 will be turned off when the dc output V₁ of the voltage boost circuit exceeding the limit and (3) another waveform source can be modulated into the positive feedback circuit through the transistor 553.

The RC 180° phase-shifter 555 is not limited to any particular phase-shifter, for example, the RC 180° phase-shifter 555 can be a well known 180° phase-shift network 5551 formed by three equivalent capacitors C and three equivalent resistors R. The device 551 is not limited to any particular device, for example, the device 551 can be an open circuit device having a threshold meaning current can flow through the two terminals of the open circuit device when an electrical discharge takes place between its two terminals by a voltage across its two terminals exceeding its threshold, a gas discharge tube (GDT) viewed as an open circuit device featuring a visibly electrical discharge, a transient voltage suppressor (TVS) having a threshold meaning a significant current can pass through the TVS when a voltage exceeding its threshold, or a Zener diode having a threshold meaning a significant current can go through the Zener when a voltage exceeding its threshold, etc. The “open circuit device” can be the first type open circuit device, the second type open circuit device, the third type open circuit device, or the fourth type open circuit device as defined above. The device 551 and the RC 180° phase-shifter 555 of FIG. 7j respectively designated by a transient voltage suppressor and the 180° phase-shift network 5551 are shown in an embodiment of FIG. 7k. The embodiment of FIG. 7j can further comprise a level control detector electrically connected to the first diode 552 and the RC 180° phase-shifter 555 and in parallel to the transistor 553 for controlling the transistor 553. The level control detector can be formed by a third diode having a threshold, a resistor and ground electrically connected in series with each other and a voltage across the resistor controls the transistor 553. When a voltage at the first diode 552 and the RC 180° phase-shifter 555 of the positive feedback circuit below the threshold of the third diode the transistor 553 is in off state and when the voltage exceeding the threshold of the third diode to electrically conduct the third diode a voltage built across the resistor will turn on the transistor 553. The design makes sure the transistor 553 will be turned on only when an expected voltage at the first diode 552 and the RC 180° phase-shifter 555 is built. The third diode of the level control detector is not limited to any particular device, for example, the third device can be a Zener diode.

FIG. 7l has shown an embodiment of the level control detector in parallel to the transistor 553 formed by a Zener 556 having an expected threshold, a resistor 557 and ground electrically connected in series with each other and the Zener 556 is electrically connected to the first diode 552 and the RC 180° phase-shifter 555. When a voltage at the first diode 552 and the RC 180° phase-shifter 555 of the positive feedback circuit below the threshold of the Zener 556 the transistor 553 is in off state and when the voltage exceeding the threshold of the Zener 556 to electrically conduct the Zener 556 a voltage built across the resistor 557 will turn on the transistor 553. The design makes sure transistor 553 will be turned on only when an expected significant voltage at the first diode 552 and the RC 180° phase-shifter 555 of the positive feedback circuit is built.

Based on FIG. 7l and shown in FIG. 7m, the dc output V₁ of the voltage boost circuit can be monitored against a limit by further comprising a comparator 558 to compare the V₁ and the limit. If the dc output V₁ of the voltage boost circuit larger than the limit is detected, then the transistor 553 will be turned off.

Based on FIG. 7j and shown in FIG. 7n, the second circuit further comprises a gas discharge tube 559 having an expected threshold and a third diode 560 and the coupling capacitor 561, the RC 180° phase-shifter 555, the gas discharge tube 559 and the third diode 560 are electrically connected in series with each other and the outputs respectively of the second diode 554 and the third diode 560 are electrically connected. The threshold of the gas discharge tube 559 is higher than that of the Zener 556 so an electrical power after the RC 180° phase-shifter 555 and the first diode 552 still goes through the transistor 553. An electrical power after the RC 180° phase-shifter 555 and the first diode 552 will go through the gas discharge tube 559 only when the transistor 553 is broken so the gas discharge tube 559 can be viewed as a backup device for the transistor 553 and also function to provide a visible warning signal that the transistor 553 is bad.

FIG. 7o has shown FIG. 7n with the device 551 and the RC 1800 phase-shifter 555 respectively designated by a transient voltage suppressor 5511 and a well known 180° phase-shift network 5551 formed by three equivalent capacitors C and three equivalent resistors R. Based on FIG. 7o and shown in FIG. 7c, the signal 5224 switching the transistor 5221 of the voltage boost circuit can be a reference to switch the transistor 553 of the positive feedback circuit so that both the transistors 553 and 5221 can be synchronous.

The signal for switching the transistor of each voltage boost circuit of the power boost circuit is not limited to a particular signal, for example, the signal can be from a PWM controller, a self-excitation signal, or a signal or a waveform modulated with a signal provided by an oscillator formed by a capacitor including the inventive capacitor including all its the embodiments and an inductor with its conductive coil winding around at least the same or common magnetic conductor or conductors of the power boost circuit, for example, the inductor can be formed by a conductive coil winding around the biggest closed-loop multilayer magnetic core and a closed-loop multilayer magnetic core inside the biggest round closed-loop multilayer magnetic core of “the first type n-phase multilayer magnetic core assembly”, “the second type n-phase multilayer magnetic core assembly”, “the third type n-phase multilayer magnetic core assembly”, or “the fourth type n-phase multilayer magnetic core assembly”, or a conductive coil winding around “the fifth type n-phase multilayer magnetic core assembly” as revealed in the present invention.

The power boost circuit having the positive feedback circuit can also be used as an electric pedal control of an electric vehicle advantaging for the control of a big power output of a voltage boost circuit by controlling a small transistor of its positive feedback circuit. For convenience, the power boost circuit without the positive feedback circuit is called “a first type power boost circuit” or “a first type electric pedal control circuit” and the power boost circuit having the positive feedback circuit can be called as “a second type power boost circuit” or “a second type electric pedal control circuit” in the present invention.

More detailed about the inventive power boost circuit is shown in FIG. 7a, for simplicity, a power boost circuit having three voltage boost circuits is demonstrated. As shown in FIG. 7a, a first voltage boost circuit is formed by a first inductor 71 having a first conductive coil 711 and a first transistor 7211 switched by a first signal 7214 with a first low side anti-diode 7212 in parallel to the first transistor 7211 electrically connected in series and a first high side diode 7213 in parallel to the first inductor 71 for a first output shown as V₁, a second voltage boost circuit is formed by a second inductor 72 having a second conductive coil 712 and a second transistor 7221 switched by a second signal 7224 with a second low side anti-diode 7222 in parallel to the second transistor 7221 electrically connected in series and a second high side diode 7223 in parallel to the second inductor 72 for a second output shown as V₂, and a third voltage boost circuit is formed by a third inductor 73 having a third conductive coil 713 and a third transistor 7231 switched by a third signal 7234 with a third low side anti-diode 7232 in parallel to the third transistor 7231 electrically connected in series and a third high side diode 7233 in parallel to the third inductor 73 for a third output shown as V_{3.}

The first, second, third conductive coils 711, 712 and 713 respectively of the first, second, and third inductors 71, 72, and 73 can respectively be a multiple-terminal conductive coil capable of defining multiple two-terminal pairs capable for receiving multiple electrical inputs and different kinds of electrical inputs such as dc or/and ac inputs, for example, as shown in FIG. 7a, the first conductive coil 711 has multiple conductive terminals 7111, 7112 and 7113 between its two end terminals capable of defining a plurality of two-terminal pairs capable of receiving a plurality and different kinds of electrical inputs shown as a first input 7114, a second input 7115, and a third input 7116.

Each inductor can define a two-terminal pair on its multiple-terminal conductive coil and all the two-terminal-pair defined inductors respectively of the three voltage boost circuits form a closed 3-side polygon or called a triangle with each vertex of the triangle representing a coupling capacitor respectively as a first coupling capacitor 7117 between the first inductor 71 and the third inductor 73, a second coupling capacitor 7127 between the first inductor 71 and the second inductor 72, and a third coupling capacitor 7137 between the second inductor 72 and the third inductor 73 as shown in FIG. 7e and FIG. 7a.

Two low side anti-diodes and the high side diodes of two voltage boost circuits function a full bridge rectifier to rectify ac into dc output for each voltage boost circuit, for example, the first low side anti-diode 7212, the first high side diode 7213, the second low side anti-diode 7222, and the second high side diode 7223 form a full bridge rectifier.

The three inductors respectively of the three voltage boost circuits of the power boost circuit have at least a same or common magnetic conductor, in other words, the first conductive coil 711, the second conductive coil 712, and the third conductive coil 713 respectively of the three inductors wind around at least a same or common magnetic conductor or conductors for magnetically coupling all together. The common magnetic conductor or conductors are not limited to any particular magnetic conductor, for example, the common magnetic conductor can be a partially saturable multilayer magnetic core, a fully saturable multilayer magnetic core, a closed-loop partially saturable multilayer magnetic core, or a closed-loop fully saturable multilayer magnetic core by current flowing through its wound coil or a nearby magnetic field, in other words, the inductor of each voltage boost circuit can be a fully saturable multilayer inductor or a partially saturable multilayer inductor.

For example, couple of embodiments, the first conductive coil 711 can wind around the biggest closed-loop multilayer magnetic core and a first closed-loop multilayer magnetic core inside the biggest round closed-loop multilayer magnetic core, the second conductive coil 712 can wind around the biggest closed-loop multilayer magnetic core and a second closed-loop multilayer magnetic core inside the biggest round closed-loop multilayer magnetic core, and the first conductive coil 713 can wind around the biggest closed-loop multilayer magnetic core and a third closed-loop multilayer magnetic core inside the biggest round closed-loop multilayer magnetic core of “the first type n-phase multilayer magnetic core assembly”, “the second type n-phase multilayer magnetic core assembly”, “the third type n-phase multilayer magnetic core assembly”, or “the fourth type n-phase multilayer magnetic core assembly”, or a conductive coil winding around “the fifth type n-phase multilayer magnetic core assembly” as revealed above in the present invention.

An electrical input to a voltage boost circuit of the power boost circuit can be a battery. An ac flowing through a conductive coil winding around at least the common magnetic conductor or conductors of the driving power boost circuit is rectified for electrically charging the battery or rectified and low-pass filtered for electrically charging the battery.

For example, an embodiment, assuming an electrical input to each voltage boost circuit of the power boost circuit of FIG. 7a is a battery, for a battery as an electrical input to the first voltage boost circuit, the conductive coil and the first conductive coil wind the same magnetic core or cores as the biggest closed-loop multilayer magnetic core and the first closed-loop multilayer magnetic core inside the biggest round closed-loop multilayer magnetic core of “the first type n-phase multilayer magnetic core assembly”, “the second type n-phase multilayer magnetic core assembly”, “the third type n-phase multilayer magnetic core assembly”, or “the fourth type n-phase multilayer magnetic core assembly”, or the conductive coil can wind around “the fifth type n-phase multilayer magnetic core assembly”, for a battery as an electrical input to the second voltage boost circuit, the conductive coil and the second conductive coil wind the same magnetic core or cores as the biggest closed-loop multilayer magnetic core and the second closed-loop multilayer magnetic core inside the biggest round closed-loop multilayer magnetic core of “the first type n-phase multilayer magnetic core assembly”, “the second type n-phase multilayer magnetic core assembly”, “the third type n-phase multilayer magnetic core assembly”, or “the fourth type n-phase multilayer magnetic core assembly”, or the conductive coil can wind around “the fifth type n-phase multilayer magnetic core assembly”, and for a battery as an electrical input to the third voltage boost circuit, the conductive coil and the third conductive coil wind the same magnetic core or cores as the biggest closed-loop multilayer magnetic core and the third closed-loop multilayer magnetic core inside the biggest round closed-loop multilayer magnetic core of “the first type n-phase multilayer magnetic core assembly”, “the second type n-phase multilayer magnetic core assembly”, “the third type n-phase multilayer magnetic core assembly”, or “the fourth type n-phase multilayer magnetic core assembly”, or the conductive coil can wind around “the fifth type n-phase multilayer magnetic core assembly”.

The signal for switching the transistor of each voltage boost circuit is not limited to a particular signal, for example, the signal can be from a PWM controller, a self-excitation signal, or a waveform modulated with a signal provided by an oscillator formed by a capacitor including the inventive capacitor including all its embodiments and an inductor with its conductive coil winding around at least the common magnetic conductor or conductors of the power boost circuit.

Based on FIG. 7a, FIG. 7b has shown a first positive feedback circuit 7119, a second positive feedback circuit 7129, and a third positive feedback circuit 7139 and each positive feedback circuit can be input through a chosen two-terminal pair of the multiple-terminal conductive coil with a desired coil turns, for example, as shown in FIG. 7b, the first positive feedback circuit is chosen at a point 7113 on the first conductive coil 711.

The power boost circuit having the positive feedback circuit can be used as an electric pedal control of an electric vehicle or equipment. As revealed above, all the inductors of the power boost circuit “magnetically in phase” can get maximum magnetization on the common magnetic conductor or conductors.

A power boost assembly is formed by at least two power boost circuits with each having at least two voltage boost circuits and at least a voltage boost circuit of a power boost circuit is in series with a voltage boost circuit of another power boost circuit and all the inductors respectively of all the voltage boost circuits of the power boost assembly have at least a same magnetic conductor meaning the conductive coil of each inductor winds around at least a same or common magnetic conductor. A voltage boost circuit of a power boost circuit in series with a voltage boost circuit of another power boost circuit means an output of a voltage boost circuit of a power boost circuit can be an input of a voltage boost circuit of another power boost circuit. The common magnetic conductor is not limited to any particular magnetic conductor, for example, the common magnetic conductor can be a multilayer magnetic core, a partial saturable multilayer magnetic core, a fully saturable multilayer magnetic core, a closed-loop multilayer magnetic core, a closed-loop partial saturable multilayer magnetic core, or a closed-loop fully saturable multilayer magnetic core by a current flowing through the wound coil or/and a nearby magnetic field, in other words, each inductor of the power boost assembly can be a prior-art inductor, a partially saturable multilayer inductor, a closed-loop partially saturable multilayer inductor, a fully saturable multilayer inductor, or a closed-loop fully saturable saturable multilayer inductor by a current flowing through the conductive coil of the inductor or/and a magnetic field nearby magnetically coupling the inductor. For example, some embodiments, an inductor of the power boost assembly can be formed by a conductive coil winding around the biggest closed-loop multilayer magnetic core and a closed-loop multilayer magnetic core inside the biggest round closed-loop multilayer magnetic core of “the first type n-phase multilayer magnetic core assembly”, “the second type n-phase multilayer magnetic core assembly”, “the third type n-phase multilayer magnetic core assembly”, or “the fourth type n-phase multilayer magnetic core assembly”, or a conductive coil winding around “the fifth type n-phase multilayer magnetic core assembly” as revealed in the present invention.

An output of a voltage boost circuit of a first power boost circuit of a power boost assembly may be processed by a low-pass filter for filtering out high frequency components and enlarging its amplitude before being inputted into a voltage boost circuit of a second power boost circuit of the power boost assembly and then followed by a diode for prohibiting a current from the second voltage boost circuit from flowing back into the first voltage boost circuit. The diameter of the conductive coil of the inductor of the second voltage boost circuit of the second power boost circuit can be bigger than that of the voltage boost circuit of the first power boost circuit advantaging for allowing bigger current to flow through the second voltage boost circuit. The power boost assembly has advantaged that the power gain of the plurality of voltage boost circuits in series is the multiplication of the power gain of each voltage boost circuit so that through multiple voltage boost circuits in series can obtain considerable final output. The power boost assembly has also featured that the transistor of each voltage boost circuit of the power boost assembly can be active or idle, which advantaging for the flexibility of the control to the power boost assembly. Two power boost circuits of the power boost assembly may have different number of voltage boost circuits.

FIG. 7g has shown an embodiment of the power boost assembly trying to be in a more general form and for simplicity each power boost circuit has a same number of voltage boost circuits. FIG. 7g has shown the power boost assembly formed by m power boost circuits with each having n voltage boost circuits for both m,n≧2 and all the inductors respectively of all the voltage boost circuits of the power boost assembly have at least a same magnetic conductor meaning the conductive coil of each inductor winds around at least a same or common magnetic conductor. For example, a first power boost circuit has voltage boost circuits 11, 12, 13 to 1n, a second power boost circuit has voltage boost circuits 21, 22, 23 to 2n, a third power boost circuit has voltage boost circuits 31, 32, 33 to 3n, and to a m^{th} power boost circuit has voltage boost circuits m1, m2, m3 to mn. Each voltage boost circuit has an input and an output, for example, the voltage boost circuit 11 has an input IN₁₁ and O₁, the voltage boost circuit 21 has an input IN₂₁ and O₂₁, the voltage boost circuit 31 has an input IN₃₁ and O₃₁, the voltage boost circuit m1 has an input INₘ₁ and Oₘ₁, the voltage boost circuit 12 has an input IN₁₂ and O₁₂, and the voltage boost circuit 32 has an input IN₃₂ and O₃₂, etc. A plurality of voltage boost circuits with a voltage boost circuit of each power boost circuit electrically in series with each other by electrically connecting an output of a voltage boost circuit to an input of another voltage boost circuit, for example, the voltage boost circuits 11, 21, 31 to m1 are in series with each other, the voltage boost circuits 12, 22, 32 to m2 are in series with each other, the voltage boost circuits 13, 23, 33 to m3 are in series with each other, and to the voltage boost circuits in, 2n, 3n to mn are in series with each other. For example, for the case of the voltage boost circuits 11, 21, 31 to m1 in series, the input IN₁₁ of the voltage boost circuit 11 of the first power boost circuit receives input, the output O₁₁, of the voltage boost circuit 11 of the first power boost circuit electrically connects to the input IN₂₁ of the voltage boost circuit 21 of the second power boost circuit, the output O₂₁ of the voltage boost circuit 21 of the second power boost circuit electrically connects to the input IN₃₁ of the voltage boost circuit 31 of the third power boost circuit, and so on until to the input INₘ₁ of the voltage boost circuit m1 of the m^{th} power boost circuit and a final output of the voltage boost circuits 11, 21, 31 to m1 in series is shown as V₁. In fact, the outputs of any one power boost circuit of the power boost assembly can be used to drive loading, for example, O₃₁, O₃₂, O₃₃, to O₃ₙ respectively of the voltage boost circuits 31, 32, 33 to 3n of the third power boost circuit of the power boost assembly can be used to drive a loading or loadings. The feature advantages to the flexibility of selecting an expected output level for a specific loading or loadings.

An output of a voltage boost circuit may be needed to be processed by a low-pass filter for filtering out its high frequency components and enlarging its amplitude before entering an input of another voltage boost circuit as shown a low-pass filter 77121 and a diode 77221 for prohibiting current from the input IN₃₁ of the voltage boost circuit 31 from flowing to the output O₂₁ of the up-level voltage boost circuit 21. The low-pass filter 77121 is not limited to any particular filter, for example, the low-pass filter 77121 can be a capacitor 77131 @@@@@@@electrically connected to ground in parallel to the input IN₃₁ of the voltage boost circuit 31 of the third power boost circuit shown in FIG. 7g.

All the inductors of the power boost assembly of FIG. 7g have at least a common or same magnetic conductor, in other words, the conductive coil of each inductor winds around at least a same magnetic conductor. The common magnetic conductor is not limited to any particular magnetic conductor, for example, the common magnetic conductor can be a multilayer magnetic core, a partial saturable multilayer magnetic core, a fully saturable multilayer magnetic core, a closed-loop multilayer magnetic core, a closed-loop partial saturable multilayer magnetic core, or a closed-loop fully saturable multilayer magnetic core by a current flowing through the wound coil or a nearby magnetic field, in other words, each inductor of the power boost assembly of FIG. 7g can be a prior-art inductor, a partially saturable multilayer inductor, a closed-loop partially saturable multilayer inductor, a fully saturable saturable multilayer inductor, or a closed-loop fully saturable saturable multilayer inductor by a current flowing through the conductive coil of the inductor or a magnetic field nearby magnetically coupling the inductor. For example, an inductor of the power boost assembly of FIG. 7g can be formed by a conductive coil winding around the biggest closed-loop multilayer magnetic core and a closed-loop multilayer magnetic core inside the biggest round closed-loop multilayer magnetic core of “the first type n-phase multilayer magnetic core assembly”, “the second type n-phase multilayer magnetic core assembly”, “the third type n-phase multilayer magnetic core assembly”, or “the fourth type n-phase multilayer magnetic core assembly”, or a conductive coil winding around “the fifth type n-phase multilayer magnetic core assembly” as revealed in the present invention.

More detailed about the power boost assembly of FIG. 7g with only two power boost circuits is demonstrated in FIG. 7f for simplicity. Each power boost circuit and each voltage boost circuit have respectively been revealed earlier already. FIG. 7f has shown O₁₁, electrically connects to IN₂₁, O₁₂ electrically connects to IN₂₂, O₁₃ electrically connects to IN₂₃, and O₁₂, electrically connects to IN₂, O₁₃, and each final output of two voltage boost circuits in series is respectively as V₁, V₂, V₃ to Vₙ or the power boost assembly of FIG. 7f has multiple outputs V₁, V₂, V₃ to Vₙ. Each output of a voltage boost circuit is processed by a low-pass filter formed by a capacitor electrically connected to ground in parallel to the input IN₃₁ of another voltage boost circuit and a diode prohibits current from an input of the voltage boost circuit from flowing to an output of a up-level voltage boost circuit.

Two embodiments of FIG. 7g by using the second type square closed-loop n-phase multilayer magnetic core assembly of FIG. 2d(b) and the first type square closed-loop n-phase multilayer magnetic core assembly of FIG. 2d(a) are respectively shown in FIG. 7h(a) and FIG. 7i(a). FIG. 7h(a) and FIG. 7i(a) have respectively shown each inductor of the power boost assembly is formed by its conductive coil winding around the biggest closed-loop multilayer magnetic core 311 and a closed-loop multilayer magnetic core inside the biggest closed-loop multilayer magnetic core 311 of “the second type n-phase multilayer magnetic core assembly” and the “first type square closed-loop n-phase multilayer magnetic core” and the conductive coils respectively of the inductors of the voltage boost circuits in series of the power boost assembly of FIG. 7g winding around the biggest closed-loop multilayer magnetic core 311 and a same closed-loop multilayer magnetic core inside the biggest closed-loop multilayer magnetic core 311.

For example, as shown in FIG. 7h(a) and FIG. 7i(a), the conductive coils respectively of the inductors of the voltage boost circuits 11, 21, 31, to m1 in a first series wind around the biggest closed-loop multilayer magnetic core 311 and a first closed-loop multilayer magnetic core 1 inside the biggest closed-loop multilayer magnetic core 311 or wind in a same phase, a first phase. The conductive coil 312 of the inductor of the top voltage boost circuit 11 in the first series receives electrical input and the bottom voltage boost circuit m1 in the first series has a dc output marked as V₁ so that FIG. 7h(a) can be expressed by FIG. 7h(b) and FIG. 7i(a) can be expressed by FIG. 7i(b) for the simplicity of the drawing.

Each inductor of the power boost circuit or the power boost assembly revealed above can be formed by its conductive coil winding around the biggest closed-loop multilayer magnetic core and a closed-loop multilayer magnetic core inside the biggest closed-loop multilayer magnetic core of “the first type n-phase multilayer magnetic core assembly” shown in FIG. 2b, FIG. 2c(a), FIG. 2d(a), or FIG. 2e. Obviously, the biggest closed-loop multilayer magnetic core is the common magnetic conductor of all the inductors of the power boost circuit or the power boost assembly.

Each inductor of the power boost circuit or the power boost assembly revealed above can be formed by its conductive coil winding around the biggest closed-loop multilayer magnetic core and a closed-loop multilayer magnetic core inside the biggest closed-loop multilayer magnetic core of “the second type n-phase multilayer magnetic core assembly” shown in FIG. 2c(b), FIG. 2d(b) or FIG. 2f. Obviously, the biggest closed-loop multilayer magnetic core is the common magnetic conductor of all the inductors of the power boost circuit or the power boost assembly.

Each inductor of the power boost circuit or the power boost assembly revealed above can be formed by its conductive coil winding around the biggest closed-loop multilayer magnetic core and a closed-loop multilayer magnetic core inside the biggest closed-loop multilayer magnetic core or winding around a closed-loop multilayer magnetic core inside the biggest closed-loop multilayer magnetic core and the centered round closed-loop multilayer magnetic core of “the third type n-phase multilayer magnetic core assembly” shown in FIG. 2g. Obviously, the biggest closed-loop multilayer magnetic core or the centered round closed-loop multilayer magnetic core is the common magnetic conductor of all the inductors of the power boost circuit or the power boost assembly.

Each inductor of the power boost circuit or the power boost assembly revealed above can be formed by its conductive coil winding around the biggest closed-loop multilayer magnetic core and a closed-loop multilayer magnetic core inside the biggest closed-loop multilayer magnetic core or winding around a closed-loop multilayer magnetic core inside the biggest closed-loop multilayer magnetic core and the centered round closed-loop multilayer magnetic core of “the fourth type n-phase multilayer magnetic core assembly” shown in FIG. 2h. Obviously, the biggest closed-loop multilayer magnetic core or the centered round closed-loop multilayer magnetic core is the common magnetic conductor of all the inductors of the power boost circuit or the power boost assembly.

Each inductor of the power boost circuit or the power boost assembly revealed above can be formed by its conductive coil winding around “the fifth round closed-loop multiple phase multilayer magnetic core assembly” shown in FIG. 2i. Obviously, “the fifth round closed-loop multiple phase multilayer magnetic core assembly” is the common magnetic conductor of all the inductors of the power boost circuit or the power boost assembly.

The power boost circuit including all its embodiments or the power boost assembly including all its embodiments can be used to drive a positive dc bus, a plurality of positive dc buses, a positive dc bus and a negative dc bus, or a plurality of positive dc buses and a negative dc bus to form a dc bus level control circuit.

At least a portion of a plurality of dc outputs respectively of a plurality of voltage boost circuits of the power boost circuit including all its embodiments or the power boost assembly including all its embodiments electrically connected together can drive a positive dc bus, a plurality of positive dc buses, a positive dc bus and a negative dc bus, or a plurality of positive dc buses and a negative dc bus, for convenience, the circuit is called dc bus level control circuit in the present invention. For example, an embodiment, a portion of a plurality of dc outputs respectively of a plurality of voltage boost circuits of the power boost circuit including all its embodiments or the power boost assembly including all its embodiments electrically connected together can drive a first positive dc bus and another portion or the rest portion of the plurality of dc outputs can drive a second positive dc bus, in other words, the power boost circuit or the power boost assembly can drives a plurality of positive dc buses.

The dc outputs from the power boost circuit or the power boost assembly electrically connected together first go into a first diode, then the output out of the first diode will first enter a low-pass filter for filtering high frequency and then enter at least an inductor electrically connected in series with each other with the conductive coil of each inductor winding around at least the common magnetic conductor or conductors of the driving power boost circuit or the driving power boost assembly, and the ac electrical power out of the inductor or inductors in series will be rectified and go through a second diode for driving a loading such as a buffer or the ac electrical power out of the inductor or inductors in series needs to be boosted and rectified then goes through a second diode for driving the buffer. The second diode may involve in the boost and rectification of the ac electrical power out of the inductor or inductors in series. The inductor or inductors in series may be part of the low-pass filter. The circuit between the first diode and the second diode is called “a positive dc bus”. The first diode may also receive an electrical power from a battery or a super capacitor or ultra capacitor viewed as a second power source to the positive dc bus. The second diode prohibits current from the buffer from flowing back into the positive dc bus. The second diode electrically connects to the first diode through a third diode to form a positive feedback loop for improving the performance of the dc bus level control circuit. The third diode prohibits current from the battery or the super capacitor or ultra capacitor from flowing back into the buffer.

The plurality of inductors electrically connected in series with each other form two terminals respectively as a first terminal at a first inductor in the series and a second terminal at a last inductor in the series. The low-pass filter is not limited to any particular filter, for example, the low pass-filter can be a π low-pass filter formed by two capacitors respectively as a first capacitor and a second capacitor and all the inductors electrically connected in series with each other sitted between the first capacitor and the second capacitor.

For the positive dc bus having the π low-pass filter, ac induced by the inductors can respectively potentially build a negative potential on the low side of each capacitor of the π low-pass filter so a first negative potential cancelling circuit in parallel to and by the first capacitor of the π low-pass filter and a second negative potential cancelling circuit in parallel to and by the second capacitor of the r low-pass filter may be needed for cancelling the negative potential built at the low side of each capacitor. Each negative potential cancelling circuit is not limited to any particular circuit, for example, each negative potential cancelling circuit can be formed by a diode and a damper electrically connected in series. The diode conducts current converted by the negative potential built at the low side of the capacitor of the π low-pass filter to flow into the nearby negative potential cancelling circuit and the damper electrically dissipates the current. The damper is not limited to a particular damper, for example, the damper can be formed by a PDR device and a NDR device electrically connected in series.

The ac electrical power out of the inductor or inductors in series can be boosted and rectified by the voltage boost circuit of FIG. 5(b) formed with the inductor ot inductors in series of the positive dc bus and the second diode. The second diode of the positive dc bus can be the high side diode and the inductor or inductors in series of the positive dc bus can be the inductor of the voltage boost circuit of FIG. 5(b). The negative potential built at the low side of the second capacitor of the π low-pass filter can be converted into a current flowing through the low side anti-diode in parallel to the transistor of the voltage boost circuit and the second diode all the way to the buffer also to perform the job of the second negative potential cancelling circuit. Besides, the first diode, the diode of the first negative potential cancelling circuit, the low side anti-diode of the voltage boost circuit, and the second diode form a full bridge rectifier to rectify ac in the positive dc bus into dc.

A switch may be needed for controlling the electrical connection or disconnection between the battery or the super capacitor and the first diode, for example, the battery or the super capacitor can be electrically disconnected with the first diode by turning off the switch at an initial period of time when the circuit is initially turned on and the switch can be turned on to electrically connect the battery or the super capacitor with the first diode after the system runs stable for a period of time. This is called a soft start so that the dc bus level control circuit is also a soft start circuit. The switch is not limited to any particular switch, for example, the switch can be a controllable transistor.

The inductor or inductors of the positive dc bus are not limited to any particular inductor, for example, the conductive coil of an inductor of the positive dc bus can wind around the biggest closed-loop multilayer magnetic core and a closed-loop multilayer magnetic core inside the biggest round closed-loop multilayer magnetic core of “the first type n-phase multilayer magnetic core assembly”, “the second type n-phase multilayer magnetic core assembly”, “the third type n-phase multilayer magnetic core assembly”, or “the fourth type n-phase multilayer magnetic core assembly”, or the conductive coil of each inductor can wind around “the fifth type n-phase multilayer magnetic core assembly” as revealed above in the present invention.

An electrical input to a voltage boost circuit of the power boost circuit or the power boost assembly of the dc bus level control circuit can be a battery. An ac flowing through a conductive coil winding around at least the common magnetic conductor or conductors of the driving power boost circuit or the driving power boost assembly is rectified for electrically charging the battery or rectified and low-pass filtered for electrically charging the battery. The more detailed can be referred to the power boost circuit section above.

The dc bus level control circuit can also electrically charge the battery or the super capacitor so the dc bus level control circuit is also a battery charging circuit.

Some embodiments of dc bus level control circuit respectively based on the first type n-phase multilayer magnetic core assembly”, “the second type n-phase multilayer magnetic core assembly”, “the third type n-phase multilayer magnetic core assembly”, “the fourth type n-phase multilayer magnetic core assembly”, and “the fifth type n-phase multilayer magnetic core assembly” will be demonstrated as followed below.

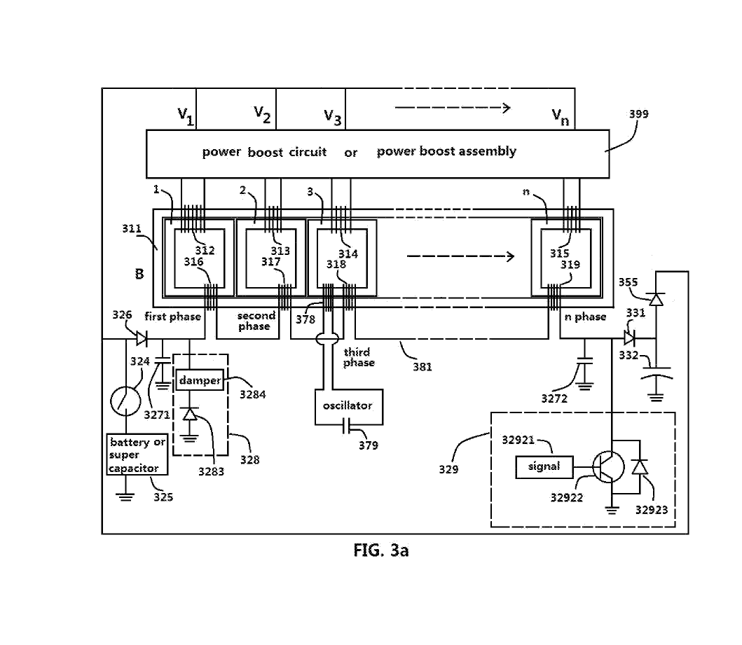

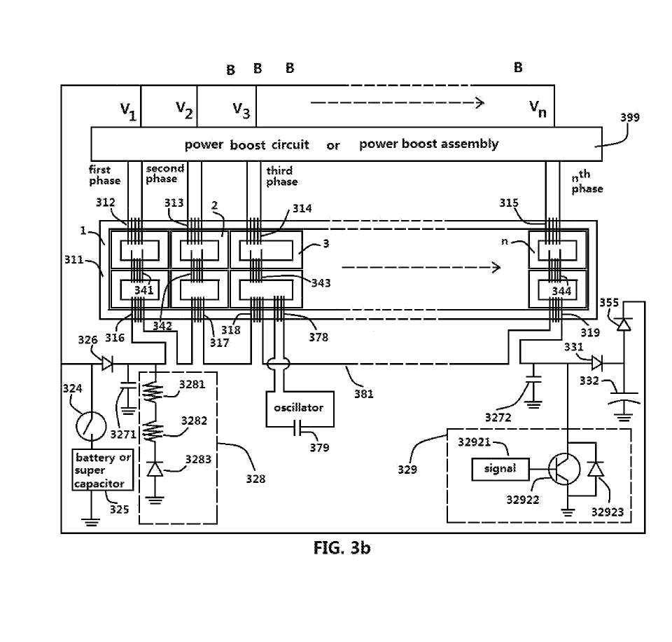

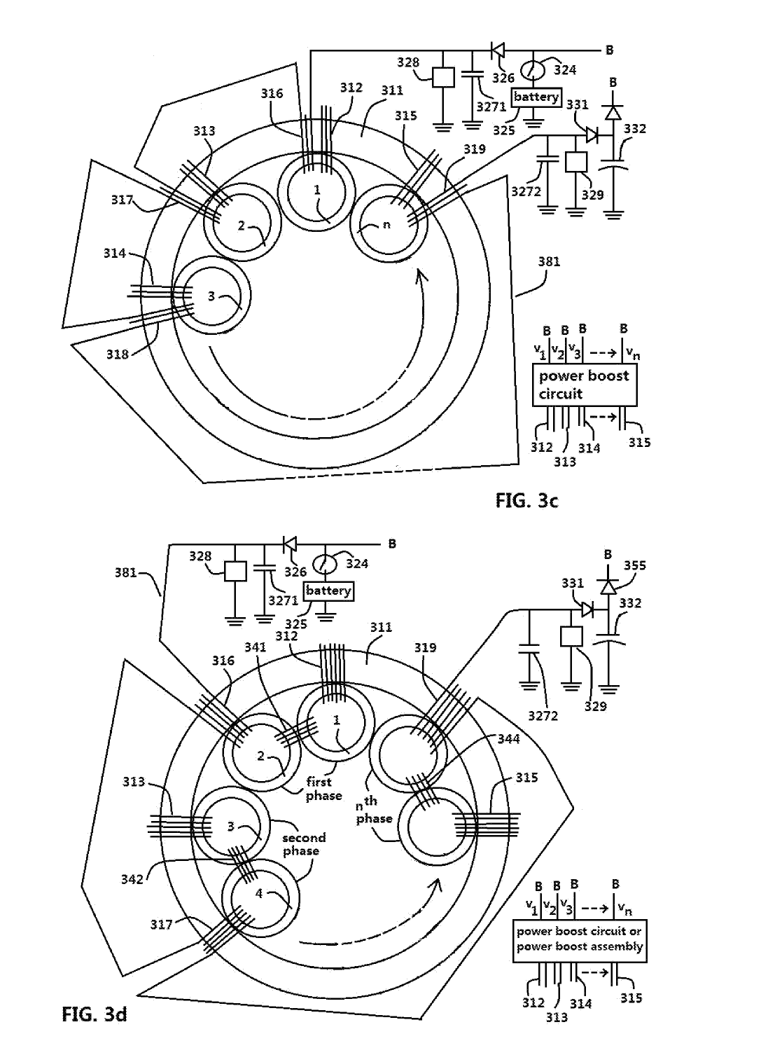

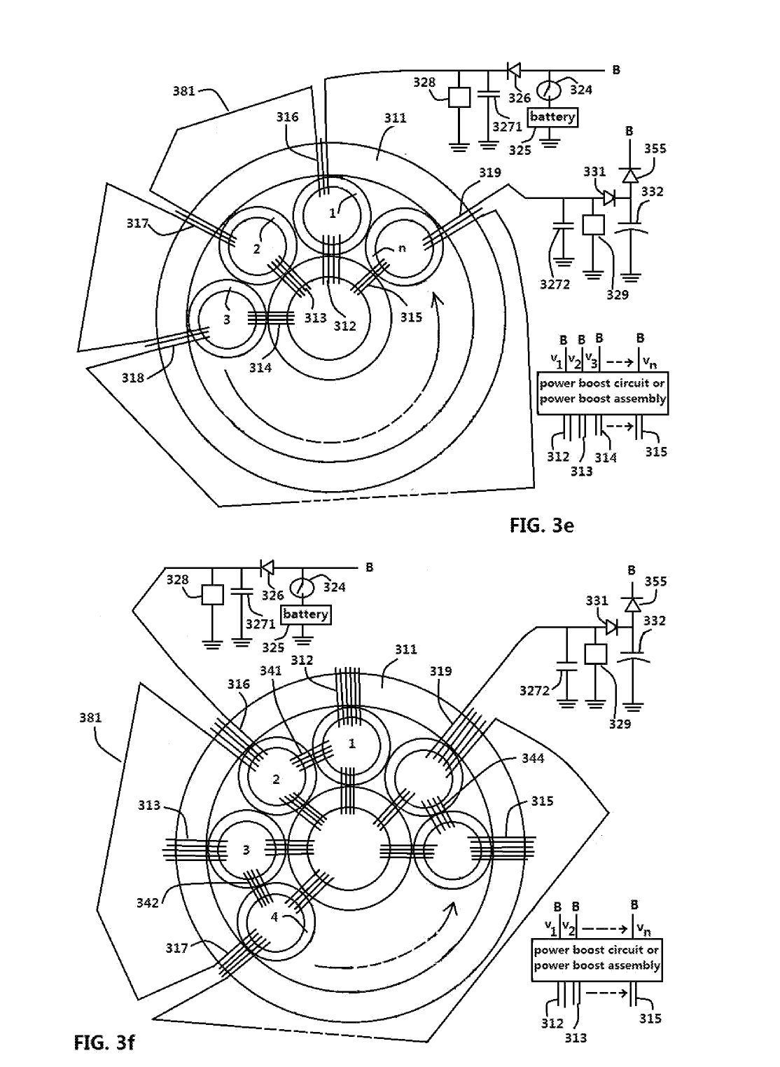

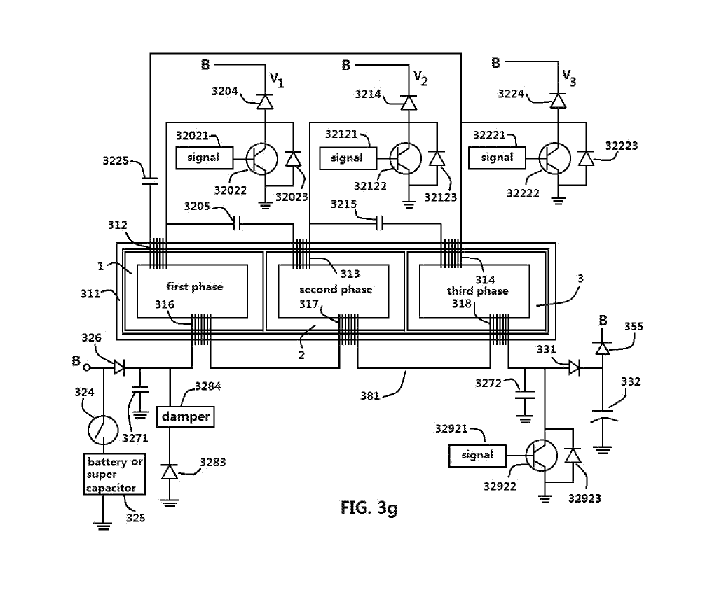

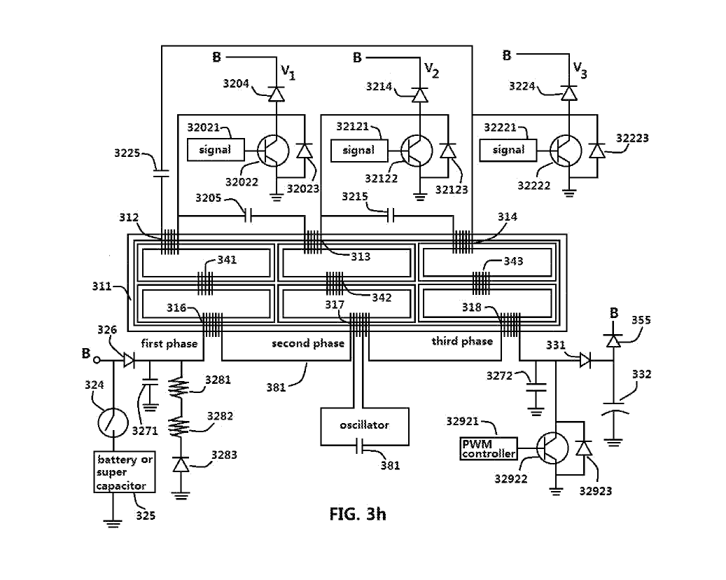

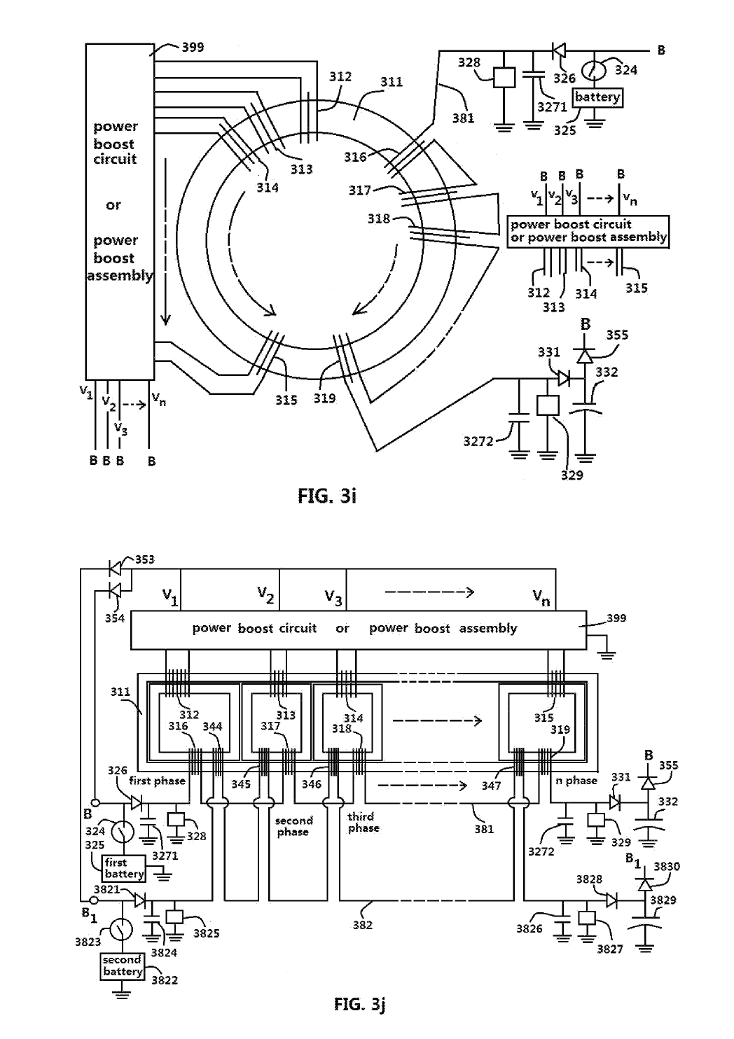

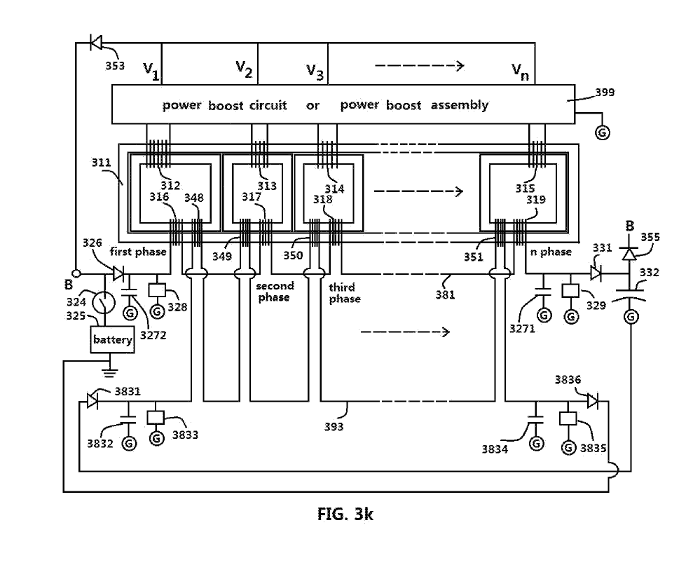

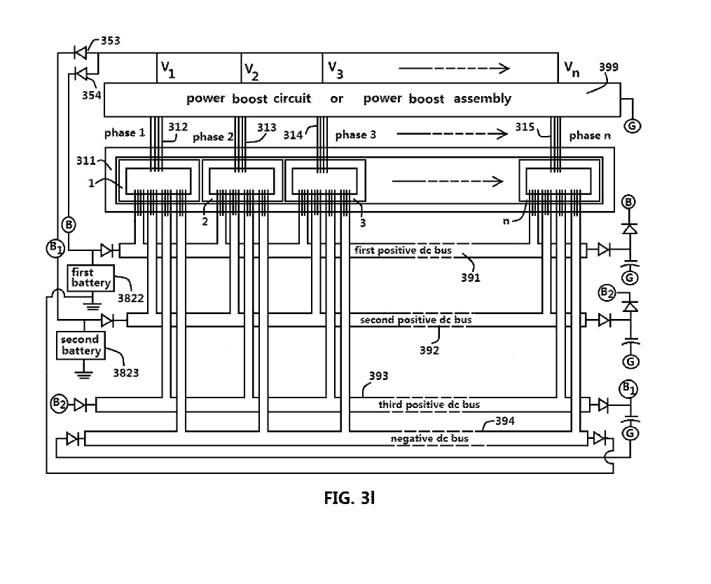

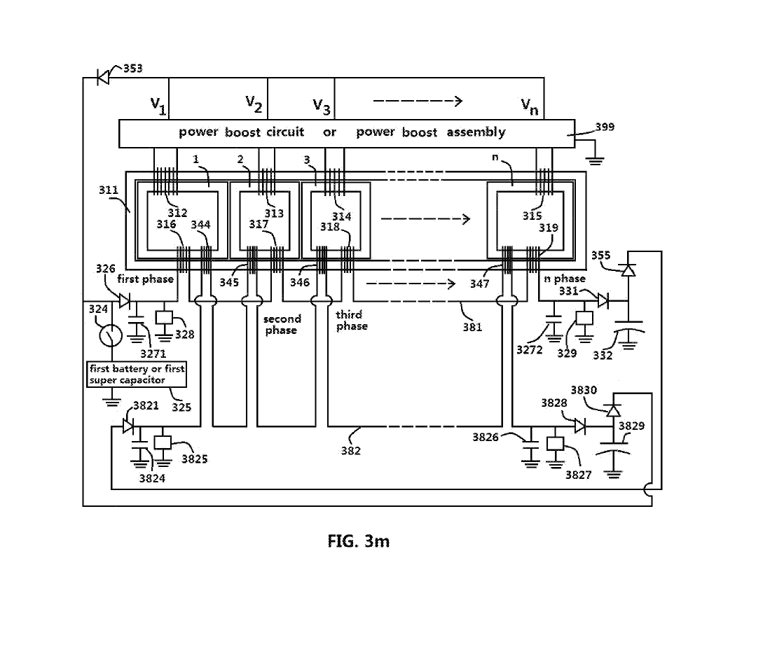

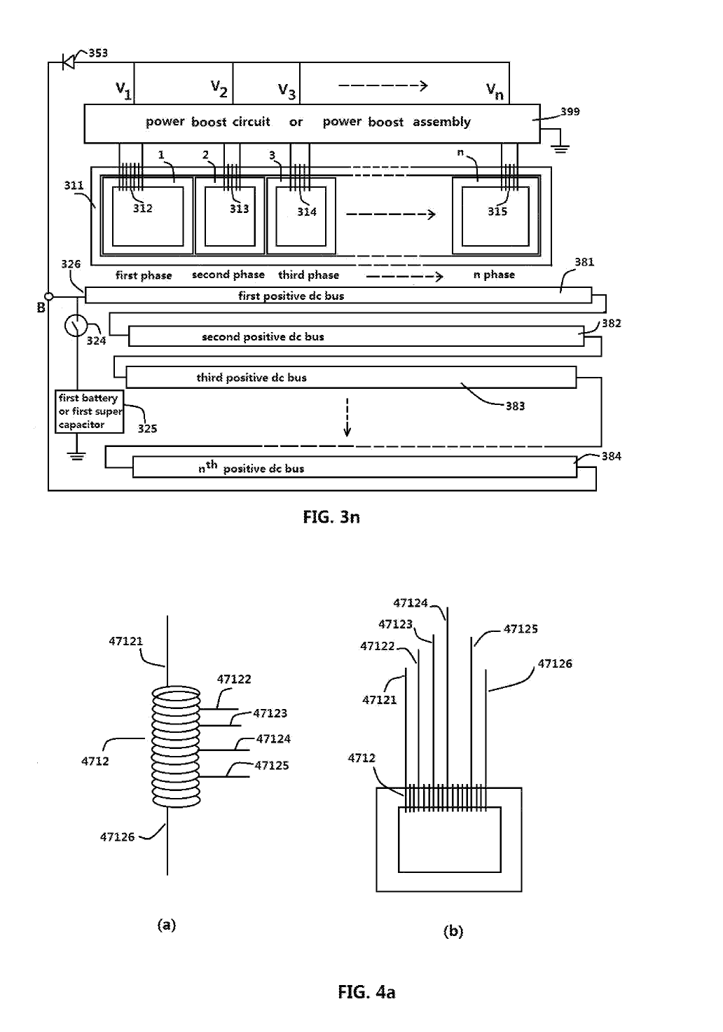

A first type dc bus level control circuit is based on “the first type n-phase multilayer magnetic core assembly” of the embodiment of FIG. 2b, FIG. 2c(a), FIG. 2d(a), or FIG. 2e is shown in FIG. 3a and FIG. 3(c) and a second type dc bus level control circuit based on “the second type n-phase multilayer magnetic core assembly” of the embodiment of FIG. 2c(b), FIG. 2d(b) or FIG. 2f is shown in FIG. 3b and FIG. 3(d). A third type dc bus level control circuit based on “the third type n-phase multilayer magnetic core assembly” of the embodiment of FIG. 2g is shown in FIG. 3e. A fourth type dc bus level control circuit based on “the fourth type n-phase multilayer magnetic core assembly” of the embodiment of FIG. 2h is shown in FIG. 3f. A fifth type dc bus level control circuit based on “the fifth type n-phase multilayer magnetic core assembly” of the embodiment of FIG. 2i is shown in FIG. 3i.

For “the first type dc bus level control circuit” shown in FIG. 3a and FIG. 3c, “the second type dc bus level control circuit” shown in FIG. 3b and FIG. 3d, “the third type dc bus level control circuit” of FIG. 3e, “the fourth type dc bus level control circuit” of FIG. 3f, and “the fifth type dc bus level control circuit” of FIG. 3i, each of the plurality of inductors of a first positive dc bus 381 formed with each phase such as a first phase has a first inductor with its conductive coil 316 winding around the biggest closed-loop multilayer magnetic core 311 and a first closed-loop multilayer magnetic core 1 inside the biggest closed-loop multilayer magnetic core 311, a second phase has a second inductor with its conductive coil 317 winding around the biggest closed-loop multilayer magnetic core 311 and a second closed-loop multilayer magnetic core 2 inside the biggest closed-loop multilayer magnetic core 311, a third phase has a third inductor with its conductive coil 318 winding around the biggest closed-loop multilayer magnetic core 311 and a third closed-loop multilayer magnetic core 3 inside the biggest closed-loop multilayer magnetic core 311, and so on to a n^{th} phase has a n^{th} inductor with its conductive coil 319 winding around the biggest closed-loop multilayer magnetic core 311 and a n^{th} closed-loop multilayer magnetic core n inside the biggest closed-loop multilayer magnetic core 311. Each inductor can have a multiple-terminal conductive coil.

Each of FIG. 3a, FIG. 3c, FIG. 3b, FIG. 3d, FIG. 3e, FIG. 3f and FIG. 3i has shown the first positive dc bus having a first diode 326, a first π low-pass filter formed by two capacitors as a first capacitor 3271 and a second capacitor 3272 and at least an inductor assuming n inductors electrically connected in series with each other sitted between the first capacitors 3271 and the second capacitor 3272, a first negative potential cancelling circuit 328 disposed by and in parallel to the first capacitor 3271 formed by a diode 3283 and a damper 3284 electrically connected in series to ground shown in FIG. 3a and FIG. 3g for electrically cancelling the negative potential built at the low side of the first capacitor 3271, a second diode 331, and a first voltage boost circuit 329 of FIG. 5(b) formed by the inductor or inductors in series of the first positive dc bus and a transistor 32922 with a low side anti-diode 32923 in parallel to the transistor 32922 electrically connected in series to ground and the second diode 331 in parallel to the inductor or inductors in series for outputting an expected boost voltage to drive a first buffer 332. A signal 32921 switches the transistor 32922 of the first voltage boost circuit 329. The negative potential built at the low side of the second capacitor 3272 of the first π low-pass filter can be converted into a current flowing through the low side anti-diode 32923 and the second diode 331 of the first voltage boost circuit 329 all the way out also performing the job of cancelling the negative potential built at the second capacitor 3272. The damper 3284 is not limited to a particular damper, for example, the damper can be formed by a PDR device and a NDR device electrically connected in series as shown in the embodiments of FIG. 3b and FIG. 3h. The damper 3284 formed by a PDR device 3281 and a NDR device 3282 electrically connected in series can be seen in embodiments of the second type dc bus level control circuit of FIG. 3b and FIG. 3h. The first diode 326 also can receive an electrical power from a first battery or a first super capacitor 325 viewed as a second power source to the first positive dc bus. The second diode 331 electrically connects to the first diode 326 through a third diode 355 to form a positive feedback loop. The third diode 355 is for prohibiting current from the battery or the super capacitor 325 from flowing into the first buffer 332.

The first diode 326 prohibits current from the first positive dc bus from flowing back to the power boost circuit or the power boost assembly 399, for convenience, the first diode 326 is called as “a backward current isolator”, the second diode 331 prohibits current from the buffer 332 from flowing back to the first positive dc bus also functioning as “a backward current isolator”, and the third diode 355 prohibits current from the battery or the super capacitor 325 from flowing back into the buffer 332.

The first diode 326, the diode 3283 of the first negative potential cancelling circuit 328, the low side anti-diode 32923 of the voltage boost circuit 329, and the second diode 331 form a full bridge rectifier to rectify ac in the first positive dc bus into dc.

A switch 324 may be needed for controlling the electrical connection or disconnection between the battery or the super capacitor 325 and the first diode 326.

An oscillator formed by a capacitor including the inventive capacitor revealed in the present invention including all its embodiments and an inductor formed with a conductive coil winding around at least the biggest closed-loop multilayer magnetic core of FIG. 3a, FIG. 3b, FIG. 3c, FIG. 3d, FIG. 3e or FIG. 3f or the round closed-loop multilayer magnetic core shown in FIG. 3i may be needed to provide a signal or a waveform modulated with the signal to switch the transistor 32922 of the first voltage boost circuit 329 for monitoring the buffer 332.

For “the first type dc bus level control circuit” shown in FIG. 3a and FIG. 3c, “the second type dc bus level control circuit” shown in FIG. 3b and FIG. 3d, “the third type dc bus level control circuit” of FIG. 3e, “the fourth type dc bus level control circuit” of FIG. 3f, and “the fifth type dc bus level control circuit” of FIG. 3i, an electrical input to a voltage boost circuit of the power boost circuit or the power boost assembly can be a battery. An ac flowing through a conductive coil winding around at least the common magnetic conductor or conductors of the driving power boost circuit or the driving power boost assembly is rectified for electrically charging the battery or rectified and low-pass filtered for electrically charging the battery.

Based on the embodiments of FIG. 3a, FIG. 3c, FIG. 3b, FIG. 3d, FIG. 3e, FIG. 3f and FIG. 3i, the second diode 331 does not directly positively fedback to the first diode 326 instead the second diode 331 first goes through a second positive dc bus 382 and then electrically connects to the first diode 326 to complete the positive feedback loop as shown in an embodiment of FIG. 3m based on FIG. 3a. FIG. 3m has shown a second positive dc bus 382 as same as the first positive dc bus 381 having a fourth diode 3821, a third capacitor 3824 and a fourth capacitor 3826 of a second π low-pass filter, a third negative potential cancelling circuit 3825 in parallel to the third capacitor 3824, at least an inductor electrically connected in series with each other with the conductive coil of each inductor winding around at least the biggest closed-loop multilayer magnetic core 311 such as the first phase has an inductor with its conductive coil 344 winding around the biggest closed-loop multilayer magnetic core 311 and the first closed-loop multilayer magnetic core 1 inside the biggest closed-loop multilayer magnetic core 311, the second phase has an inductor with its conductive coil 345 winding around the biggest closed-loop multilayer magnetic core 311 and the second closed-loop multilayer magnetic core 2 inside the biggest closed-loop multilayer magnetic core 311, the third phase has an inductor with its conductive coil 346 winding around the biggest closed-loop multilayer magnetic core 311 and the third closed-loop multilayer magnetic core 3 inside the biggest closed-loop multilayer magnetic core 311, and so on to the n^{th} phase has an inductor with its conductive coil 347 winding around the biggest closed-loop multilayer magnetic core 311 and the n^{th} closed-loop multilayer magnetic core n inside the biggest closed-loop multilayer magnetic core 311, a fifth diode 3828, and a second voltage boost circuit 3827 formed with the inductors in series and the fifth diode 3828. The dc output out from the fifth diode 3828 drives a second buffer 3829. The second diode 331 of the first positive dc bus 381 electrically connects to the fourth diode 3821 of the second positive dc bus 382 and the output out of the fifth diode 3828 of the second positive dc bus 382 electrically connects to the first diode 326 of the first positive dc bus 381 to complete a positive feedback loop through a sixth diode 3830.

The third diode 355 may not be needed. The first diode 326 prohibits current from the first positive dc bus from flowing back to the power boost circuit or the power boost assembly 399, the second diode 331 prohibits current from the first buffer 332 from flowing back to the first positive dc bus, the fourth diode 3821 prohibits current from the second positive dc bus from flowing back to the first positive dc bus and the first buffer 332, the fifth diode 3828 prohibits current from the second buffer 3829 from flowing back to the second positive dc bus 382, and the sixth diode 3830 prohibits current from the first battery or the first super capacitor 325 from flowing into the second buffer 3829.

The logic revealed in the embodiment of FIG. 3m can be applied to n positive dc buses as shown in an embodiment of FIG. 3n. FIG. 3n has shown n positive dc buses for n≧2 without showing detailed circuit with each having at least an inductor electrically connected in series with each other with the conductive coil of each inductor winding around at least the biggest closed-loop multilayer magnetic core 311 and the n positive dc buses are electrically connected in series with each other to form a positive feedback loop. FIG. 3m has shown the outputs of the power boost circuit or the power boost assembly 399 input into a first positive dc bus 381, an output of the first positive dc bus 381 inputs to a second positive dc bus 382, an output of the second positive dc bus 382 inputs to a third positive dc bus 383, and so on to a n^{th} positive dc bus 384 and an output of the n^{th} positive dc bus 384 electrically connects to the input of the first positive dc bus 381 to complete the positive feedback loop.

The embodiments of the dc bus level control circuit of FIGS. 3m and 3n have featured the power boost circuit or the power boost assembly is capable of driving a plurality of positive dc buses with fewer batteries or super capacitors and current flowing through the plurality of positive dc buses provides extra magnetization to the biggest closed-loop multilayer magnetic core 311.

Another embodiment of the power boost circuit or the power boost assembly driving a plurality of positive dc buses is shown in FIG. 3j based on FIG. 3m. Using FIG. 3m, adding a second battery 3822 provides electrical power at the fourth diode 3821 of the second positive dc bus 382 as a second power source to the second positive dc bus 382 and at least a portion of the outputs of the power boost circuit or the power boost assembly 399 electrically connected together go through two diodes 353 and 354 to drive the first positive dc bus 381 and the second positive dc bus 382 and each of the first positive dc bus 381 and the second positive dc bus 382 has a positive feedback loop as shown in FIG. 3j. Shown in FIG. 3j, two Bs and two B₁s are electrically connected together to complete the positive feedback loop.

The power boost circuit or the power boost assembly 399 can drive both positive dc bus and negative dc bus. The first positive dc bus revealed in the embodiment of FIG. 3a uses same reference level. Based on FIG. 3a, all the devices with their ground electrically connected to the low side of the buffer 332 which electrically connects to the ground of the battery 325 through a negative dc bus 393 as same as the first positive dc bus formed by two capacitors 3832, 3834 and at least an inductor electrically connected in series with each other with the conductive coil of each inductor winding around at least the biggest closed-loop multilayer magnetic core 311 form a π low-pass filter, a block 3833 represents a negative potential cancelling circuit, a block 3835 represents a voltage boost circuit of FIG. 5(b), and two diodes 3831 and 3836 as shown in FIG. 3k.

Combining the embodiments of FIG. 3m, FIG. 3k and FIG. 3j is shown in FIG. 3l in a simpler expression, FIG. 3l has shown the power boost circuit or the power boost assembly 399 driving three positive dc buses respectively as a first positive dc bus 391, a second positive dc bus 392 and a third positive dc bus 393 and a negative dc bus 394. The first positive dc bus 391 has its own positive feedback loop. The second positive dc bus 392 goes through a third positive bus 393 to complete a positive feedback loop. FIG. 3l has also shown a negative dc bus 394.

The first type dc bus level control circuit, the second type dc bus level control circuit, the third type dc bus level control circuit, the fourth type dc bus level control circuit and the fifth type dc bus level control circuit can also function to charge the battery, function as a power factor correction circuit (or PFC in short), function as an electric pedal control circuit, or function as a soft start circuit so the first type dc bus level control circuit can be called as a first type battery charge circuit, a first type power factor correction circuit, a first type soft start circuit, or a first type electric pedal control circuit, the second type dc bus level control circuit can be called as a second type battery charge circuit, a second type power factor correction circuit, a second type soft start circuit, or a second type electric pedal control circuit, the third type dc bus level control circuit can be called as a third type battery charge circuit, a third type power factor correction circuit, a third type soft start circuit, or a third type electric pedal control circuit, the fourth type dc bus level control circuit can be called as a fourth type battery charge circuit, a fourth type power factor correction circuit, a fourth type soft start circuit, or a fourth type electric pedal control circuit, and the fifth type dc bus level control circuit can be called as a fifth type battery charge circuit, a fifth type power factor correction circuit, a fifth type soft start circuit, or a fifth type electric pedal control circuit in the present invention.

The embodiments of FIG. 3j and FIG. 3l can be respectively viewed as a circuit electrically charging a plurality of batteries at the same time, in other words, it can be a battery charging station.

A first embodiment, all the magnetic conductor layers wound by a conductive coil of “the first type n-phase multilayer magnetic core assembly” of FIG. 2b, FIG. 2c(a), FIG. 2d(a), or FIG. 2e, “the first type dc bus level control circuit” of FIG. 3a, FIG. 3c or FIG. 3g based on “the first type n-phase multilayer magnetic core assembly” of FIG. 2b, FIG. 2c(a), FIG. 2d(a), or FIG. 2e, the power boost circuit including its all embodiments based on “the first type n-phase multilayer magnetic core assembly” of FIG. 2b, FIG. 2c(a), FIG. 2d(a), or FIG. 2e, the power boost assembly including its all embodiments based on “the first type n-phase multilayer magnetic core assembly” of FIG. 2b, FIG. 2c(a), FIG. 2d(a), or FIG. 2e, “the second type n-phase multilayer magnetic core assembly” of FIG. 2c(b), FIG. 2d(b) or FIG. 2f, “the second type dc bus level control circuit” of FIG. 3b, FIG. 3d, or FIG. 3h based on “the second type n-phase multilayer magnetic core assembly” of FIG. 2c(b), FIG. 2d(b) or FIG. 2f, the power boost circuit including its all embodiments based on “the second type n-phase multilayer magnetic core assembly” of FIG. 2c(b), FIG. 2d(b) or FIG. 2f, the power boost assembly including its all embodiments based on “the second type n-phase multilayer magnetic core assembly” of FIG. 2c(b), FIG. 2d(b) or FIG. 2f, “the third type n-phase multilayer magnetic core assembly” of FIG. 2g, “the third type dc bus level control circuit” of FIG. 3e based on “the third type n-phase multilayer magnetic core assembly” of FIG. 2g, the power boost circuit including its all embodiments based on “the third type n-phase multilayer magnetic core assembly” of FIG. 2g, the power boost assembly including its all embodiments based on “the third type n-phase multilayer magnetic core assembly” of FIG. 2g, “the fourth type n-phase multilayer magnetic core assembly” of FIG. 2h, “the fourth type dc bus level control circuit” of FIG. 3f based on “the fourth type n-phase multilayer magnetic core assembly” of FIG. 2h, the power boost circuit including its all embodiments based on “the fourth type n-phase multilayer magnetic core assembly” of FIG. 2h, the power boost assembly including its all embodiments based on “the fourth type n-phase multilayer magnetic core assembly” of FIG. 2h, the fifth type n-phase multilayer magnetic core assembly” of FIG. 2i, or “the fifth type dc bus level control circuit” of FIG. 3i based on “the fifth type n-phase multilayer magnetic core assembly” of FIG. 2i, the power boost circuit including its all embodiments based on “the fifth type n-phase multilayer magnetic core assembly” of FIG. 2i, or the power boost assembly including its all embodiments based on “the fifth type n-phase multilayer magnetic core assembly” of FIG. 2i have different saturation levels from each other by a current flowing through the conductive coil or/and a nearby magnetical field magnetically coupling the magnetic conductor layers.

A second embodiment, at least a magnetic conductor layer wound by a conductive coil of “the first type n-phase multilayer magnetic core assembly” of FIG. 2b, FIG. 2c(a), FIG. 2d(a), or FIG. 2e, “the first type dc bus level control circuit” of FIG. 3a, FIG. 3c or FIG. 3g based on “the first type n-phase multilayer magnetic core assembly” of FIG. 2b, FIG. 2c(a), FIG. 2d(a), or FIG. 2e, the power boost circuit including its all embodiments based on “the first type n-phase multilayer magnetic core assembly” of FIG. 2b, FIG. 2c(a), FIG. 2d(a), or FIG. 2e, the power boost assembly including its all embodiments based on “the first type n-phase multilayer magnetic core assembly” of FIG. 2b, FIG. 2c(a), FIG. 2d(a), or FIG. 2e, “the second type n-phase multilayer magnetic core assembly” of FIG. 2c(b), FIG. 2d(b) or FIG. 2f, “the second type dc bus level control circuit” of FIG. 3b, FIG. 3d, or FIG. 3h based on “the second type n-phase multilayer magnetic core assembly” of FIG. 2c(b), FIG. 2d(b) or FIG. 2f, the power boost circuit including its all embodiments based on “the second type n-phase multilayer magnetic core assembly” of FIG. 2c(b), FIG. 2d(b) or FIG. 2f, the power boost assembly including its all embodiments based on “the second type n-phase multilayer magnetic core assembly” of FIG. 2c(b), FIG. 2d(b) or FIG. 2f, “the third type n-phase multilayer magnetic core assembly” of FIG. 2g, “the third type dc bus level control circuit” of FIG. 3e based on “the third type n-phase multilayer magnetic core assembly” of FIG. 2g, the power boost circuit including its all embodiments based on “the third type n-phase multilayer magnetic core assembly” of FIG. 2g, the power boost assembly including its all embodiments based on “the third type n-phase multilayer magnetic core assembly” of FIG. 2g, “the fourth type n-phase multilayer magnetic core assembly” of FIG. 2h, “the fourth type dc bus level control circuit” of FIG. 3f based on “the fourth type n-phase multilayer magnetic core assembly” of FIG. 2h, the power boost circuit including its all embodiments based on “the fourth type n-phase multilayer magnetic core assembly” of FIG. 2h, the power boost assembly including its all embodiments based on “the fourth type n-phase multilayer magnetic core assembly” of FIG. 2h, the fifth type n-phase multilayer magnetic core assembly” of FIG. 2i, or “the fifth type dc bus level control circuit” of FIG. 3i based on “the fifth type n-phase multilayer magnetic core assembly” of FIG. 2i, the power boost circuit including its all embodiments based on “the fifth type n-phase multilayer magnetic core assembly” of FIG. 2i, or the power boost assembly including its all embodiments based on “the fifth type n-phase multilayer magnetic core assembly” of FIG. 2i can be saturated by a current flowing through the conductive coil or/and a nearby magnetical field magnetically coupling the magnetic conductor layers.

A third embodiment based on the second embodiment above, at least a magnetic conductor layer wound by a conductive coil of “the first type n-phase multilayer magnetic core assembly” of FIG. 2b, FIG. 2c(a), FIG. 2d(a), or FIG. 2e, “the first type dc bus level control circuit” of FIG. 3a, FIG. 3c or FIG. 3g based on “the first type n-phase multilayer magnetic core assembly” of FIG. 2b, FIG. 2c(a), FIG. 2d(a), or FIG. 2e, the power boost circuit including its all embodiments based on “the first type n-phase multilayer magnetic core assembly” of FIG. 2b, FIG. 2c(a), FIG. 2d(a), or FIG. 2e, the power boost assembly including its all embodiments based on “the first type n-phase multilayer magnetic core assembly” of FIG. 2b, FIG. 2c(a), FIG. 2d(a), or FIG. 2e, “the second type n-phase multilayer magnetic core assembly” of FIG. 2c(b), FIG. 2d(b) or FIG. 2f, “the second type dc bus level control circuit” of FIG. 3b, FIG. 3d, or FIG. 3h based on “the second type n-phase multilayer magnetic core assembly” of FIG. 2c(b), FIG. 2d(b) or FIG. 2f, the power boost circuit including its all embodiments based on “the second type n-phase multilayer magnetic core assembly” of FIG. 2c(b), FIG. 2d(b) or FIG. 2f, the power boost assembly including its all embodiments based on “the second type n-phase multilayer magnetic core assembly” of FIG. 2c(b), FIG. 2d(b) or FIG. 2f, “the third type n-phase multilayer magnetic core assembly” of FIG. 2g, “the third type dc bus level control circuit” of FIG. 3e based on “the third type n-phase multilayer magnetic core assembly” of FIG. 2g, the power boost circuit including its all embodiments based on “the third type n-phase multilayer magnetic core assembly” of FIG. 2g, the power boost assembly including its all embodiments based on “the third type n-phase multilayer magnetic core assembly” of FIG. 2g, “the fourth type n-phase multilayer magnetic core assembly” of FIG. 2h, “the fourth type dc bus level control circuit” of FIG. 3f based on “the fourth type n-phase multilayer magnetic core assembly” of FIG. 2h, the power boost circuit including its all embodiments based on “the fourth type n-phase multilayer magnetic core assembly” of FIG. 2h, the power boost assembly including its all embodiments based on “the fourth type n-phase multilayer magnetic core assembly” of FIG. 2h, the fifth type n-phase multilayer magnetic core assembly” of FIG. 2i, or “the fifth type dc bus level control circuit” of FIG. 3i based on “the fifth type n-phase multilayer magnetic core assembly” of FIG. 2i, the power boost circuit including its all embodiments based on “the fifth type n-phase multilayer magnetic core assembly” of FIG. 2i, or the power boost assembly including its all embodiments based on “the fifth type n-phase multilayer magnetic core assembly” of FIG. 2i can not be saturated by a current flowing through the conductive coil or/and a nearby magnetical field magnetically coupling the magnetic conductor layers.

A fourth embodiment, at least a magnetic conductor layer wound by a conductive coil of “the first type n-phase multilayer magnetic core assembly” of FIG. 2b, FIG. 2c(a), FIG. 2d(a), or FIG. 2e, “the first type dc bus level control circuit” of FIG. 3a, FIG. 3c or FIG. 3g based on “the first type n-phase multilayer magnetic core assembly” of FIG. 2b, FIG. 2c(a), FIG. 2d(a), or FIG. 2e, the power boost circuit including its all embodiments based on “the first type n-phase multilayer magnetic core assembly” of FIG. 2b, FIG. 2c(a), FIG. 2d(a), or FIG. 2e, the power boost assembly including its all embodiments based on “the first type n-phase multilayer magnetic core assembly” of FIG. 2b, FIG. 2c(a), FIG. 2d(a), or FIG. 2e, “the second type n-phase multilayer magnetic core assembly” of FIG. 2c(b), FIG. 2d(b) or FIG. 2f, “the second type dc bus level control circuit” of FIG. 3b, FIG. 3d, or FIG. 3h based on “the second type n-phase multilayer magnetic core assembly” of FIG. 2c(b), FIG. 2d(b) or FIG. 2f, the power boost circuit including its all embodiments based on “the second type n-phase multilayer magnetic core assembly” of FIG. 2c(b), FIG. 2d(b) or FIG. 2f, the power boost assembly including its all embodiments based on “the second type n-phase multilayer magnetic core assembly” of FIG. 2c(b), FIG. 2d(b) or FIG. 2f, “the third type n-phase multilayer magnetic core assembly” of FIG. 2g, “the third type dc bus level control circuit” of FIG. 3e based on “the third type n-phase multilayer magnetic core assembly” of FIG. 2g, the power boost circuit including its all embodiments based on “the third type n-phase multilayer magnetic core assembly” of FIG. 2g, the power boost assembly including its all embodiments based on “the third type n-phase multilayer magnetic core assembly” of FIG. 2g, “the fourth type n-phase multilayer magnetic core assembly” of FIG. 2h, “the fourth type dc bus level control circuit” of FIG. 3f based on “the fourth type n-phase multilayer magnetic core assembly” of FIG. 2h, the power boost circuit including its all embodiments based on “the fourth type n-phase multilayer magnetic core assembly” of FIG. 2h, the power boost assembly including its all embodiments based on “the fourth type n-phase multilayer magnetic core assembly” of FIG. 2h, the fifth type n-phase multilayer magnetic core assembly” of FIG. 2i, or “the fifth type dc bus level control circuit” of FIG. 3i based on “the fifth type n-phase multilayer magnetic core assembly” of FIG. 2i, the power boost circuit including its all embodiments based on “the fifth type n-phase multilayer magnetic core assembly” of FIG. 2i, or the power boost assembly including its all embodiments based on “the fifth type n-phase multilayer magnetic core assembly” of FIG. 2i can not be saturated by a current flowing through the conductive coil or/and a nearby magnetical field magnetically coupling the magnetic conductor layers.

A fifth embodiment, for “the first type n-phase multilayer magnetic core assembly” of FIG. 2b, FIG. 2c(a), FIG. 2d(a), or FIG. 2e, “the first type dc bus level control circuit” of FIG. 3a, FIG. 3c or FIG. 3g based on “the first type n-phase multilayer magnetic core assembly” of FIG. 2b, FIG. 2c(a), FIG. 2d(a), or FIG. 2e, the power boost circuit including its all embodiments based on “the first type n-phase multilayer magnetic core assembly” of FIG. 2b, FIG. 2c(a), FIG. 2d(a), or FIG. 2e, the power boost assembly including its all embodiments based on “the first type n-phase multilayer magnetic core assembly” of FIG. 2b, FIG. 2c(a), FIG. 2d(a), or FIG. 2e, “the second type n-phase multilayer magnetic core assembly” of FIG. 2c(b), FIG. 2d(b) or FIG. 2f, “the second type dc bus level control circuit” of FIG. 3b, FIG. 3d, or FIG. 3h based on “the second type n-phase multilayer magnetic core assembly” of FIG. 2c(b), FIG. 2d(b) or FIG. 2f, the power boost circuit including its all embodiments based on “the second type n-phase multilayer magnetic core assembly” of FIG. 2c(b), FIG. 2d(b) or FIG. 2f, the power boost assembly including its all embodiments based on “the second type n-phase multilayer magnetic core assembly” of FIG. 2c(b), FIG. 2d(b) or FIG. 2f, “the third type n-phase multilayer magnetic core assembly” of FIG. 2g, “the third type dc bus level control circuit” of FIG. 3e based on “the third type n-phase multilayer magnetic core assembly” of FIG. 2g, the power boost circuit including its all embodiments based on “the third type n-phase multilayer magnetic core assembly” of FIG. 2g, the power boost assembly including its all embodiments based on “the third type n-phase multilayer magnetic core assembly” of FIG. 2g, “the fourth type n-phase multilayer magnetic core assembly” of FIG. 2h, “the fourth type dc bus level control circuit” of FIG. 3f based on “the fourth type n-phase multilayer magnetic core assembly” of FIG. 2h, the power boost circuit including its all embodiments based on “the fourth type n-phase multilayer magnetic core assembly” of FIG. 2h, the power boost assembly including its all embodiments based on “the fourth type n-phase multilayer magnetic core assembly” of FIG. 2h, the fifth type n-phase multilayer magnetic core assembly” of FIG. 2i, or “the fifth type dc bus level control circuit” of FIG. 3i based on “the fifth type n-phase multilayer magnetic core assembly” of FIG. 2i, the power boost circuit including its all embodiments based on “the fifth type n-phase multilayer magnetic core assembly” of FIG. 2i, or the power boost assembly including its all embodiments based on “the fifth type n-phase multilayer magnetic core assembly” of FIG. 2i can be saturated by a current flowing through the conductive coil or/and a nearby magnetical field magnetically coupling the magnetic conductor layers.

A sixth embodiment, for “the first type n-phase multilayer magnetic core assembly” of FIG. 2b, FIG. 2c(a), FIG. 2d(a), or FIG. 2e, “the first type dc bus level control circuit” of FIG. 3a, FIG. 3c or FIG. 3g based on “the first type n-phase multilayer magnetic core assembly” of FIG. 2b, FIG. 2c(a), FIG. 2d(a), or FIG. 2e, the power boost circuit including its all embodiments based on “the first type n-phase multilayer magnetic core assembly” of FIG. 2b, FIG. 2c(a), FIG. 2d(a), or FIG. 2e, the power boost assembly including its all embodiments based on “the first type n-phase multilayer magnetic core assembly” of FIG. 2b, FIG. 2c(a), FIG. 2d(a), or FIG. 2e, “the second type n-phase multilayer magnetic core assembly” of FIG. 2c(b), FIG. 2d(b) or FIG. 2f, “the second type dc bus level control circuit” of FIG. 3b, FIG. 3d, or FIG. 3h based on “the second type n-phase multilayer magnetic core assembly” of FIG. 2c(b), FIG. 2d(b) or FIG. 2f, the power boost circuit including its all embodiments based on “the second type n-phase multilayer magnetic core assembly” of FIG. 2c(b), FIG. 2d(b) or FIG. 2f, the power boost assembly including its all embodiments based on “the second type n-phase multilayer magnetic core assembly” of FIG. 2c(b), FIG. 2d(b) or FIG. 2f, “the third type n-phase multilayer magnetic core assembly” of FIG. 2g, “the third type dc bus level control circuit” of FIG. 3e based on “the third type n-phase multilayer magnetic core assembly” of FIG. 2g, the power boost circuit including its all embodiments based on “the third type n-phase multilayer magnetic core assembly” of FIG. 2g, the power boost assembly including its all embodiments based on “the third type n-phase multilayer magnetic core assembly” of FIG. 2g, “the fourth type n-phase multilayer magnetic core assembly” of FIG. 2h, “the fourth type dc bus level control circuit” of FIG. 3f based on “the fourth type n-phase multilayer magnetic core assembly” of FIG. 2h, the power boost circuit including its all embodiments based on “the fourth type n-phase multilayer magnetic core assembly” of FIG. 2h, or the power boost assembly including its all embodiments based on “the fourth type n-phase multilayer magnetic core assembly” of FIG. 2h, the magnetic conductor layers of the biggest closed-loop multilayer magnetic core are magnetized at a first magnetization level by a first current flowing through a first conductive coil winding around the biggest closed-loop multilayer magnetic core and a first closed-loop multilayer magnetic core inside the biggest closed-loop multilayer magnetic core, a first static magnet nearby magnetically coupling the biggest closed-loop multilayer magnetic core or/and a first induced magnetic field nearby magnetically coupling the biggest closed-loop multilayer magnetic core, and the magnetic conductor layers of the biggest closed-loop multilayer magnetic core are further magnetized from the first magnetization level to a second magnetization level by a second current flowing through a second conductive coil winding around the biggest closed-loop multilayer magnetic core and a second closed-loop multilayer magnetic core inside the biggest closed-loop multilayer magnetic core, a second static magnet nearby magnetically coupling the biggest closed-loop multilayer magnetic core or/and a second induced magnetic field nearby magnetically coupling the biggest closed-loop multilayer magnetic core. The first conductive coil and the second conductive coil can be same or different. The first closed-loop multilayer magnetic core and the second closed-loop multilayer magnetic core inside the biggest closed-loop multilayer magnetic core can be same or different. The first static magnet and the second static magnet can be same or different. The first induced magnetic field and the second induced magnetic field can be same or different. The first conductive coil and the second conductive coil can respectively be a multiple-terminal conductive coil capable of receiving multiple electrical inputs such as from a solar panel, a battery and/or an electrical power converted from a rotating mechanism.

A seventh embodiment based on the sixth embodiment, none of the magnetic conductor layers of the biggest closed-loop multilayer magnetic core is saturated by the first magnetization level and at least one of the magnetic conductor layers of the biggest closed-loop multilayer magnetic core is saturated by the second magnetization level.

An eighth embodiment based on the sixth embodiment, none of the magnetic conductor layers of the biggest closed-loop multilayer magnetic core is saturated by the first magnetization level and all the magnetic conductor layers of the biggest closed-loop multilayer magnetic core are saturated by the second magnetization level.

A ninth embodiment based on the sixth embodiment, none of the magnetic conductor layers of the biggest closed-loop multilayer magnetic core is saturated by the first magnetization level and at least one of the magnetic conductor layers of the biggest closed-loop multilayer magnetic core is saturated by the second magnetization level and at least one of the magnetic conductor layers of the biggest closed-loop multilayer magnetic core is not saturated by the second magnetization level.

A tenth embodiment based on the sixth embodiment, all the magnetic conductor layers of the biggest closed-loop multilayer magnetic core are saturated by the first magnetization level and none of the magnetic conductor layers of the biggest closed-loop multilayer magnetic core is saturated by the second magnetization level.

An eleventh embodiment based on the sixth embodiment, at least one of the magnetic conductor layers of the biggest closed-loop multilayer magnetic core is saturated and at least one of the magnetic conductor layers of the biggest closed-loop multilayer magnetic core is not saturated by the first magnetization level and none of the magnetic conductor layers of the biggest closed-loop multilayer magnetic core is saturated by the second magnetization level.

A twelfth embodiment based on the sixth embodiment, at least one of the magnetic conductor layers of the biggest closed-loop multilayer magnetic core is saturated by the first magnetization level and none of the magnetic conductor layers of the biggest closed-loop multilayer magnetic core is saturated by the second magnetization level.

A thirteen embodiment based on the sixth embodiment, a magnetic conductor layer of the biggest closed-loop multilayer magnetic core is not saturated by the first magnetization level and the magnetic conductor layer is saturated by the second magnetization level.

A fourteenth embodiment based on the sixth embodiment, a magnetic conductor layer of the biggest closed-loop multilayer magnetic core is saturated by the first magnetization level and the magnetic conductor layer is not saturated by the second magnetization level.

A fifteenth embodiment, the fifth type n-phase multilayer magnetic core assembly” of FIG. 2i, or “the fifth type dc bus level control circuit” of FIG. 3i based on “the fifth type n-phase multilayer magnetic core assembly” of FIG. 2i, the power boost circuit including its all embodiments based on “the fifth type n-phase multilayer magnetic core assembly” of FIG. 2i, or the power boost assembly including its all embodiments based on “the fifth type n-phase multilayer magnetic core assembly” of FIG. 2i, the magnetic conductor layers of the fifth type n-phase multilayer magnetic core assembly are magnetized at a first magnetization level by a first current flowing through a first conductive coil winding around the fifth type n-phase multilayer magnetic core assembly, a first static magnet nearby magnetically coupling the fifth type n-phase multilayer magnetic core assembly or/and a first induced magnetic field nearby magnetically coupling the fifth type n-phase multilayer magnetic core assembly, and the magnetic conductor layers the fifth type n-phase multilayer magnetic core assembly are further magnetized from the first magnetization level to a second magnetization level by a second current flowing through a second conductive coil winding around the fifth type n-phase multilayer magnetic core assembly, a second static magnet nearby magnetically coupling the fifth type n-phase multilayer magnetic core assembly or/and a second induced magnetic field nearby magnetically coupling the fifth type n-phase multilayer magnetic core assembly. The first conductive coil and the second conductive coil can be same or different.

A sixteenth embodiment based on the fifteenth embodiment, a magnetic conductor layer is not saturated by the first magnetization level and the magnetic conductor layer is saturated by the second magnetization level.

A seventeenth embodiment based on the fifteenth embodiment, a magnetic conductor layer is saturated by the first magnetization level and the magnetic conductor layer is not saturated by the second magnetization level.

An eighteenth embodiment based on the fifteenth embodiment, no magnetic conductor layer is saturated by the first magnetization level and at least one magnetic conductor layer is saturated by the second magnetization level.

A nineteenth embodiment based on the fifteenth embodiment, no magnetic conductor layer is saturated by the first magnetization level and all the magnetic conductor layers are saturated by the second magnetization level.

A twentieth embodiment based on the fifteenth embodiment, no magnetic conductor layer is saturated by the first magnetization level and at least one magnetic conductor layer is saturated by the second magnetization level and at least one magnetic conductor layer is not saturated by the second magnetization level.

A twenty-first embodiment based on the fifteenth embodiment, all the magnetic conductor layers are saturated by the first magnetization level and no magnetic conductor layer is saturated by the second magnetization level.

An twenty-second embodiment based on the fifteenth embodiment, at least one magnetic conductor layer is saturated and at least one magnetic conductor layer is not saturated by the first magnetization level and no magnetic conductor layer is saturated by the second magnetization level.

A twenty-third embodiment based on the fifteenth embodiment, at least one magnetic conductor layer is saturated by the first magnetization level and no magnetic conductor layer is saturated by the second magnetization level.

The PDR device and the NDR device mentioned in the present invention are not limited to any particular PDR device and NDR device, for example, an embodiment, the PDR device can be a positive temperature coefficient (or PTC in short) or can be made of polycrystalline BaTiO₃ and the NDR device can be a negative temperature coefficient (or NTC in short) or can be made of Cu, ZnO or Mn₂O₃ mixture.

1. A power boost circuit, comprises:
n voltage boost circuits for n≧2 with each voltage boost circuit comprising:
an inductor having a multiple-terminal conductive coil capable of defining a plurality of two-terminal pairs on the multiple-terminal conductive coil capable of receiving a plurality of electrical inputs,
a transistor electrically in series with the inductor,
a low side anti-diode in parallel to the transistor,
a signal switching the transistor, and
a high side diode electrically in parallel to the inductor for an output,
wherein each inductor defines a two-terminal pair on the multiple-terminal conductive coil and all the two-terminal-pair defined inductors respectively of the n voltage boost circuits form a closed n-side polygon with each vertex of the n-side polygon being a coupling capacitor, and the multiple-terminal conductive coil of each inductor winds around at least a same magnetic conductor.

2. The power boost circuit of claim 1, wherein each magnetic flux induced in the same magnetic conductor or conductors by current flowing through the conductive coil of each inductor or a magnetic field magnetically coupling the same magnetic conductor or conductors should be magnetically in phase to get maximum magnetization on the same magnetic conductor or conductors.

3. The power boost circuit of claim 1, wherein the same magnetic conductor is selected from the group consisting of multilayer magnetic core, a closed-loop multilayer magnetic core, a partially saturable multilayer magnetic core, or a fully saturable multilayer magnetic core, a closed-loop partially saturable multilayer magnetic core, or a closed-loop fully saturable multilayer magnetic core by a current flowing through the conductive coil winding around the same magnetic conductor or a magnetic field magnetically coupling the same magnetic conductor.

4. The power boost circuit of claim 2, wherein the same magnetic conductor is selected from the group consisting of a multilayer magnetic core, a closed-loop multilayer magnetic core, a partially saturable multilayer magnetic core, or a fully saturable multilayer magnetic core, a closed-loop partially saturable multilayer magnetic core, or a closed-loop fully saturable multilayer magnetic core by a current flowing through the conductive coil winding around the same magnetic conductor or a magnetic field magnetically coupling the same magnetic conductor.

5. The power boost circuit of claim 1, wherein a conductive coil of an inductor of a voltage boost circuit winding around a biggest closed-loop multilayer magnetic core and a closed-loop multilayer magnetic core inside the biggest closed-loop multilayer magnetic core is selected from the group consisting of “a first type n-phase multilayer magnetic core assembly”, “a second type n-phase multilayer magnetic core assembly”, “a third type n-phase multilayer magnetic core assembly” and “a fourth type n-phase multilayer magnetic core assembly” and the conductive coils respectively of all the inductors wind around different closed-loop multilayer magnetic cores inside the biggest closed-loop multilayer magnetic core.

6. The power boost circuit of claim 2, wherein a conductive coil of an inductor of a voltage boost circuit winding around a biggest closed-loop multilayer magnetic core and a closed-loop multilayer magnetic core inside the biggest closed-loop multilayer magnetic core is selected from the group consisting of “a first type n-phase multilayer magnetic core assembly”, “a second type n-phase multilayer magnetic core assembly”, “a third type n-phase multilayer magnetic core assembly” and “a fourth type n-phase multilayer magnetic core assembly” and the conductive coils respectively of all the inductors wind around different closed-loop multilayer magnetic cores inside the biggest closed-loop multilayer magnetic core.

7. The power boost circuit of claim 3, wherein a conductive coil of an inductor of a voltage boost circuit winding around a biggest closed-loop multilayer magnetic core and a closed-loop multilayer magnetic core inside the biggest closed-loop multilayer magnetic core is selected from the group consisting of “a first type n-phase multilayer magnetic core assembly”, “a second type n-phase multilayer magnetic core assembly”, “a third type n-phase multilayer magnetic core assembly” and “a fourth type n-phase multilayer magnetic core assembly” and the conductive coils respectively of all the inductors wind around different closed-loop multilayer magnetic cores inside the biggest closed-loop multilayer magnetic core.

8. The power boost circuit of claim 4, wherein a conductive coil of an inductor of a voltage boost circuit winding around a biggest closed-loop multilayer magnetic core and a closed-loop multilayer magnetic core inside the biggest closed-loop multilayer magnetic core is selected from the group consisting of “a first type n-phase multilayer magnetic core assembly”, “a second type n-phase multilayer magnetic core assembly”, “a third type n-phase multilayer magnetic core assembly” and “a fourth type n-phase multilayer magnetic core assembly” and the conductive coils respectively of all the inductors wind around different closed-loop multilayer magnetic cores inside the biggest closed-loop multilayer magnetic core.

9. The power boost circuit of claim 4, wherein each voltage boost circuit further comprising a positive feedback circuit comprising a device having a threshold, a diode, a transistor, and a second diode electrically connected in series with each other and a coupling capacitor and a RC 180° phase shifter electrically connected in series in parallel to the device having a threshold and the first diode, the coupling capacitor and the device having a threshold receive a portion of its output and the output of the second diode is an input to the voltage boost circuit.

10. The power boost circuit of claim 6, wherein each voltage boost circuit further comprising a positive feedback circuit comprising a device having a threshold, a first diode, a transistor, and a second diode electrically connected in series with each other and a coupling capacitor and a RC 180° phase shifter electrically connected in series in parallel to the device having a threshold and the first diode, the coupling capacitor and the device having a threshold receive a portion of its output and the output of the second diode is an input to the voltage boost circuit.

11. The power boost circuit of claim 7, wherein each voltage boost circuit further comprising a positive feedback circuit comprising a device having a threshold, a first diode, a transistor, and a second diode electrically connected in series with each other and a coupling capacitor and a RC 180° phase shifter electrically connected in series in parallel to the device having a threshold and the first diode, the coupling capacitor and the device having a threshold receive a portion of its output and the output of the second diode is an input to the voltage boost circuit.

12. The power boost circuit of claim 8, wherein each voltage boost circuit further comprising a positive feedback circuit comprising a device having a threshold, a first diode, a transistor, and a second diode electrically connected in series with each other and a coupling capacitor and a RC 180° phase shifter electrically connected in series in parallel to the device having a threshold and the first diode, the coupling capacitor and the device having a threshold receive a portion of its output and the output of the second diode is an input to the voltage boost circuit.

13. The power boost circuit of claim 11, wherein the positive feedback circuit further comprising a level control detector in parallel to the transistor of the positive feedback circuit formed by a Zener having an expected threshold, a resistor and ground electrically connected in series and the Zener is electrically connected to the RC 180° phase shifter and the first diode of the positive feedback circuit so when a voltage at the RC 180° phase shifter and the first diode of the positive feedback circuit exceeds the expected threshold of the Zener the Zener becomes conductive and a voltage built across the resistor turns on the transistor and when a voltage at the RC 180° phase shifter and the first diode of the positive feedback circuit is below the expected threshold of the Zener the Zener is not conductive and a voltage built across the resistor turns off the transistor.

14. The power boost circuit of claim 12, wherein the positive feedback circuit further comprising a level control detector in parallel to the transistor of the positive feedback circuit formed by a Zener having an expected threshold, a resistor and ground electrically connected in series and the Zener is electrically connected to the RC 180° phase shifter and the first diode of the positive feedback circuit so when a voltage at the RC 180° phase shifter and the first diode of the positive feedback circuit exceeds the expected threshold of the Zener the Zener becomes conductive and a voltage built across the resistor turns on the transistor and when a voltage at the RC 180° phase shifter and the first diode of the positive feedback circuit is below the expected threshold of the Zener the Zener is not conductive and a voltage built across the resistor turns off the transistor.

15. The power boost circuit of claim 13, wherein the positive feedback circuit further comprising a comparator for comparing the output of each voltage boost circuit with a limit and when the output larger than the limit is detected the comparator turns off the transistor.

16. The power boost circuit of claim 14, wherein the positive feedback circuit further comprising a comparator for comparing the output of each voltage boost circuit with a limit and when the output larger than the limit is detected the comparator turns off the transistor.

17. The power boost circuit of claim 15, wherein the positive feedback circuit further comprising a gas discharge tube having a threshold larger than the threshold of the transistor of the positive feedback circuit and having a visible electrical discharge and a third diode, the coupling capacitor, a RC 180° phase shifter, the gas discharge tube and the third diode are electrically connected in series with each other and the output of the third diode and the output of the second diode are electrically connected, the gas discharge tube works when the transistor of the positive feedback circuit is bad providing a visible warning that the transistor of the positive feedback circuit is bad.

18. The power boost circuit of claim 16, wherein the positive feedback circuit further comprising a gas discharge tube having a threshold larger than the threshold of the transistor of the positive feedback circuit and having a visible electrical discharge and a third diode, the coupling capacitor, a RC 180° phase shifter, the gas discharge tube and the third diode are electrically connected in series with each other and the output of the third diode and the output of the second diode are electrically connected, the gas discharge tube works when the transistor of the positive feedback circuit is bad providing a visible warning that the transistor of the positive feedback circuit is bad.

19. The power boost circuit of claim 17, wherein the RC 180° phase shifter is a 180° phase-shift network formed by three equivalent capacitors and three equivalent resistors and the device having a threshold of the positive feedback circuit is a transient voltage suppressor.

20. The power boost circuit of claim 18, wherein the RC 180° phase shifter is a 180° phase-shift network formed by three equivalent capacitors and three equivalent resistors and the device having a threshold of the positive feedback circuit is a transient voltage suppressor.
